(19) United States
(12) Patent Application Publication
(10) Pub. No.: US 2026/0275939 A1
(43) Pub. Date: Sep. 17, 2026

(54) Gas Turbine Engine

(71) Applicant: General Electric Company, Schenectady, NY (US)

(72) Inventors: Brandon W. MILLER, Evendale, OH (US); Randy M. VONDRELL, Evendale, OH (US); David M. OSTDIEK, Evendale, OH (US); Craig W. HIGGINS, Evendale, OH (US); Alexander SIMPSON, Evendale, OH (US)

(73) Assignee: General Electric Company, Schenectady, NY (US)

(21) Appl. No.: 19/016,818

(22) Filed: Jan. 10, 2025

Related U.S. Application Data
(63) Continuation-in-part of application No. 18/888,873, filed on Sep. 18, 2024, now Pat. No. 12,410,763.
Application No. 18/888,873 is a continuation of application No. 18/675,270, filed on May 28, 2024, now Pat. No. 12,523,188.
Application No. 18/675,270 is a continuation of application No. 17/879,384, filed on Aug. 2, 2022, now Pat. No. 12,031,504.

(51) Int. Cl. F02K 3/065; F02C 3/06

(52) U.S. Cl. CPC F02K 3/065; F02C 3/06

(57) ABSTRACT

A gas turbine engine includes an inlet duct, a fan duct, a core duct, a primary fan, and a secondary fan. The gas turbine engine defines a thrust to power airflow ratio between 3.5 and 100, a core bypass ratio between 0.1 and 10, a first VPF parameter between 0.10 and 0.40, and a second VPF parameter between 1-30 lbf/in². The thrust to power airflow ratio is a ratio of an airflow through a bypass passage over the turbomachine plus an airflow through the fan duct to an airflow through the core duct. The core bypass ratio is a ratio of the airflow through the fan duct to the airflow through the core duct. The first VPF parameter is a ratio of a fan blade radius ratio to a fan pressure ratio. The second VPF parameter is a ratio of a bearing spanwise force to a fan area.

### CROSS-REFERENCE TO RELATED APPLICATIONS

This application is a continuation-in-part application of U.S. application Ser. No. 18/888,873, filed Sep. 18, 2024, which is a continuation-in-part of U.S. application Ser. No. 18/675,270, filed May 28, 2024, which is a continuation application of U.S. application Ser. No. 17/879,384, filed Aug. 2, 2022, now U.S. Pat. No. 12,031,504. Each of these applications is incorporated by reference herein in their entireties.

### FIELD

The present disclosure relates to a gas turbine engine with a third stream and a fan assembly.

### BACKGROUND

A gas turbine engine typically includes a fan and a turbomachine. The turbomachine generally includes an inlet, one or more compressors, a combustor, and at least one turbine. The compressors compress air which is channeled to the combustor where it is mixed with fuel. The mixture is then ignited for generating hot combustion gases. The combustion gases are channeled to the turbine(s) which extracts energy from the combustion gases for powering the compressor(s), as well as for producing useful work to propel an aircraft in flight. The turbomachine is mechanically coupled to the fan for driving the fan during operation.

In some instances, the turbomachine can be configured as a direct drive engine. Direct drive engines are configured such that a power turbine (e.g., a low-pressure turbine) of the turbomachine is directly coupled to the bypass fan. As such, the power turbine and the bypass fan rotate at the same rotational speed (i.e., the same rpm).

In other instances, the turbomachine can be configured as a geared engine. Geared engines include a gearbox disposed between and interconnecting the bypass fan and power turbine of the core engine. The gearbox, for example, allows the power turbine of the core engine to rotate at a different speed than the bypass fan. Thus, the gearbox can, for example, allow the power turbine of the turbomachine and the bypass fan to operate at their respective rotational speeds for maximum efficiency and/or power production.

In some instances, a propulsor of the turbomachine can be a fan encased within a fan case and/or nacelle. This type of turbomachine can be referred to as “a ducted engine.”

In other instances, the propulsor of the turbomachine can be exposed (e.g., not within a fan case or a nacelle). This type of turbomachine can be referred to as “an open rotor engine” or an “unducted engine.”

In some instances, the turbomachine can comprise a fixed pitch fan, which typical in commercial engines. In such configuration, the pitch of the fan is static and configured to accommodate various engine operating conditions (e.g., takeoff, climb, cruise, approach, etc.).

In other instances, the turbomachine can include a variable pitch fan. In such configurations, the pitch (or blade angle) of the fan can be adjusted to improve propulsive efficiency as the engine operating conditions change.

Despite certain advantages, turbomachines comprising a gearbox and/or a variable pitch fan can have one or more drawbacks. For example, including a gearbox and/or a variable pitch fan in a turbomachine introduces additional complexity to the turbomachine. This can, for example, make engine development and/or manufacturing significantly more difficult. As such, there is a need for improved gas turbofan engines comprising a gearbox and/or a variable pitch fan. There is also a need for devices and methods that can be used to develop and manufacture geared gas turbofan engines with variable pitch fans more efficiently and/or precisely.

### BRIEF DESCRIPTION

Aspects and advantages of the disclosed technology will be set forth in part in the following description, or may be obvious from the description, or may be learned through practice of the technology disclosed in the description.

Various turbomachines and gear assemblies are disclosed herein. The disclosed turbomachines can comprise a compressor section, a combustion section, and a turbine section arranged in serial flow order in some configurations. The disclosed turbomachines can define an engine inlet to an inlet duct, a fan duct inlet to a fan duct, and a core inlet to a core duct. The disclosed turbomachines can drive a primary fan and a secondary fan located downstream of the primary fan within the inlet duct.

The disclosed turbomachines are characterized by a thrust to power airflow ratio and/or a core bypass ratio. The thrust to power airflow ratio is defined as a ratio of an airflow through a bypass passage over the turbomachine plus an airflow through the fan duct to an airflow through the core duct. The disclosed turbomachines are further characterized by a core bypass ratio defined as a ratio of the airflow through the fan duct to the airflow through the core duct. The turbomachines can define a thrust to power airflow ratio between 3.5 and 100 and a core bypass ratio between 0.1 and 10 in some configurations. The disclosed thrust to power ratios and core bypass ratios may be used, for example, to aid in the development of turbomachines with third streams by indicating an improvement in the turbomachine's packaging concerns, weight concerns, and thermal management capabilities.

Additionally or alternatively, the disclosed turbomachines can comprise a variable pitch fan (“VPF”) in some configurations. The disclosed turbomachines can also comprise a gearbox in some configurations. The disclosed variable pitch fans are characterized by a plurality of fan parameters including a first VPF parameter defined as the hub-to-tip radius ratio (“RR”) divided by the fan pressure ratio (“FPR”) and a second VPF parameter defined as the bearing spanwise force (“F_span”) divided by the fan area (“F_area”). The disclosed VPF parameters may also be used, for example, to aid the development of variable pitch fans and/or other turbomachine configurations. The VPF parameters thus provide improved variable pitch fans and/or can help simplify one or more complexities of variable pitch fans and/or geared turbomachine development.

In some examples, a turbomachine includes a fan assembly including a plurality of fan blades. The fan blades are configured such that they define a first VPF parameter and a second VPF parameter. In some instances, the first VPF parameter is within a range of 0.10 to 0.40, and the second VPF parameter is within a range of 1-30 lbf/in². In some examples, the turbomachine further includes a pitch change mechanism, a vane assembly, a core engine, and a gearbox. The pitch change mechanism is coupled to the plurality of fan blades and configured for adjusting a pitch of the plurality of fan blades. The vane assembly includes a plurality of vanes disposed aft of the fan blades. The core engine includes one or more compressor sections and one or more turbine sections. The gearbox includes an input and an output. The input is coupled to the one or more turbine sections of the core engine and comprises a first rotational speed, and the output is coupled to the fan assembly and has a second rotational speed, which is less than the first rotational speed.

In some configurations, a turbomachine, for example can define a bypass passage, a fan duct, and a core duct, and include a variable pitch fan comprising a plurality of fan blades. The turbomachines can define a thrust to power airflow ratio between 3.5 and 100 and a core bypass ratio between 0.1 and 10. Additionally or alternatively, the fan blades can define a first VPF parameter within a range of 0.10 to 0.40 and a second VPF parameter within a range of 1-30 lbf/in². In some configurations, the turbomachine can be an unducted turbomachine. In some configurations, the turbomachine can have a gearbox. The thrust to power ratios, core bypass ratios, and VPF parameters disclosed herein can thus provide improved turbomachines—for example, unducted, geared, three-stream turbomachines with variable pitch fans—having simpler variable pitch fan designs and improved packaging, weight, and thermal management capabilities.

It is desirable to have a low radius ratio (ratio of hub to fan tip radii). With regard to a three stream engine as disclosed herein, the combination of the variable pitch fan with a secondary fan provides an advantage to achieving, lower, primary fan radius ratios, which are favorable for overall system weight and aerodynamic performance. At a given constant engine thrust requirement as the ratio of secondary fan flow to core flow ratio increases, the thrust produced by the secondary fan increases, and subsequently the power transferred to the primary fan for a given thrust level will decrease. The decreased primary fan power results in decreased centrifugal loads, centrifugal twisting loads, and sizing blade out loads, enabling progressively more compact primary fan support and pitch change system designs, which can then achieve progressively lower primary fan radius ratios.

While various proposals have been made to achieve a lower radius ratio, it was found that the embodiments disclosed herein (e.g., embodiments 1-37, FIGS. 37-46 and accompanying description) were particularly advantageous when applied to a three stream engine. Bearing stresses, material, and matched blade size and weights explained in connection with the VPF relationship facilitate the reduced radius ratio achievable from the architecture proposed for three stream flow as defined herein. Compared with other approaches proposed for a VPF, it was found that the approach described in these embodiments were particularly beneficial when applied to the three-stream gas turbine engines as defined herein.

These and other features, aspects, and/or advantages of the present disclosure will become better understood with reference to the following description and the claims. The accompanying drawings, which are incorporated in and constitute a part of this specification, illustrate embodiments of the disclosed technology and, together with the description, serve to explain the principles of the disclosure.

### BRIEF DESCRIPTION OF THE DRAWINGS

A full and enabling disclosure of the present disclosure, including the best mode thereof, directed to one of ordinary skill in the art, is set forth in the specification, which makes reference to the appended figures, in which:

FIG. 1 is a schematic cross-sectional view of a three-stream engine in accordance with an exemplary embodiment of the present disclosure.

FIG. 2 is a close-up, schematic view of the exemplary three-stream engine of FIG. 1.

FIG. 3 is a close-up view of an area surrounding a leading edge of a core cowl of the exemplary three-stream engine of FIG. 2.

FIGS. 4A through 4H are tables depicting numerical values showing the relationships between various parameters in accordance with various example embodiments of the present disclosure.

FIGS. 5A through 5D are graphs depicting a range of thrust to power airflow ratios and core bypass ratios in accordance with various example embodiments of the present disclosure.

FIG. 6 is a schematic view of a turboprop engine in accordance with an exemplary aspect of the present disclosure.

FIG. 7 is a schematic view of a direct drive, ducted, turbofan engine in accordance with an exemplary aspect of the present disclosure.

FIG. 8 is a schematic view of a geared, ducted, turbofan engine in accordance with an exemplary aspect of the present disclosure.

FIG. 9 is a schematic view of a geared, ducted, turbofan engine in accordance with another exemplary aspect of the present disclosure.

FIG. 10 is a schematic view of an unducted gas turbine engine in accordance with another exemplary aspect of the present disclosure.

FIG. 11 is a schematic view of an unducted gas turbine engine in accordance with yet another exemplary aspect of the present disclosure.

FIG. 12 is a schematic view of an unducted gas turbine engine in accordance with still another exemplary aspect of the present disclosure.

FIG. 13 depicts a cross-sectional schematic illustration of an exemplary embodiment of a turbomachinery engine configured with an open rotor propulsion system and a variable pitch fan.

FIG. 14 depicts a cross-sectional schematic illustration of an exemplary embodiment of a turbomachinery engine comprising an open rotor propulsion system, a variable pitch fan, a three-stream architecture, and one or more heat exchangers in a third stream of the three-stream architecture.

FIG. 15 depicts a cross-sectional schematic illustration of an exemplary embodiment of a turbomachinery engine configured with a ducted propulsion system and a variable pitch fan.

FIG. 16 depicts a cross-sectional schematic illustration of an exemplary embodiment of a turbomachinery engine comprising a ducted propulsion system, a variable pitch fan, a three-stream architecture, and one or more heat exchangers in a third stream of the three-stream architecture.

FIG. 17 depicts a cross-sectional schematic illustration of an exemplary embodiment of a counter-rotating low-pressure turbine of a turbomachinery engine, the low-pressure turbine having a 3×3 configuration.

FIG. 18 depicts a cross-sectional schematic illustration of an exemplary embodiment of a counter-rotating low-pressure turbine of a turbomachinery engine, the low-pressure turbine having a 4×3 configuration.

FIG. 19 depicts a cross-sectional schematic illustration of an exemplary embodiment of a gearbox configuration for a turbomachinery engine.

FIG. 20 depicts a cross-sectional schematic illustration of an exemplary embodiment of a gearbox configuration for a turbomachinery engine.

FIG. 21 depicts a cross-sectional schematic illustration of an exemplary embodiment of a gearbox configuration for a turbomachinery engine.

FIG. 22 depicts a cross-sectional schematic illustration of an exemplary embodiment of a gearbox configuration for a turbomachinery engine.

FIG. 23 depicts a cross-sectional schematic illustration of an exemplary embodiment of a gearbox configuration for a turbomachinery engine.

FIG. 24 depicts an exemplary range of a first VPF parameter relative to an exemplary range of a second VPF parameter, which can be particularly advantageous for a turbomachinery comprising a variable pitch fan.

FIG. 25 depicts an exemplary range of a first VPF parameter relative to an exemplary range of a second VPF parameter, which can be particularly advantageous for a turbomachinery comprising a variable pitch fan.

FIG. 26 depicts an exemplary range of a first VPF parameter relative to an exemplary range of a second VPF parameter, which can be particularly advantageous for a turbomachinery comprising a variable pitch fan.

FIG. 27 depicts an exemplary range of a first VPF parameter relative to an exemplary range of a second VPF parameter, which can be particularly advantageous for a turbomachinery comprising a variable pitch fan.

FIG. 28 depicts an exemplary range of a first VPF parameter relative to an exemplary range of a second VPF parameter, which can be particularly advantageous for a turbomachinery comprising a variable pitch fan.

FIG. 29 depicts an exemplary range of a first VPF parameter relative to an exemplary range of a second VPF parameter, which can be particularly advantageous for a turbomachinery comprising a variable pitch fan.

FIG. 30 depicts an exemplary range of a first VPF parameter relative to an exemplary range of a second VPF parameter, which can be particularly advantageous for a turbomachinery comprising a variable pitch fan.

FIG. 31 depicts an exemplary range of a first VPF parameter relative to an exemplary range of a second VPF parameter, which can be particularly advantageous for a turbomachinery comprising a variable pitch fan.

FIG. 32 depicts an exemplary range of a first VPF parameter relative to an exemplary range of a second VPF parameter, which can be particularly advantageous for a turbomachinery comprising a variable pitch fan.

FIG. 33 depicts an exemplary range of a first VPF parameter relative to an exemplary range of a second VPF parameter, which can be particularly advantageous for a turbomachinery comprising a variable pitch fan.

FIG. 34 depicts an exemplary range of a first VPF parameter relative to an exemplary range of a second VPF parameter, which can be particularly advantageous for a turbomachinery comprising a variable pitch fan.

FIG. 35 depicts an exemplary range of a first VPF parameter relative to an exemplary range of a second VPF parameter, which can be particularly advantageous for a turbomachinery comprising a variable pitch fan.

FIG. 36 depicts an exemplary range of a first VPF parameter relative to an exemplary range of a second VPF parameter, which can be particularly advantageous for a turbomachinery comprising a variable pitch fan.

FIG. 37 depicts various fan parameters of several exemplary turbomachinery engines comprising ducted variable pitch fans.

FIG. 38 depicts various fan parameters of several exemplary turbomachinery engines comprising unducted variable pitch fans.

FIG. 39 depicts a partial cross-sectional schematic illustration of an exemplary embodiment of a turbomachinery engine configured with a ducted propulsion system and a variable pitch fan.

FIG. 40 is perspective view of a variable pitch fan of the exemplary turbomachinery engines disclosed herein.

FIG. 41 is a perspective view of a disk and trunnion mechanisms of the exemplary variable pitch fan of FIG. 40.

FIG. 42 is a perspective view of a segment of the disk and one of the associated trunnion mechanisms of FIG. 41.

FIG. 43 is an exploded view of the trunnion mechanism shown in FIG. 41.

FIG. 44 is a cross-sectional view of the segment of the disk and the trunnion mechanism of FIG. 42 with a blade attached to the trunnion mechanism.

FIG. 45 is a side elevation view of a gas turbine engine fan rotor assembly including a hydraulic pitch change mechanism actuator assembly.

FIG. 46 is a cross-sectional view of a portion of a fan assembly that may be implemented with the turbomachinery engines disclosed herein.

### DETAILED DESCRIPTION

Reference will now be made in detail to present embodiments of the disclosure, one or more examples of which are illustrated in the accompanying drawings. Each example is provided by way of explanation of the disclosed technology, not limitation of the disclosure. In fact, it will be apparent to those skilled in the art that various modifications and variations can be made in the present disclosure without departing from the scope or spirit of the disclosure. For instance, features illustrated or described as part of one embodiment can be used with another embodiment to yield a still further embodiment. Thus, it is intended that the present disclosure covers such modifications and variations as come within the scope of the appended claims and their equivalents.

The detailed description uses numerical and letter designations to refer to features in the drawings. Like or similar designations in the drawings and description have been used to refer to like or similar parts of the disclosure.

The word “exemplary” is used herein to mean “serving as an example, instance, or illustration.” Any implementation described herein as “exemplary” is not necessarily to be construed as preferred or advantageous over other implementations. Additionally, unless specifically identified otherwise, all embodiments described herein should be considered exemplary.

As used herein, the terms “first,” “second,” and “third” may be used interchangeably to distinguish one component from another and are not intended to signify location or importance of the individual components.

The terms “forward” and “aft” refer to relative positions within a gas turbine engine or vehicle, and refer to the normal operational attitude of the gas turbine engine or vehicle. For example, with regard to a gas turbine engine, forward refers to a position closer to an engine inlet and aft refers to a position closer to an engine nozzle or exhaust.

The terms “upstream” and “downstream” refer to the relative direction with respect to fluid flow in a fluid pathway. For example, “upstream” refers to the direction from which the fluid flows, and “downstream” refers to the direction to which the fluid flows.

The terms “high/low speed” and “high/low pressure” are used with respect to a high pressure/high speed system and low pressure/low speed system of a gas turbine engine interchangeably. The terms “high” and “low” are used in this context to distinguish the two systems, and are not meant to imply any absolute speed and/or pressure values.

The terms “coupled,” “fixed,” “attached to,” and the like refer to both direct coupling, fixing, or attaching, as well as indirect coupling, fixing, or attaching through one or more intermediate components or features, unless otherwise specified herein.

The singular forms “a,” “an,” and “the” include plural references unless the context clearly dictates otherwise.

Approximating language, as used herein throughout the specification and claims, is applied to modify any quantitative representation that could permissibly vary without resulting in a change in the basic function to which it is related. Accordingly, a value modified by a term or terms, such as “about,” “approximately,” and “substantially,” are not to be limited to the precise value specified. In at least some instances, the approximating language may correspond to the precision of an instrument for measuring the value, or the precision of the methods or machines for constructing or manufacturing the components and/or systems. For example, the approximating language may refer to being within a 1, 2, 4, 5, 10, 15, or 20 percent margin in either individual values, range(s) of values and/or endpoints defining range(s) of values.

Here and throughout the specification and claims, ranges of values are combinable and interchangeable, such ranges are identified and include all the sub-ranges contained therein unless context or language indicates otherwise. For example, all ranges disclosed herein are inclusive of the endpoints, and the endpoints are independently combinable with each other. Thus, the phrases “from X to Y” and “between X and Y” each refer to a range of values inclusive of the endpoints (i.e., refers to a range of values that includes both X and Y).

A “third stream” as used herein means a non-primary (e.g., secondary) air stream capable of increasing fluid energy to produce a minority of total propulsion system thrust of an engine. A pressure ratio of the third stream may be higher than that of the primary propulsion stream (e.g., a bypass or propeller driven propulsion stream). The thrust may be produced through a dedicated nozzle or through mixing of an airflow through the third stream with a primary propulsion stream or a core air stream, e.g., into a common nozzle.

In certain exemplary embodiments an operating temperature of the airflow through the third stream may be less than a maximum compressor discharge temperature for the engine, and more specifically may be less than 350 degrees Fahrenheit (such as less than 300 degrees Fahrenheit, such as less than 250 degrees Fahrenheit, such as less than 200 degrees Fahrenheit, and at least as great as an ambient temperature). In certain exemplary embodiments these operating temperatures may facilitate heat transfer to or from the airflow through the third stream and a separate fluid stream. Further, in certain exemplary embodiments, the airflow through the third stream may contribute less than 50% of the total engine thrust (and at least, e.g., 2% of the total engine thrust) at a takeoff condition, or more particularly while operating at a rated takeoff power at sea level, static flight speed, 86 degrees Fahrenheit ambient temperature operating conditions.

Furthermore in certain exemplary embodiments, aspects of the airflow through the third stream (e.g., airstream, mixing, or exhaust properties), and thereby the aforementioned exemplary percent contribution to total thrust, may passively adjust during engine operation or be modified purposefully through use of engine control features (such as fuel flow, electric machine power, variable stators, variable inlet guide vanes, valves, variable exhaust geometry, or fluidic features) to adjust or optimize overall system performance across a broad range of potential operating conditions.

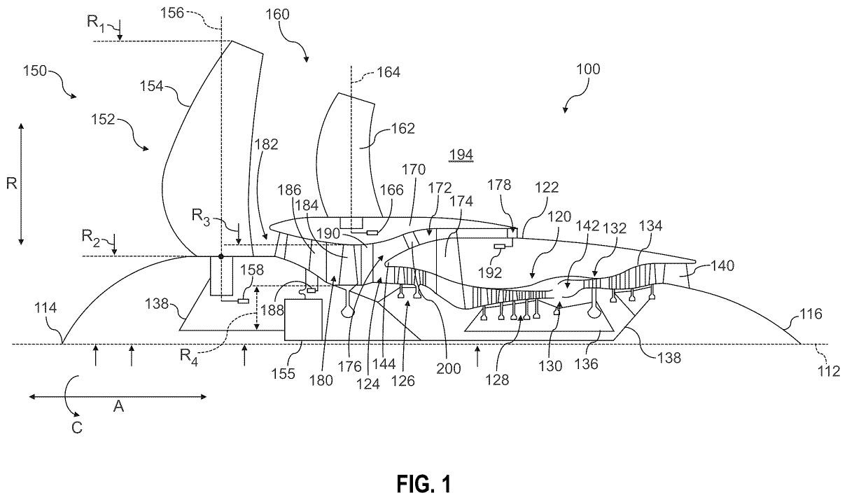

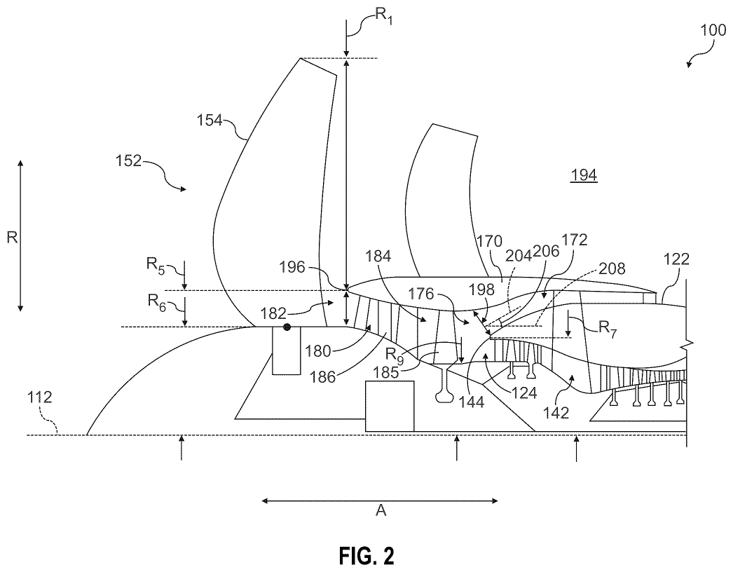

The term “bypass passage” refers generally to a passage with an airflow from a fan of the gas turbine engine that flows over an upstream-most inlet to a turbomachine of the gas turbine engine. In a ducted gas turbine engine, the bypass passage is the passage defined between an outer nacelle (surrounding the fan of the gas turbine engine) and one or more cowls inward of the outer nacelle (e.g., a fan cowl, a core cowl or both if both are present; see, e.g., FIGS. 7 through 9). In an unducted gas turbine engine, the bypass passage refers to an open sided passage (i.e., not explicitly defined by a structure such as an outer nacelle) where airflow from the fan passes over an upstream-most inlet to the turbomachine (e.g., inlet 182 to inlet duct 180 in FIGS. 1 and 2), defined at least in part by a primary fan outer fan area, which refers to an area defined by an annulus representing a portion of the fan located outward of an inlet splitter at the upstream-most inlet to the turbomachine (e.g., inlet splitter 196 of the fan cowl 170 in the embodiment of FIGS. 1 and 2). An airflow through the bypass passage of a ducted or an unducted engine refers to all of the airflow from the fan that is not provided through the upstream-most inlet to the turbomachine.

The term “disk loading” refers to an average pressure change across a plurality of rotor blades of a rotor assembly, such as the average pressure change across a plurality of fan blades of a fan.

The term “rated speed” refers to an operating condition of an engine whereby the engine is operating in the maximum, full load operating condition that is rated by the manufacturer. For example, in an engine certified by the Federal Aviation Administration (“FAA”), the rated speed refers to a rotation speed of the engine during the highest sustainable and continuous power operation in the certification documents, such as a rotational speed of the gas turbine engine when operating under a maximum continuous operation.

The term “standard day operating condition” refers to ambient conditions of sea level altitude, 59 degrees Fahrenheit, and 60 percent relative humidity.

The term “propulsive efficiency” refers to an efficiency with which the energy contained in an engine's fuel is converted into kinetic energy for the vehicle incorporating the engine, to accelerate it, or to replace losses due to aerodynamic drag or gravity.

Generally, an aeronautical gas turbine engine includes a fan to provide a desired amount of thrust without overloading the fan blades (i.e., without increasing a disk loading of the fan blades of the fan beyond a certain threshold), and therefore to maintain a desired overall propulsive efficiency for the gas turbine engine. Conventional gas turbine engine design practice has been to provide an outer nacelle surrounding the fan to provide relatively efficient thrust for the gas turbine engine. Such a configuration, sometimes referred to as a turbofan engine configuration, may generally limit a permissible size of the fan (i.e., a diameter of the fan). However, the inventors of the present disclosure have found that gas turbine engine design is now driving the diameter of the fan higher to provide as much thrust for the gas turbine engine as possible from the fan to improve an overall propulsive efficiency of the gas turbine engine.

By increasing the fan diameter, an installation of the gas turbine engine becomes more difficult. In addition, if an outer nacelle is maintained, the outer nacelle may become weight prohibitive with some larger diameter fans. Further, as the need for gas turbine engines to provide more thrust continues, the thermal demands on the gas turbine engines correspondingly increases.

The inventors of the present disclosure found that for a three stream gas turbine engine having a primary fan and a secondary fan, with the secondary fan being a ducted fan providing an airflow to a third stream of the gas turbine engine, an overall propulsive efficiency of the gas turbine engine that results from providing a high diameter fan may be maintained at a high level, while reducing the size of the primary fan. Such a configuration may maintain a desired overall propulsive efficiency for the gas turbine engine, or unexpectedly may in fact increase the overall propulsive efficiency of the gas turbine engine.

Additionally or alternatively, at least one fan (for example, the primary fan) of the aeronautical gas turbine engine can be a VPF with a plurality of rotor blades. The inclusion of the VPF can confer one or more advantages (e.g., increased propulsive efficiency) but can also create challenges with the mechanical packaging of the gas turbine engine (e.g., the size, weight, and/or drag of the gas turbine engine) and the mechanical integration of the VPF to the rest of the gas turbine engine.

The inventors of the present disclose additionally found that for a gas turbine engine having a variable pitch fan with a plurality of fan blades, an overall propulsive efficiency of the gas turbine engine that results from providing the VPF may be maintained at a high level, while keeping the mechanical packaging within acceptable parameters. Such a configuration may maintain a desired overall propulsive efficiency for the gas turbine engine, or unexpectedly may in fact increase the overall propulsive efficiency of the gas turbine engine.

The inventors proceeded in the manner of designing a gas turbine engine with given primary fan characteristics (for example, variable pitch capability, fan blade dimensions), secondary fan characteristics, and turbomachine characteristics; checking the propulsive efficiency of the designed gas turbine engine; redesigning the gas turbine engine with varying primary fan, secondary fan, and turbomachine characteristics; rechecking the propulsive efficiency of the redesigned gas turbine engine; etc. during the design of several different types of gas turbine engines, including the gas turbine engines described below with reference to FIGS. 1, 6 through 10, and 13 through 16.

During the course of this practice of studying/evaluating various primary fan characteristics, secondary fan characteristics, and turbomachine characteristics considered feasible for best satisfying mission requirements, it was discovered that certain relationships exist between a ratio of an airflow through the bypass passage and the third stream to an airflow through a core duct (referred to hereinbelow as a thrust to power airflow ratio), as well as between a ratio of an airflow through the third steam to the airflow through the core duct (referred to hereinbelow as a core bypass ratio). In particular, the inventors of the present disclosure have found that these ratios can be thought of as an indicator of the ability of a gas turbine engine to maintain or even improve upon a desired propulsive efficiency via the third stream and, additionally, indicating an improvement in the gas turbine engine's packaging concerns and weight concerns, and thermal management capabilities.

Additionally, the inventors discovered that certain relationships exist between a ratio of a hub-to-tip radius ratio of the variable pitch fan and a fan pressure ratio (i.e., the first VPF parameter), as well as between a ratio of a bearing spanwise force of the fan at a redline operating condition measured in pounds force divided by the fan area measured in square inches (i.e., the second VPF parameter). In particular, the inventors discovered that the relationship of the VPF parameters to various gas turbine engine embodiments provides a relatively quick and straightforward way of determining the feasibility of a particular VPF design. Accordingly, the inventors' disclosed methods and VPF parameters can improve the design of ducted and unducted turbomachinery engines.

Finally, the inventors unexpectedly discovered that gas turbine engines can be evaluated based various combinations of these parameters for example, combinations of one or more of the thrust to power airflow ratio, the core bypass ratio, the first VPF parameter, and the second VPF parameter—to further improve the propulsive efficiency and/or design of gas turbine engines, in particular, unducted, three-stream gas turbine engines including variable pitch fans with pluralities of fan blades.

Referring now to FIG. 1, a schematic cross-sectional view of a gas turbine engine 100 is provided according to one example. As shown, FIG. 1 provides a gas turbine engine having a rotor assembly with a single stage of unducted rotor blades. Thus, the rotor assembly may be referred to herein as an “unducted fan,” or the entire engine 100 may be referred to as an “unducted gas turbine engine.” In addition, the engine 100 of FIG. 1 includes a third stream extending from the compressor section to a rotor assembly flowpath over the turbomachine, as will be explained in more detail below.

As shown, the engine 100 defines an axial direction A, a radial direction R, and a circumferential direction C. The engine 100 additionally defines an axial centerline or longitudinal axis 112 that extends along the axial direction A. The axial direction A extends parallel to the longitudinal axis 112, the radial direction R extends outward from and inward to the longitudinal axis 112 in a direction orthogonal to the axial direction A, and the circumferential direction extends three hundred sixty degrees (360°) around the longitudinal axis 112. The engine 100 extends from a forward end 114 to an aft end 116, e.g., along the axial direction A.

The engine 100 includes a turbomachine 120 and a rotor assembly, also referred to a fan section 150 disposed upstream of the turbomachine 120. The turbomachine 120 includes a compressor section, a combustion section, a turbine section, and an exhaust section in a serial flow order. As shown in FIG. 1, the turbomachine 120 includes a core cowl 122 that defines an annular core inlet 124 and encloses at least in part a low pressure system and a high pressure system. For example, the core cowl 122 depicted encloses and supports at least in part a booster or low pressure (“LP”) compressor 126 for pressurizing the air that enters the turbomachine 120 through core inlet 124. A high pressure (“HP”), multi-stage, axial-flow compressor 128 receives pressurized air from the LP compressor 126 and further increases the pressure of the air. The pressurized air flows downstream to a combustor 130 of the combustion section where fuel is injected into the pressurized air stream and ignited to raise the temperature and energy level of the pressurized air.

The high energy combustion products flow from the combustor 130 downstream to a high pressure turbine 132 configured to drive the high pressure compressor 128 through a high pressure shaft 136. In this way, the high pressure turbine 132 is drivingly coupled with the high pressure compressor 128; thus, the high pressure compressor 128, the combustor 130, and the high pressure turbine 132 may collectively be referred to as the “core” of the engine 100. The high energy combustion products then flow to a low pressure turbine 134. The low pressure turbine 134 drives the low pressure compressor 126 and components of the fan section 150 through a low pressure shaft 138; thus, the low pressure turbine 134 is drivingly coupled with the low pressure compressor 126 and components of the fan section 150. The LP shaft 138 is coaxial with the HP shaft 136 in this example embodiment. However, in some examples, the LP shaft 138 and the HP shaft 136 can extend along different axes. After driving each of the turbines 132, 134, the combustion products exit the turbomachine 120 through a turbomachine exhaust nozzle 140.

Accordingly, the turbomachine 120 defines a working gas flowpath or core duct 142 that extends between the core inlet 124 and the turbomachine exhaust nozzle 140. The core duct 142 is an annular duct positioned generally inward of the core cowl 122 along the radial direction R. The core duct 142 (e.g., the working gas flowpath through the turbomachine 120) may be referred to as a “second stream.”

The fan section 150 includes a fan 152, which is the primary fan in this example embodiment. For the depicted embodiment of FIG. 1, the fan 152 is an open rotor or unducted fan 152. Thus, the engine 100 described herein is an open rotor engine.

As shown, the fan 152 includes an array of fan blades 154 (only one shown in FIG. 1). The fan blades 154 are configured to rotate about the longitudinal axis 112. As noted above, the fan 152 is drivingly coupled with the low pressure turbine 134 via the LP shaft 138. As shown in FIG. 1, the fan 152 is coupled with the LP shaft 138 via a speed reduction gearbox 155, e.g., in an indirect-drive or geared-drive configuration.

Moreover, the array of fan blades 154 can be arranged in equal spacing around the longitudinal axis 112. As shown, each fan blade 154 has a root and a tip and a span defined therebetween and, as further shown, each fan blade 154 defines a fan blade tip radius R₁ along the radial direction R from the longitudinal axis 112 to the tip, and a hub radius (or inner radius) R₂ along the radial direction R from the longitudinal axis 112 to the base of each fan blade 154 (i.e., from the longitudinal axis 112 to a radial location where each fan blade 154 meets a front hub of the gas turbine engine 100 at a leading edge of the respective fan blade 154). A distance from the base of each fan blade 154 to a tip of the respective fan blade 154 is referred to as a “span” of the respective fan blade 154. The fan 152, or rather each fan blade 154 of the fan 152, defines a fan radius ratio, RqR, equal to R₂ divided by R₁. As the fan 152 is the primary fan of the engine 100, the fan radius ratio, RqR, of the fan 152 may be referred to as the primary fan radius ratio (RqR_{Prim.-Fan}).

Moreover, each fan blade 154 defines a central blade axis 156. For this embodiment, each fan blade 154 of the fan 152 is rotatable about their respective central blade axis 156, e.g., in unison with one another. Thus, the fan 152 in this embodiment is also referred to as a “variable pitch fan 152.” One or more actuators 158 are provided to facilitate such rotation and therefore may be used to change a pitch of the fan blades 154 about their respective central blades' axes 156.

The fan section 150 further includes a fan guide vane array 160 with fan guide vanes 162 (only one shown in FIG. 1) disposed around the longitudinal axis 112. Although the illustrated fan guide vanes 162 are not rotatable about the longitudinal axis 112, some examples of the fan guide vanes 162 can be rotatable, e.g., about the longitudinal axis 112. Each fan guide vane 162 has a root and a tip and a span defined therebetween. The fan guide vanes 162 may be unshrouded as shown in FIG. 1 or, alternatively, may be shrouded, e.g., by an annular shroud spaced outward from the tips of the fan guide vanes 162 along the radial direction R or attached to the fan guide vanes 162.

Each fan guide vane 162 defines a central blade axis 164. For this embodiment, each fan guide vane 162 of the fan guide vane array 160 is rotatable about its respective central blade axis 164, e.g., in unison with one another. One or more actuators 166 are provided to facilitate such rotation and therefore may be used to change a pitch of the fan guide vane 162 about its respective central blade axis 164. However, in other embodiments, each fan guide vane 162 may be fixed or unable to be pitched about its central blade axis 164. The fan guide vanes 162 are mounted to a fan cowl 170.

Still referring to FIG. 1, in addition to the fan 152, which is unducted, a ducted fan 184 is disposed aft of the fan 152, such that the engine 100 includes both a ducted and unducted fans which both serve to generate thrust through the movement of air without passage through at least a portion of the turbomachine 120 (e.g., without passage through the HP compressor 128 and combustion section for the embodiment depicted). The ducted fan 184 is rotatable about the same axis (e.g., the longitudinal axis 112) as the fan blade 154. The illustrated ducted fan 184 is driven by the low pressure turbine 134 (e.g., coupled to the LP shaft 138). In the embodiment depicted, as noted above, the fan 152 may be referred to as the primary fan, and the ducted fan 184 may be referred to as a secondary fan. It will be appreciated that these terms “primary” and “secondary” are terms of convenience, and do not imply any particular importance, power, or the like. For example, the power of the fan 152 can be greater than the power of the ducted fan 184, or the power of the ducted fan 184 can be greater than the power of the fan 152.

The ducted fan 184 includes a plurality of fan blades (not separately labeled in FIG. 1; see fan blades 185 labeled in FIG. 2) and may be a “single stage fan” in which the plurality of fan blades are arranged in a single stage The fan blades of the ducted fan 184 can be arranged in equal spacing around the longitudinal axis 112. Each blade of the ducted fan 184 has a root and a tip and a span defined therebetween. Further, each fan blade of the ducted fan 184 defines a fan blade tip radius R₃ along the radial direction R from the longitudinal axis 112 to the tip, and a hub radius (or inner radius) R₄ along the radial direction R from the longitudinal axis 112 to the base of the respective fan blades of the ducted fan 184 (i.e., a location where the respective fan blades of the ducted fan 184 meet an inner flowpath liner at a leading edge of the respective fan blades of the ducted fan 184). Each fan blade of the ducted fan 184 may define a span extending from the base of the fan blade to a tip of the fan blade. Further, the ducted fan 184, or rather each fan blade of the ducted fan 184, defines a fan radius ratio, RqR, equal to R₄ divided by R₃. As the ducted fan 184 is the secondary fan of the engine 100, the fan radius ratio, RqR, of the ducted fan 184 may be referred to as the secondary fan radius ratio, RqR_{Sec.-Fan}. In some examples, the ducted fan 184 can be a variable pitch fan, wherein the fan blades of the ducted fan 184 rotate about their spans.

The fan cowl 170 annularly encases at least a portion of the core cowl 122 and is generally positioned outward of at least a portion of the core cowl 122 along the radial direction R. As shown, a downstream section of the fan cowl 170 extends over a forward portion of the core cowl 122 to define a fan duct flowpath, or simply a fan duct 172. According to this embodiment, the fan flowpath or fan duct 172 may be understood as forming at least a portion of the third stream of the engine 100.

Incoming air may enter through the fan duct 172 through a fan duct inlet 176 and may exit through a fan exhaust nozzle 178 to produce propulsive thrust. The fan duct 172 is an annular duct positioned generally outward of the core duct 142 along the radial direction R. The fan cowl 170 and the core cowl 122 are connected together and supported by a plurality of substantially radially-extending, circumferentially-spaced stationary struts 174 (only one of which is shown in FIG. 1). The stationary struts 174 may each be aerodynamically contoured to direct air flowing thereby. Other struts in addition to the stationary struts 174 may be used to connect and support the fan cowl 170 and/or core cowl 122. In many embodiments, the fan duct 172 and the core duct 142 may at least partially co-extend (generally axially) on opposite sides (e.g., opposite radial sides) of the core cowl 122. For example, the fan duct 172 and the core duct 142 may each extend directly from a leading edge 144 of the core cowl 122 and may partially co-extend generally axially on opposite radial sides of the core cowl 122.

The engine 100 also includes an inlet duct 180. The inlet duct 180 extends between an engine inlet 182 and the core inlet 124 and/or the fan duct inlet 176. The engine inlet 182 is defined generally at the forward end of the fan cowl 170 and is positioned between the fan 152 and the fan guide vane array 160 along the axial direction A. The inlet duct 180 is an annular duct that is positioned inward of the fan cowl 170 along the radial direction R. Air flowing downstream along the inlet duct 180 is split into the core duct 142 and the fan duct 172 by a fan duct splitter or leading edge 144 of the core cowl 122. In some examples, the air flowing downstream along the inlet duct 180 can split evenly, but in some examples, the air flowing downstream along the inlet duct 180 can be split unevenly (e.g., in uneven ratio and/or unequal amounts). The inlet duct 180 is wider than the core duct 142 along the radial direction R. The inlet duct 180 is also wider than the fan duct 172 along the radial direction R. The secondary fan 184 is positioned at least partially in the inlet duct 180.

As shown, the engine 100 includes one or more features to increase an efficiency of a third stream thrust, Fn_{3S} (e.g., a thrust generated by an airflow through the fan duct 172 exiting through the fan exhaust nozzle 178, generated at least in part by the ducted fan 184). For example, as shown, the engine 100 further includes an array of inlet guide vanes 186 positioned in the inlet duct 180 upstream of the ducted fan 184 and downstream of the engine inlet 182. The array of inlet guide vanes 186 are disposed around the longitudinal axis 112. For this embodiment, the inlet guide vanes 186 are not rotatable about the longitudinal axis 112. However, some examples of the inlet guide vanes 186 can be rotatable, e.g., about the longitudinal axis 112. Each inlet guide vanes 186 defines a central blade axis (not labeled for clarity), and is rotatable about its respective central blade axis, e.g., in unison with one another. In such a manner, the inlet guide vanes 186 may be considered a variable geometry component. One or more actuators 188 are provided to facilitate such rotation and therefore may be used to change a pitch of the inlet guide vanes 186 about their respective central blade axes. However, in other embodiments, each inlet guide vanes 186 may be fixed or unable to be pitched about its central blade axis.

Furthermore, located downstream of the ducted fan 184 and upstream of the fan duct inlet 176, the engine 100 includes an array of outlet guide vanes 190. As with the array of inlet guide vanes 186, the array of outlet guide vanes 190 are not rotatable about the longitudinal axis 112. However, as shown in the illustrated example, unlike the array of inlet guide vanes 186, the array of outlet guide vanes 190 are configured as fixed-pitch outlet guide vanes.

Further, it will be appreciated that for the embodiment depicted, the fan exhaust nozzle 178 of the fan duct 172 is further configured as a variable geometry exhaust nozzle. In such a manner, the engine 100 includes one or more actuators 192 for modulating the variable geometry exhaust nozzle. For example, the variable geometry exhaust nozzle may be configured to vary a total cross-sectional area (e.g., an area of the nozzle in a plane perpendicular to the longitudinal axis 112) to modulate an amount of thrust generated based on one or more engine operating conditions (e.g., temperature, pressure, mass flowrate, etc. of an airflow through the fan duct 172). A fixed geometry exhaust nozzle may also be adopted.

The combination of the array of inlet guide vanes 186 located upstream of the ducted fan 184, the array of outlet guide vanes 190 located downstream of the ducted fan 184, and the fan exhaust nozzle 178 may result in a more efficient generation of third stream thrust, Fn_{3S}, during one or more engine operating conditions. Further, by introducing a variability in the geometry of the inlet guide vanes 186 and the fan exhaust nozzle 178, the engine 100 may be capable of generating more efficient third stream thrust, Fn_{3S}, across a relatively wide array of engine operating conditions, including takeoff and climb (where a maximum total engine thrust Fn_{Total}, is generally needed) as well as cruise (where a lesser amount of total engine thrust, Fn_{Total}, is generally needed).

Referring still to FIG. 1, in some examples, air passing through the fan duct 172 may be relatively cooler (e.g., lower temperature) than one or more fluids utilized in the turbomachine 120. In this way, one or more heat exchangers 200 may be positioned in thermal communication with the fan duct 172. For example, one or more heat exchangers 200 may be disposed within the fan duct 172 and utilized to cool one or more fluids from the core engine with the air passing through the fan duct 172, as a resource for removing heat from a fluid, e.g., compressor bleed air, oil, or fuel.

The heat exchanger 200 may be an annular heat exchanger extending substantially 360 degrees in the fan duct 172 (e.g., at least 300 degrees, such as at least 330 degrees). In such a manner, the heat exchanger 200 may effectively utilize the air passing through the fan duct 172 to cool one or more systems of the engine 100 (e.g., lubrication oil systems, compressor bleed air, electrical components, etc.). The heat exchanger 200 uses the air passing through duct 172 as a heat sink and correspondingly increases the temperature of the air downstream of the heat exchanger 200 and exiting the fan exhaust nozzle 178.

FIG. 2 is a close-up, simplified, schematic view of the gas turbine engine 100 of FIG. 1. As previously described with respect to FIG. 1, the gas turbine engine 100 includes a primary fan (e.g., the fan 152 having fan blades 154) and a secondary fan (e.g., ducted fan 184 having fan blades 185). Airflow from the fan 152 is split between a bypass region 194 (as defined below) and the inlet duct 180 by an inlet splitter 196. Airflow from the ducted fan 184 is split between the fan duct 172 and the core duct 142 by the leading edge 144 (sometimes also referred to as a fan duct splitter).

The exemplary gas turbine engine 100 shown in FIG. 2 further defines a primary fan outer fan area, A_{P_Out}, a primary fan inner fan area, A_{P_In}, a secondary fan outer fan area, A_{S_Out}, and a secondary fan inner fan area, A_{S_In}.

The primary fan outer fan area, A_{P_Out}, refers to an area defined by an annulus representing a portion of the fan 152 located outward of the inlet splitter 196 of the fan cowl 170. In particular, the gas turbine engine 100 further defines a fan cowl splitter radius, R₅. The fan cowl splitter radius, R₅, is defined along the radial direction R from the longitudinal axis 112 to the inlet splitter 196. The primary fan outer fan area, A_{P_Out}, refers to an area defined by the formula:

$$π {R}_{1}^{2} - π {R}_{5}^{2} .$$

The primary fan inner fan area, A_{P_In}, refers to an area defined by an annulus representing a portion of the fan 152 located inward of the inlet splitter 196 of the fan cowl 170. In particular, the gas turbine engine 100 further defines an engine inlet inner radius, R₆. The engine inlet inner radius, R₆, is defined along the radial direction R from the longitudinal axis 112 to an inner casing defining the engine inlet 182 directly inward along the radial direction R from the inlet splitter 196. The primary fan inner fan area, A_{P_In}, refers to an area defined by the formula:

$$π {R}_{5}^{2} - π {R}_{6}^{2} .$$

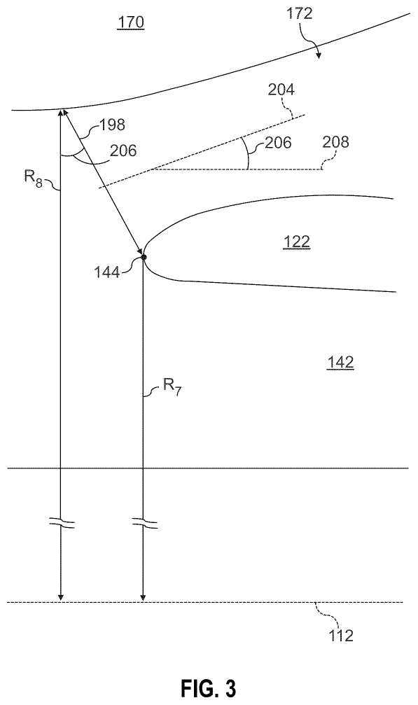

The secondary fan outer fan area, A_{S_Out}, refers to an area representing a portion of an airflow from the ducted fan 184 that is provided to the fan duct 172. In particular, the leading edge 144 defines a leading edge radius, R₇, and the gas turbine engine 100 defines an effective fan duct inlet outer radius, R₈ (see FIG. 3). The leading edge radius, R₇, is defined along the radial direction R from the longitudinal axis 112 to the leading edge 144.

Referring briefly to FIG. 3, providing a close-up view of an area surrounding the leading edge 144, the fan duct 172 defines a cross-wise height 198 measured from the leading edge 144 to the fan cowl 170 in a direction perpendicular to a mean flow direction 204 of an airflow through a forward 10% of the fan duct 172. An angle 206 is defined by the mean flow direction 204 relative to a reference line 208 extending parallel to the longitudinal axis 112. The angle 206 is referred to as θ. In certain embodiments, the angle 206 may be between 5 degrees and 80 degrees, such as between 10 degrees and 60 degrees (an increased angle is a counterclockwise rotation in FIG. 3). The effective fan duct inlet outer radius, R₈, is defined along the radial direction R from the longitudinal axis 112 to where the cross-wise height 198 meets the fan cowl 170. The secondary fan outer fan area, A_{S_out}, refers to an area defined by the formula:

$$\frac{π ( {R}_{8}^{2} - {R}_{7}^{2} )}{cos ( θ )} .$$

Referring back to FIG. 2, the secondary fan inner fan area, A_{S_In}, refers to an area defined by an annulus representing a portion of the ducted fan 184 located inward of the leading edge 144 of the core cowl 122. In particular, the gas turbine engine 100 further defines a core inlet inner radius, R₉. The core inlet inner radius, R₉, is defined along the radial direction R from the longitudinal axis 112 to an inner casing defining the core inlet 124 directly inward along the radial direction R from the leading edge 144. The secondary fan inner fan area, A_{S_In}, refers to an area defined by the formula:

$$π {R}_{7}^{2} - π {R}_{9}^{2} .$$

The primary fan outer fan area, A_{P_Out}, the primary fan inner fan area, A_{P_In}, the secondary fan outer fan area, A_{S_Out}, and the secondary fan inner fan area, A_{S_In}, may be used in defining various airflow ratios for the engine 100. In particular, the exemplary engine 100 of FIGS. 1 through 3 further defines a thrust to power airflow ratio and a core bypass ratio, which are used herein to define an engine in accordance with the present disclosure. The thrust to power airflow ratio is a ratio of an airflow through the bypass passage of the engine 100 and through the fan duct 172 to an airflow through the core duct 142. The bypass passage (not separately labeled) is located within the bypass region 194 and refers to a passage where airflow from the fan 152 passes over the inlet duct 180. Further, the core bypass ratio is a ratio of an airflow through the fan duct 172 to the airflow through the core duct 142. These ratios are calculated while the engine 100 is operating at a rated speed during standard day operating conditions, and the amounts of airflow used to calculate these ratios are each expressed as a mass flowrate in the same units (mass per unit time).

Specifically, the amount of airflow through the engine's bypass passage can be determined using a fan pressure ratio for the fan 152, a rotational speed of the fan 152, or both while the engine is operating at the rated speed during standard day operating conditions, and the primary fan outer fan area, A_{P_Out}. The amount of airflow through the inlet duct 180 can be determined using a fan pressure ratio for the fan 152, a rotational speed of the fan 152, or both while operating at a rated speed during standard day operating conditions, and the primary fan inner fan area, A_{P_In}. The amount of airflow through the fan duct 172 and the amount of airflow through the core duct 142 can be determined based on the amount of airflow through the inlet duct 180 while the engine is operating at the rated speed during standard day operating conditions; a fan pressure ratio, a rotational speed, or both of the ducted fan 184 while the engine is operating at the rated speed during standard day operating conditions; and the secondary fan outer fan area, A_{S_Out}, and the secondary fan inner fan area, A_{S_In}.

The inventors discovered, unexpectedly during the course of gas turbine engine design—i.e., designing gas turbine engines (e.g., both ducted and unducted gas turbine engines and turboprop engines) having a variety of different primary fan and secondary fan characteristics—and evaluating an overall propulsive efficiency, significant relationships exist in a ratio of an airflow through a bypass passage and through a third stream to an airflow through a core duct (referred to herein as a thrust to power airflow ratio), as well as in a ratio of an airflow through the third steam to the airflow through the core duct (referred to herein as a core bypass ratio). These relationships are indicative of the ability of a gas turbine engine to maintain or even improve upon a desired propulsive efficiency via the third stream and, additionally, indicating an improvement in the gas turbine engine's packaging concerns and weight concerns, and thermal management capabilities.

In some examples, it may be desirable to increase a fan diameter to provide a higher thrust to power airflow ratio, which typically correlates to a higher overall propulsive efficiency. However, increasing the fan diameter too much may actually result in a decrease in propulsive efficiency at higher speeds due to drag from the fan blades. Further, increasing the fan diameter too much may also create prohibitively heavy fan blades, creating installation problems due to the resulting forces on the supporting structure (e.g., frames, pylons, etc.), exacerbated by a need to space the engine having such fan blades further from a mounting location on the aircraft to allow the engine to fit, e.g., under/over the wing, adjacent the fuselage, etc.

Similarly, it may generally be desirable to increase an airflow through the fan duct relative to the core duct in order to provide a higher core bypass ratio, as such may also generally correlate to a higher overall propulsive efficiency. Notably, however, the higher the core bypass ratio, the less airflow provided to the core of the gas turbine engine. For a given amount of power needed to drive, e.g., a primary fan and a secondary fan of the gas turbine engine, if less airflow is provided, either a maximum temperature of the core needs to be increased or a size of the primary fan or secondary fan needs to be decreased. Such a result can lead to either premature wear of the core or a reduction in propulsive efficiency of the gas turbine engine.

As noted above, the inventors of the present disclosure discovered bounding the relationships defined by the thrust to power airflow ratio and core bypass ratio can result in a gas turbine engine maintaining or even improving upon a desired propulsive efficiency, while also taking into account the gas turbine engine's packaging concerns and weight concerns, and also providing desired thermal management capabilities. The relationship discovered, infra, can identify an improved engine configuration suited for a particular mission requirement, one that takes into account installation, packaging and loading, thermal sink needs and other factors influencing the optimal choice for an engine configuration.

In addition to yielding an improved gas turbine engine, as explained in detail above, utilizing this relationship, the inventors found that the number of suitable or feasible gas turbine engine designs incorporating a primary fan and a secondary fan, and defining a third stream, capable of meeting both the propulsive efficiency requirements and packaging, weight, and thermal sink requirements could be greatly diminished, thereby facilitating a more rapid down selection of designs to consider as a gas turbine engine is being developed. This more rapid down selection provides more insight to the requirements for a given gas turbine engine well before specific technologies, integration and system requirements are developed fully, thereby beneficially allowing engine designers to better avoid late-stage redesigns.

The inventors discovered that the desired relationships providing for the improved gas turbine engine are expressed as:

$$TPAR = ( {A}_{B} + {A}_{3 S} ) / {A}_{C} \qquad ( 1 )$$

$$CBR = {A}_{3 S} / {A}_{C} \qquad ( 2 )$$

where TPAR is a thrust to power airflow ratio, CBR is a core bypass ratio, A_{B} is an airflow through a bypass passage of the gas turbine engine while the engine is operated at a rated speed during standard day operating conditions, A_{3S} is an airflow through a third stream of the gas turbine engine while the engine is operated at the rated speed during standard day operating conditions, and A_{C} is an airflow through a core of the gas turbine engine while the engine is operated at the rated speed during standard day operating conditions. The airflow through the core of the gas turbine engine may refer to an airflow through an upstream end of the core (e.g., an airflow through a first stage of a high pressure compressor of the core). A_{B}, A_{3S}, and A_{C} are each expressed as mass flowrate, with the same units as one another.

Values for various parameters of the influencing characteristics of an engine defined by Expressions (1) and (2) are set forth below in TABLE 1:

TABLE 1

| | | Ranges appropriate for using |
|---|---|---|
| Symbol | Description | Expression (1) |
| R₁/R₃ | Tip radius ratio | 1.35 to 10, such as 2 to 7, such |
| | | as 3 to 5, such as at least 3.5, |
| | | such as at least 3.7, such as at |
| | | least 4, such as up to 10, such |
| | | as up to 7 |
| RqR_{Sec.-Fan} | Secondary fan | 0.2 to 0.9, such as 0.2 to 0.7, |
| | radius ratio | such as 0.57 to 0.67 |
| RqR_{Prim.-Fan} | Primary fan radius | 0.2 to 0.4, such as 0.25 to 0.35 |
| | ratio | |
| TPAR | Thrust to power | 3.5 to 100, such as 4 to 75 |
| | airflow ratio | (see also, TABLE 2, below) |
| CBR | Core Bypass Ratio | 0.1 to 10, such as 0.3 to 5 |
| | | (see also, TABLE 2, below) |

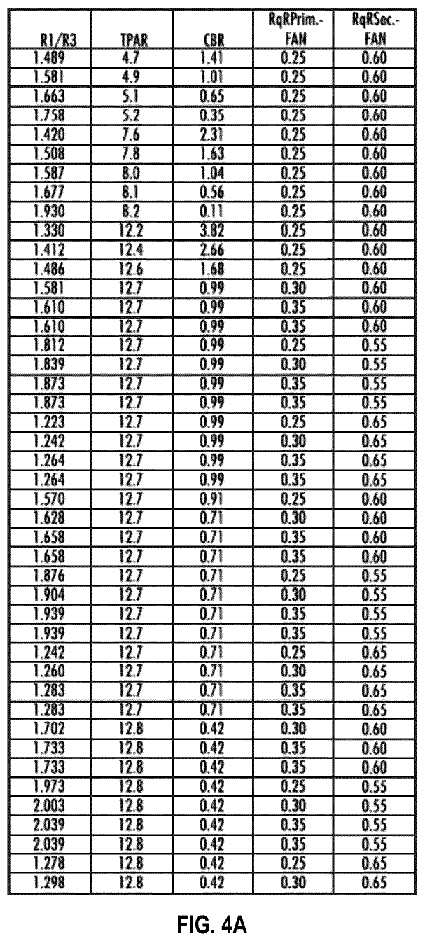

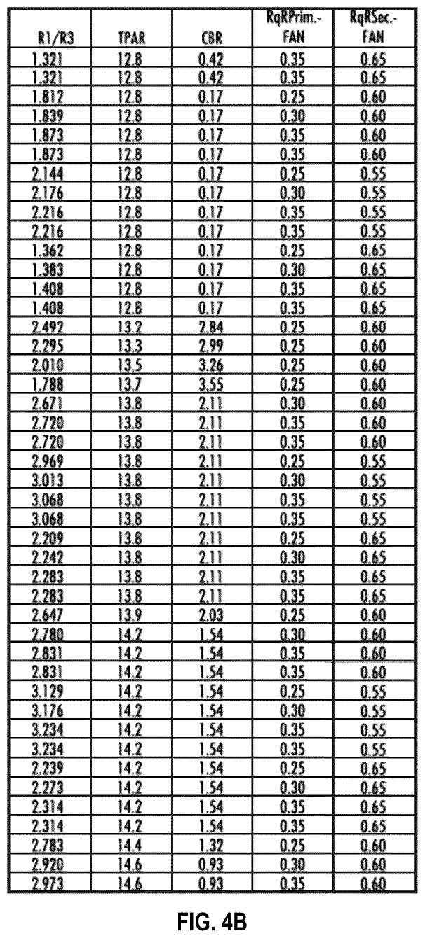

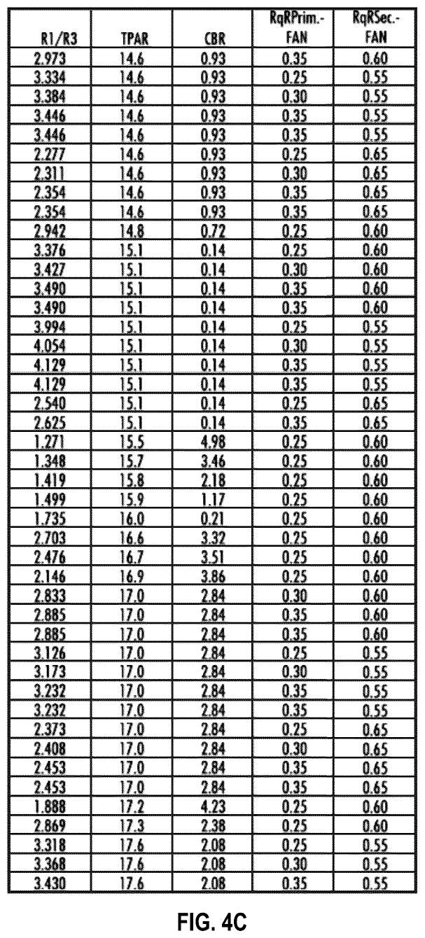

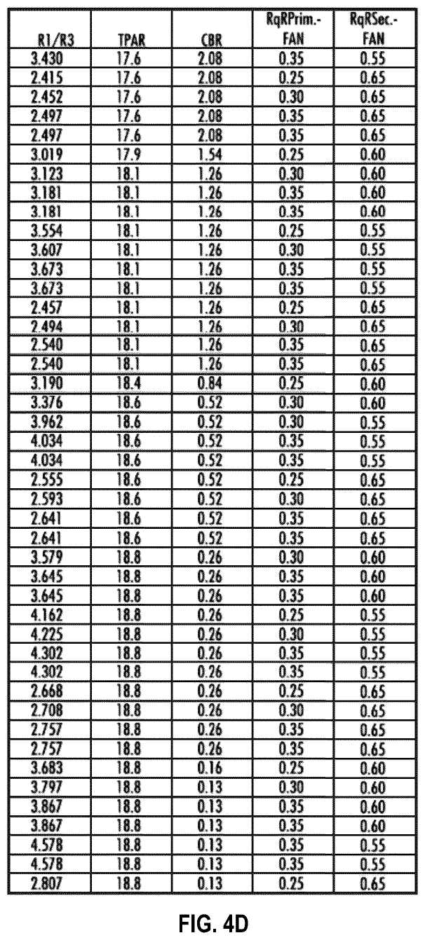

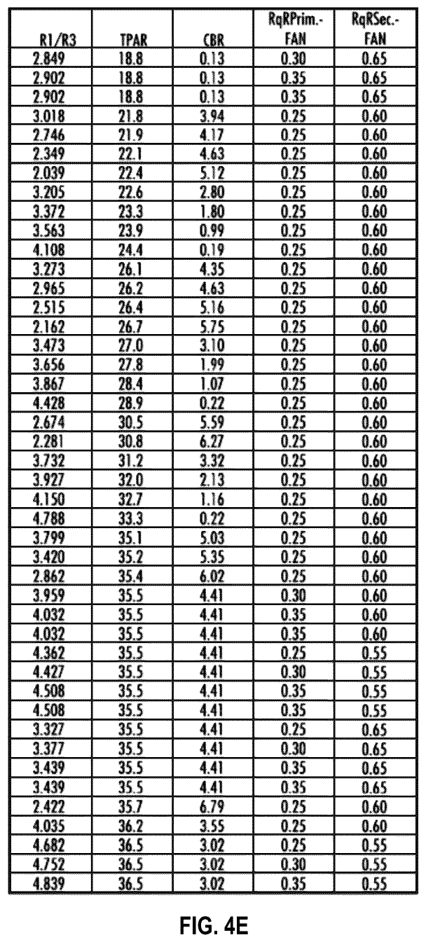

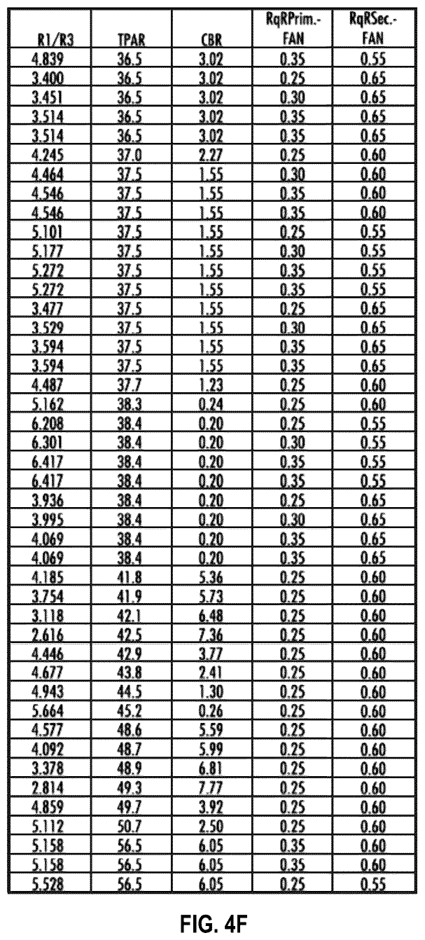

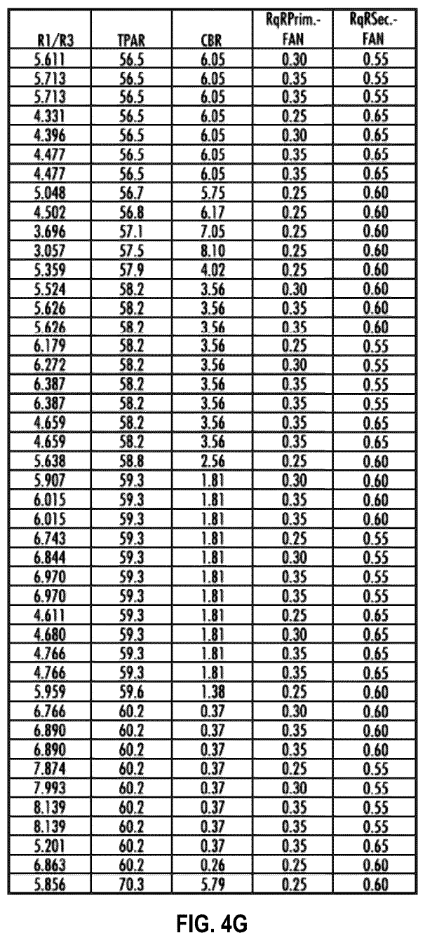

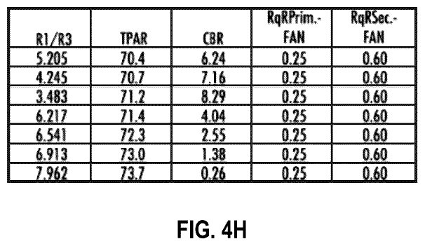

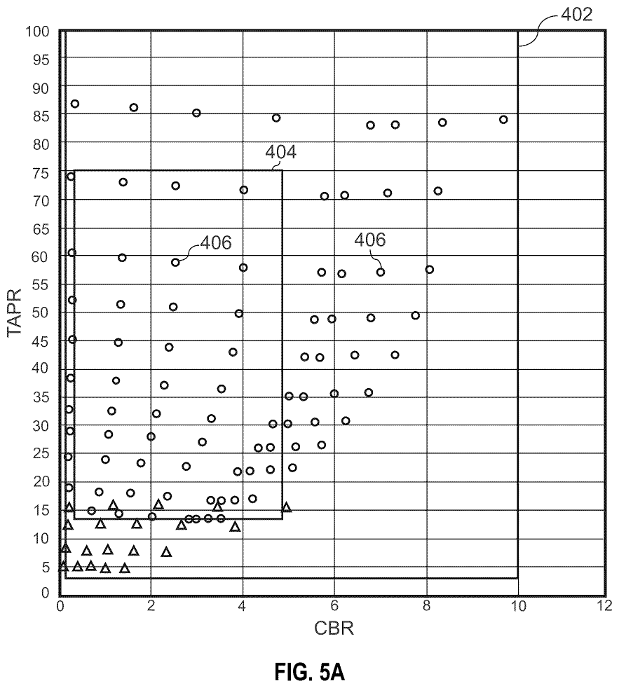

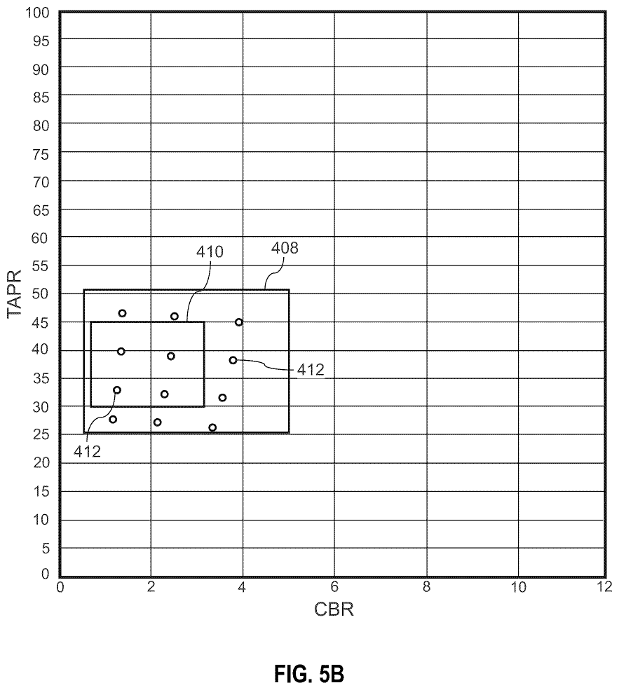

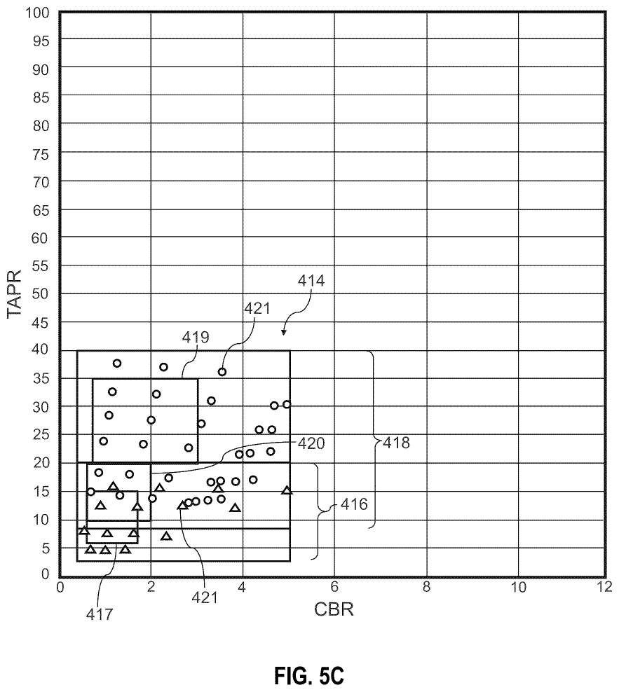

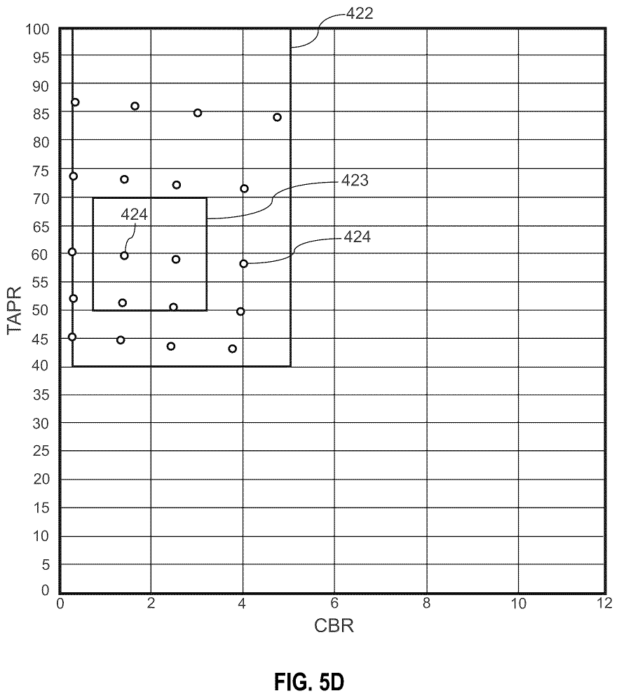

Referring now to FIGS. 4A-4H and 5A-51D, the relationships between the various parameters of Expressions (1) and (2) of exemplary gas turbine engines are illustrated in accordance with one or more exemplary embodiments of the present disclosure. In particular, FIGS. 4A-4H provide a table including numerical values corresponding to several of the plotted gas turbine engines in FIGS. 5A-5D. FIGS. 5A-51D are plots of gas turbine engines in accordance with one or more exemplary embodiments of the present disclosure, showing the TPAR (Y-Axis) and the CBR (X-axis). FIGS. 5A-51D highlight preferred subranges, including subranges for unducted engines, ducted engines, and turboprop engines, as discussed hereinbelow.

Now referring to FIG. 5A, a first range 402 and a second range 404 are provided, and exemplary embodiments 406 are plotted. The exemplary embodiments 406 include a variety of gas turbine engine types in accordance with aspects of the present disclosure, including unducted gas turbine engines, ducted gas turbine engines (turbofan engines), and turboprop engines. The first range 402 corresponds to a TPAR between 3.5 and 100 and a CBR between 0.1 and 10. The first range 402 captures the benefits of the present disclosure across the variety of engine types. The second range 404 corresponds to a TPAR between 14 and 75 and a CBR between 0.3 and 5. The second range 404 may provide more desirable TPAR and CBR relationships across the variety of engine types to achieve propulsive efficiency, while still providing packaging and weight benefits, thermal benefits, etc.

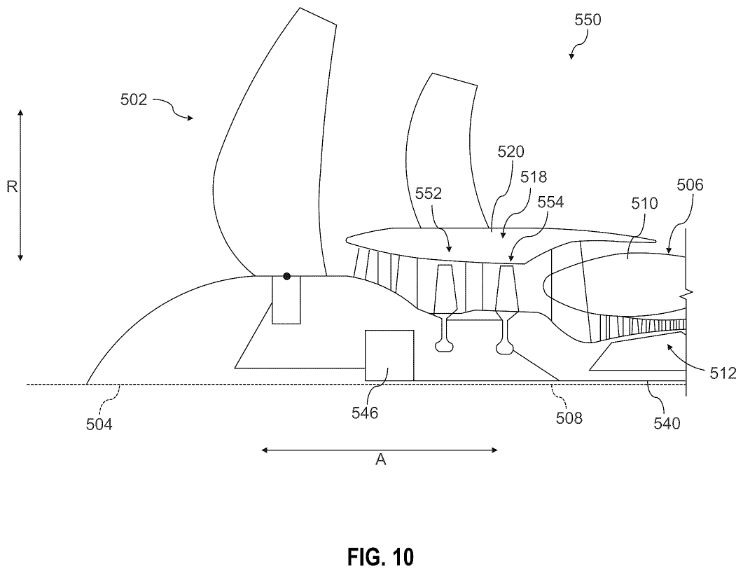

Now referring to FIG. 5B, a third range 408 and a fourth range 410 are provided, and exemplary embodiments 412 are plotted. The exemplary embodiments 412 include a variety of unducted gas turbine engines in accordance with aspects of the present disclosure. In particular, the exemplary embodiments 412 include a variety of gas turbine engines having an unducted primary fan, similar to the exemplary embodiments described herein with reference to FIGS. 1 and 10. The third range 408 corresponds to a TPAR between 30 and 56 and a CBR between 0.3 and 5. The third range 408 captures the benefits of the present disclosure for unducted gas turbine engines. The fourth range 410 corresponds to a TPAR between 35 and 50 and a CBR between 0.5 and 3. The fourth range 410 may provide more desirable TPAR and CBR relationships for the unducted gas turbine engines to achieve propulsive efficiency, while still providing packaging and weight benefits, thermal benefits, etc.

As will be appreciated, the unducted gas turbine engines may have, on the whole, a higher TPAR as compared to the ducted gas turbine engines (see FIG. 5C), enabled by a lack of an outer nacelle or other casing surrounding a primary fan. The range of CBR values in the fourth range 410 is not as large as the range of CBR values in the third range 408, as in the embodiments with a higher TPAR, the CBR needs to be lower to provide a necessary amount of airflow to a core of the engine without exceeding temperature thresholds or requiring an undesired reduction in a size of the primary fan.

The inventors of the present disclosure have found that the TPAR values and CBR values in the third and fourth ranges 408, 410 shown may provide a desirable propulsive benefit, while still enabling operation of the core in a reasonable manner, and balancing installation and thermal load considerations.

Now referring to FIG. 5C, a fifth range 414, a sixth range 416, a seventh range 417, an eighth range 418, a ninth range 419, and a tenth range 420 are provided, and exemplary embodiments 421 are plotted. The exemplary embodiments 421 include a variety of ducted gas turbine engines in accordance with aspects of the present disclosure. In particular, the exemplary embodiments 421 include a variety of gas turbine engines having a ducted primary fan, similar to the exemplary embodiments described herein with reference to FIGS. 7 through 9. The fifth range 414 corresponds to a TPAR between 3.5 and 40 and a CBR between 0.3 and 5. The fifth range 414 captures the benefits of the present disclosure for ducted gas turbine engines.

The sixth range 416 corresponds to a TPAR between 3.5 and 20 and a CBR between 0.2 and 5. The sixth range 416 captures the benefits of the present disclosure for ducted gas turbine engines in a direct drive configuration (see, e.g., FIG. 7). As will be appreciated, with a ducted, direct drive gas turbine engine a primary fan may be smaller, limiting a TPAR. The seventh range 417, which also corresponds to ducted gas turbine engines in a direct drive configuration, corresponds to a TPAR between 6 and 15 and a CBR between 0.3 and 1.8, and may represent a more preferrable range.

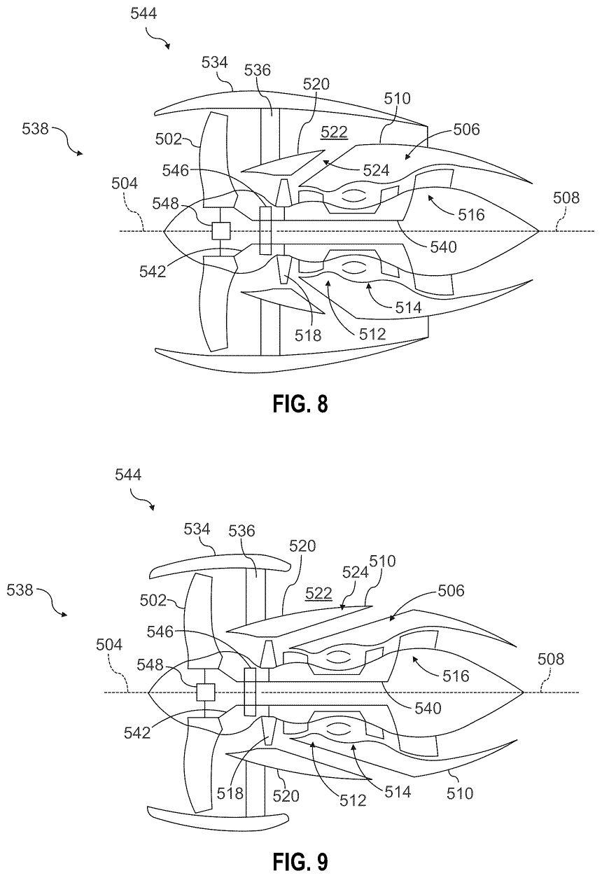

The eighth range 418 corresponds to a TPAR between 8 and 40 and a CBR between 0.2 and 5. The eighth range 418 captures the benefits of the present disclosure for ducted gas turbine engines in a geared configuration (see, e.g., FIGS. 8 and 9). As will be appreciated, with a ducted, geared gas turbine engine a primary fan may be larger as compared to a ducted, direct drive gas turbine engine, allowing for a larger TPAR. TPAR is, in turn limited by an allowable nacelle drag and fan operability.

The ninth range 419 corresponds to ducted gas turbine engines in a geared configuration having a variable pitch primary fan (see FIGS. 8 and 9) and the tenth range 420 corresponds to ducted gas turbine engines in a geared configuration having a fixed pitch primary fan. Inclusion of a variable pitch primary fan may allow for a larger fan, but may also necessitate higher heat rejection abilities for the gas turbine engine, which may, in turn increase a CBR. The ninth range 419 corresponds to a TPAR between 20 and 35 and a CBR between 0.5 and 3, and the tenth range 420 corresponds to a TPAR between 10 and 20 and a CBR between 0.3 and 2. It will be appreciated that in other exemplary aspects, a gas turbine engine of the present disclosure in a ducted, geared, variable pitch configuration may have TPAR between 15 and 40 and a CBR between 0.3 and 5, and a gas turbine engine in a ducted, geared, fixed pitch configuration may have TPAR between 8 and 25 and a CBR between 0.3 and 5.

As will be appreciated, the ducted gas turbine engines may have, on the whole, a lower TPAR than the unducted gas turbine engines as a result of an outer nacelle surrounding a primary fan (the outer nacelle becoming prohibitively heavy with higher diameter primary fans). Further, it will be appreciated that the TPAR values for geared engines may be higher than the TPAR values for direct drive engines, as inclusion of the gearbox allows the primary fan to rotate more slowly than the driving turbine, enabling a comparatively larger primary fan without overloading the primary fan or generating shock losses at a tip of the primary fan. The range of CBR values may generally be relatively high given the relatively low TPAR values (since a relatively high amount of airflow is provided to a secondary fan through an engine inlet when the TPAR values are low), as a necessary amount of airflow to a core of the ducted gas turbine engine may still be provided with a relatively high CBR without exceeding temperature thresholds or requiring a reduction in a size of the primary fan.

The inventors of the present disclosure have found that the TPAR values and CBR values in the fifth, sixth, seventh, eighth, ninth, and tenth ranges 414, 416, 417, 418, 419, 420 shown may provide a desirable propulsive benefit, while still enabling operation of the core in a reasonable manner, and balancing installation and thermal load considerations.

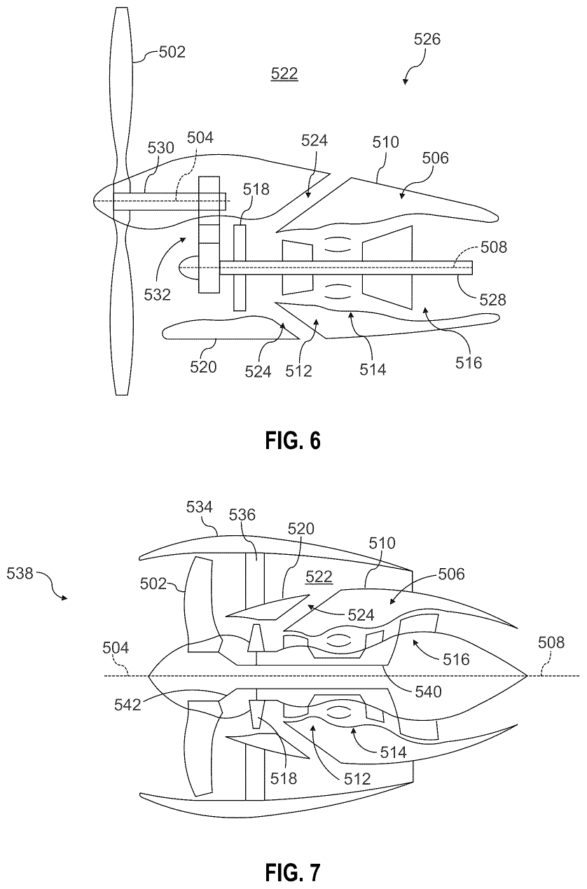

Now referring to FIG. 5D, an eleventh range 422 and a twelfth range 423 are provided, and exemplary embodiments 424 are plotted. The exemplary embodiments 424 include a variety of turboprop gas turbine engines in accordance with aspects of the present disclosure, such as a variety of turboprop gas turbine engines similar to the exemplary embodiment described herein with reference to FIG. 6. The eleventh range 422 corresponds to a TPAR between 40 and 100 and a CBR between 0.3 and 5. The eleventh range 422 captures the benefits of the present disclosure for turboprop gas turbine engines. The twelfth range 423 corresponds to a TPAR between 50 and 70 and a CBR between 0.5 and 3, and may represent a more preferrable range.

As will be appreciated, the turboprop gas turbine engines may have, on the whole, higher TPAR values than turbofan engines, enabled by the lack of an outer nacelle or other casing surrounding a primary fan and a relatively slow operational speed of the primary fan and aircraft incorporating the turboprop gas turbine engine. The range of CBR values in the eleventh range 422 and the twelfth range 423 may be relatively small, as less air may be provided through a third stream with such a high TPAR without compromising operation of a core of the gas turbine engine.

The inventors of the present disclosure discovered that the TPAR values and CBR values in the eleventh range 422 and twelfth range 423 shown may provide a desirable propulsive benefit, while still enabling operation of the core in a reasonable manner and balancing installation and thermal load considerations.

Table 2, produced below, provides a summary of TPAR values and CBR values for various gas turbine engines in accordance with one or more examples of the present disclosure.

TABLE 2

| Engine Type | TPAR Value | CBR Value |
|---|---|---|
| All Aeronautical Gas Turbine Engines | 3.5 to 100 | 0.1 to 10 |
| (“GTE”) | | |
| All Aeronautical GTE | 4 to 75 | 0.3 to 5 |
| Open Rotor GTE | 30 to 60 | 0.3 to 5 |
| Open Rotor GTE | 35 to 50 | 0.5 to 3 |
| Ducted Gas GTE | 3.5 to 40 | 0.2 to 5 |
| Ducted, Geared GTE | 8 to 40 | 0.2 to 5 |
| Ducted, Geared, Variable Pitch GTE | 15 to 40 | 0.3 to 5 |
| Ducted, Geared, Variable Pitch GTE | 20 to 35 | 0.5 to 3 |
| Ducted, Geared, Fixed-Pitch GTE | 8 to 25 | 0.2 to 5 |
| Ducted, Geared, Fixed-Pitch GTE | 10 to 20 | 0.3 to 2 |
| Ducted, Direct Drive GTE | 3.5 to 20 | 0.2 to 5 |
| Ducted, Direct Drive GTE (lower flight | 6 to 20 | 0.2 to 5 |
| speed) | | |
| Ducted, Direct Drive GTE (lower flight | 8 to 15 | 0.3 to 1.8 |
| speed) | | |
| Ducted, Direct Drive GTE (higher flight | 3.5 to 10 | 0.2 to 2 |
| speed) | | |
| Ducted, Direct Drive GTE (higher flight | 3.5 to 6 | 0.3 to 1.5 |
| speed) | | |
| Turboprop GTE | 40 to 100 | 0.3 to 5 |
| Turboprop GTE | 50 to 70 | 0.5 to 3 |

In Table 2, the term “ducted” refers to inclusion of an outer nacelle around a primary fan (see, e.g., FIGS. 7 to 9); “open rotor” refers to inclusion of an unducted primary fan (see, e.g., FIGS. 1, 10); “geared” refers to inclusion of a reduction gearbox between the primary fan and a driving turbine (see, e.g., FIGS. 8 to 10); “direct drive” refers to exclusion of a reduction gearbox between the primary fan and a driving turbine (see, e.g., FIG. 7); “variable pitch” refers to inclusion of a pitch change mechanism for changing a pitch of fan blades on a primary fan (see, e.g., FIGS. 1, 8, 9); “fixed pitch” refers to exclusion of a pitch change mechanism for changing a pitch of fan blades on a primary fan (see, e.g., FIGS. 6 to 7); “lower flight speed” refers to an engine designed to operate at a flight speed less than 0.85 Mach; and “higher flight speed” refers to an engine designed to operate at a flight speed higher than 0.85 Mach.

In some examples, the engine 100 can be characterized as having a first VPF parameter (described later herein) of about 0.10-0.40. In some examples, the engine 100 can be characterized as having a second VPF parameter (also described later herein) of or of about 1-30 lbf/in², such as 1-5.25 lbf/in².

It will be appreciated that although the discussion above is generally relating to the open rotor engine 100 described above with reference to FIGS. 1 and 2, in various embodiments of the present disclosure, the relationships outlined above with respect to, e.g., Expressions (1) and (2) may be applied to any other suitable engine architecture. For example, reference will now be made to FIGS. 6 through 12, each depicting schematically an engine architecture associated with the present disclosure.

Each of the gas turbine engines of FIGS. 6 through 9 generally include a rotor 502 rotatable about a rotor axis 504 and a turbomachine 506 rotatable about a longitudinal axis 508. The rotor 502 corresponds to the “primary fan” described herein. The turbomachine 506 is surrounded at least in part by a core cowl 510 and includes a compressor section 512, a combustion section 514, and a turbine section 516 in serial flow order. In addition to the rotor 502, the gas turbine engines of FIGS. 7 through 9 each also include a ducted mid-fan or secondary fan 518. The gas turbine engines each include a fan cowl 520 surrounding the secondary fan 518.

Referring still to the gas turbine engines of FIGS. 6 through 9, the gas turbine engines each also define a bypass passage 522 downstream of the respective rotor 502 and over the respective fan cowl 520 and core cowl 510, and further define a third stream 524 extending from a location downstream of the respective secondary fan 518 to the respective bypass passage 522 (at least in the embodiments depicted; in other embodiments, the third stream 524 may instead extend to a location downstream of the bypass passage 522).

Referring particularly to FIG. 6, the exemplary gas turbine engine depicted is configured as a turboprop engine 526. In such a manner, the rotor 502 (or primary fan) is configured as a propeller, defining a relatively large diameter. Further, the turboprop engine 526 includes an engine shaft 528 driven by the turbomachine 506, a fan shaft 530 rotatable with the rotor 502, and a gearbox 532 mechanically coupling the engine shaft 528 with the fan shaft 530. The gearbox 532 is an offset gearbox such that the rotor axis 504 is radially offset from the longitudinal axis 508 of the turboprop engine 526.

Notably, in other embodiments of the present disclosure, a turboprop engine may be provided with a reverse flow combustor.

Referring to FIGS. 7 through 9, the gas turbine engines are each configured as turbofan engines, and more specifically as ducted turbofan engines. In such a manner, the gas turbine engines each include an outer nacelle 534 surrounding the rotor 502, and the rotor 502 (or primary fan) of each is therefore configured as a ducted fan. Further, each of the gas turbine engines includes outlet guide vanes 536 extending through the bypass passage 522 to the outer nacelle 534 from the fan cowl 520, the core cowl 510, or both.

More specifically, still, the gas turbine engine of FIG. 7 is configured as a direct drive, ducted, turbofan engine 538. In particular, the direct drive, ducted, turbofan engine 538 includes an engine shaft 540 driven by the turbine section 516 and a fan shaft 542 rotatable with the rotor 502. The fan shaft 542 is configured to rotate directly with (i.e., at the same speed as) the engine shaft 540.

By contrast, the gas turbine engine of FIG. 8 is configured as a geared, ducted, turbofan engine 544. In particular, the geared, ducted, turbofan engine 544 includes the engine shaft 540 driven by the turbine section 516 and the fan shaft 542 rotatable with the rotor 502. However, the exemplary geared, ducted, turbofan engine 544 further includes a gearbox 546 mechanically coupling the engine shaft 540 to the fan shaft 542. The gearbox 546 allows the rotor 502 to rotate at a slower speed than the engine shaft 540, and thus at a slower speed than the secondary fan 518.

Notably, the exemplary geared, ducted, turbofan engine 544 of FIG. 8 further includes a pitch change mechanism 548 operable with the rotor 502 to change a pitch of the rotor blades of the rotor 502. Such may allow for an increased efficiency of the gas turbine engine.

Further, the exemplary gas turbine engine of FIG. 9 is again configured as a direct drive, ducted, turbofan engine 538. However, by contrast to the embodiment of FIG. 8 where a fan duct outlet defined by the fan duct is upstream of a bypass passage outlet defined by the bypass passage, in the embodiment of FIG. 9, the fan duct outlet defined by the fan duct is downstream of the bypass passage outlet defined by the bypass passage.

Moreover, in other exemplary embodiments, other suitable gas turbine engines may be provided. For example, referring now to FIG. 10, a gas turbine engine in accordance with yet another exemplary embodiment of the present disclosure is provided. The exemplary gas turbine engine of FIG. 10 may be configured in a similar manner as the exemplary gas turbine engines described above with reference to FIGS. 7 and 8.

For example, the exemplary gas turbine engine of FIG. 10 includes a rotor 502 rotatable about a rotor axis 504 and a turbomachine 506 rotatable about a longitudinal axis 508. The rotor axis 504 and the longitudinal axis 508 are aligned in the embodiment of FIG. 10. The rotor 502 corresponds to the “primary fan” described herein. The turbomachine 506 is surrounded at least in part by a core cowl 510 and includes a compressor section 512 (and, not shown, a combustion section and a turbine section in serial flow order with the compressor section 512). In addition to the rotor 502, the gas turbine engine also includes a ducted mid-fan or secondary fan 518 and a fan cowl 520 surrounding the secondary fan 518.

However, for the embodiment of FIG. 10, the gas turbine engine is configured as an unducted gas turbine engine 550 (see, e.g., FIG. 1), and the secondary fan 518 is not configured as a single stage fan (see fan 184 of FIG. 1). Instead, for the embodiment of FIG. 10, the secondary fan 518 is configured as a multi-stage secondary fan, and more specifically still as a two-stage secondary fan having a total of two stages of rotating compressor rotor blades, and more specifically having a first stage 552 of secondary fan rotor blades and a second stage 554 of secondary fan rotor blades. Notably, with such a configuration, the turbomachine 506 does not include a separate low pressure compressor.

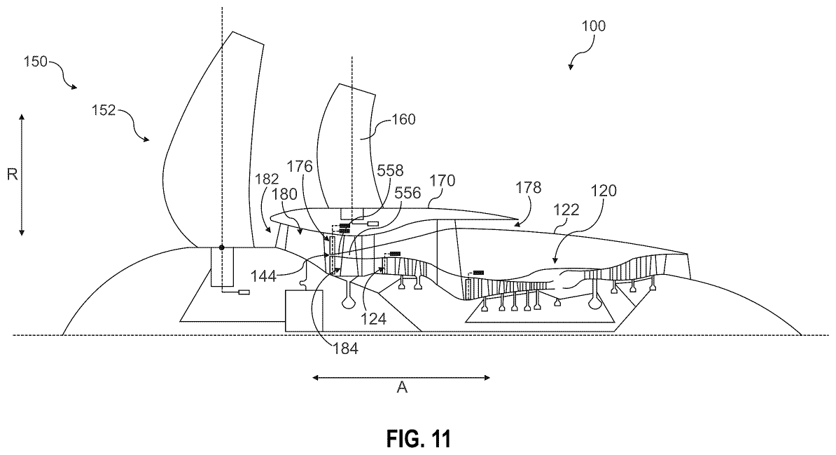

Additionally, in still other exemplary embodiments, the gas turbine engine may have other configurations. For example, referring now to FIG. 11, a gas turbine engine in accordance with yet another exemplary embodiment of the present disclosure is provided. The exemplary gas turbine engine of FIG. 11 may be configured in a similar manner as the exemplary gas turbine engines described above with reference to, e.g., FIGS. 1 through 3.

For example, the exemplary gas turbine engine of FIG. 11 includes a turbomachine 120 and a rotor assembly, also referred to a fan section 150, positioned upstream thereof. The engine 100 further includes a fan cowl 170 and a core cowl 122, the fan cowl 170 annularly encasing at least a portion of the core cowl 122 and generally positioned outward of at least a portion of the core cowl 122 along the radial direction R. Particularly, a downstream section of the fan cowl 170 extends over a forward portion of the core cowl 122 to define a fan duct flowpath, or simply fan duct 172. Incoming air may enter through the fan duct 172 through a fan duct inlet 176 and may exit through a fan exhaust nozzle 178 to produce propulsive thrust. The fan duct 172 extends from a leading edge 144 of the core cowl 122.

The engine 100 also defines an inlet duct 180. The inlet duct 180 extends between an engine inlet 182 and a core inlet 124. The engine inlet 182 is defined generally at the forward end of the fan cowl 170 and is positioned between a fan 152 of the fan section 150 and a fan guide vane array 160 along the axial direction A. The engine 100 further includes a ducted fan 184 with a plurality of fan blades located at least partially in the inlet duct 180.

However, for the embodiment of FIG. 11, the core cowl 122 carries forward to an aft edge of the fan blades of the ducted fan 184 and the fan blades themselves include an integral splitter 556. This may be termed a blade-on-blade configuration where inner and outer blades are effectively superimposed upon one another and may be unitarily formed or otherwise fabricated to achieve the split between streams.

The core cowl 122 further includes a section 558 extending forward past the fan blades of the ducted fan 184, such that the leading edge 144 is located forward of the fan blades of the ducted fan 184. With such an arrangement, the fan duct inlet 176 is also located forward of the fan blades of the ducted fan 184, and an outer portion of the fan blades along the radial direction R is positioned within the fan duct 172. With this configuration, a secondary fan outer fan area, A_{S_Out}, may be calculated at the fan duct inlet 176 in the same manner discussed above with reference to, e.g., FIGS. 2 and 3.

Further, with such a configuration, the secondary fan inner fan area, A_{S_In}, still refers to an area defined by an annulus representing a portion of the ducted fan 184 located inward of the leading edge 144 of the core cowl 122. However, a calculation of the secondary fan inner fan area, A_{S_In}, is based on a leading edge radius, R₇, of the leading edge 144 and an inner fan duct radius, defined along the radial direction R, directly inward along the radial direction R from the leading edge 144 (and not a core inlet inner radius at the core inlet 124).

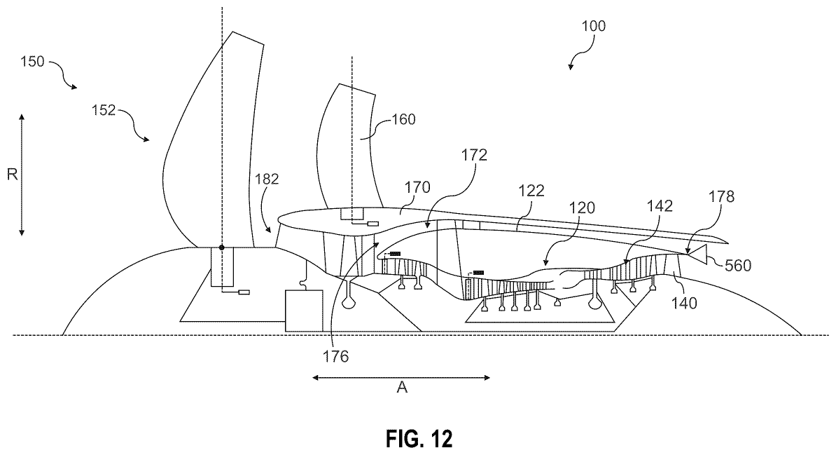

Further, still, in other exemplary embodiments, other engine configurations may be provided. For example, referring now to FIG. 12, an engine 100 in accordance with another embodiment of the present disclosure is provided. The engine 100 of FIG. 12 may be configured in a similar manner as the exemplary engine 100 of, e.g., FIGS. 1 through 3.

For example, the exemplary gas turbine engine of FIG. 12 includes a turbomachine 120 and a rotor assembly, also referred to a fan section 150, positioned upstream thereof. The engine 100 further includes a fan cowl 170 and a core cowl 122, the fan cowl 170 annularly encasing at least a portion of the core cowl 122 and generally positioned outward of at least a portion of the core cowl 122 along the radial direction R. Particularly, a downstream section of the fan cowl 170 extends over a forward portion of the core cowl 122 to define a fan duct flowpath, or simply fan duct 172. Incoming air may enter through the fan duct 172 through a fan duct inlet 176 and may exit through a fan exhaust nozzle 178 to produce propulsive thrust. The fan duct 172 extends from a leading edge 144 of the core cowl 122.

However, for the embodiment of FIG. 12, the fan duct 172 of the exemplary engine 100 is an elongated fan duct 172 extending between the fan cowl 170 and the core cowl 122, a full length of the core cowl 122. With such a configuration, the fan exhaust nozzle 178 is downstream of an exhaust nozzle 140 of the turbomachine 120. The engine 100 of FIG. 12 further includes a mixing device 560 in the region aft of the exhaust nozzle 140 to aid in mixing airflow from the fan duct 172 and from a working gas flowpath 142 of the turbomachine 120, e.g., to improve acoustic performance by directing airflow from the working gas flowpath 142 of the turbomachine 120 outward and from the fan duct 172 inward. Mixing in such a manner may improve performance and noise emissions.

Moreover, in other exemplary embodiments of the present disclosure, a gas turbine engine may have still other suitable configurations. For example, in other embodiments, the gas turbine engine may include any suitable number of shafts or spools, compressors, or turbines (e.g., the gas turbine engine may be a three-spool engine having three turbines and associated spools).

Further, it will be appreciated that in at least certain exemplary embodiments of the present disclosure, a method of operating a gas turbine engine is provided. The method may be utilized with one or more of the exemplary gas turbine engines discussed herein, such as in FIGS. 1 through 12. The method includes operating the gas turbine engine at a rated speed, wherein operating the gas turbine engine at the rated speed comprises operating the gas turbine engine to define a thrust to power airflow ratio between 3.5 and 100 and a core bypass ratio between 0.1 and 5. For the exemplary method, the thrust to power airflow ratio is a ratio of an airflow through a bypass passage over a turbomachine of the gas turbine engine plus an airflow through a fan duct to an airflow through a core duct, and the core bypass ratio is a ratio of the airflow through the fan duct to the airflow through the core duct.

As will be appreciated from the description herein, various embodiments of a gas turbine engine are provided. Certain of these embodiments may be an unducted, single rotor gas turbine engine (see FIGS. 1 and 2, 11, and 12, and FIGS. 13 and 14 described later herein), a turboprop engine (see FIG. 6), or a ducted turbofan engine (see FIGS. 7 through 9, and FIGS. 15 and 16 described later herein). Another example of a ducted turbofan engine can be found in U.S. patent application Ser. No. 16/811,368 (Published as U.S. Patent Application Publication No. 2021/0108597), filed Mar. 6, 2020 (FIG. 10, Paragraph [0062], et al.; including an annular fan case 13 surrounding the airfoil blades 21 of rotating element 20 and surrounding vanes 31 of stationary element 30; and including a third stream/fan duct 73 (shown in FIG. 10, described extensively throughout the application)), which is incorporated by reference herein in its entirety. Various additional aspects of one or more of these embodiments are discussed below. These exemplary aspects may be combined with one or more of the exemplary gas turbine engine(s) discussed above with respect to the figures.

For example, in some examples, the engine may include a heat exchanger located in an annular duct, such as in a third stream. The heat exchanger may extend substantially continuously in a circumferential direction of the gas turbine engine (e.g., at least 300 degrees, such as at least 330 degrees).

In one or more of these examples, a threshold power or disk loading for a fan (e.g., an unducted single rotor or primary forward fan) may range from 25 horsepower per square foot (hp/ft²) or greater at cruise altitude during a cruise operating mode. In particular embodiments of the engine, structures and methods provided herein generate power loading between 80 hp/ft² and 160 hp/ft² or higher at cruise altitude during a cruise operating mode, depending on whether the engine is an open rotor or ducted engine.

In various embodiments, an engine of the present disclosure is applied to a vehicle with a cruise altitude up to approximately 65,000 ft. In certain embodiments, cruise altitude is between approximately 28,000 ft and approximately 45,000 ft. In still certain embodiments, cruise altitude is expressed in flight levels based on a standard air pressure at sea level, in which a cruise flight condition is between FL280 and FL650. In another embodiment, cruise flight condition is between FL280 and FL450. In still certain embodiments, cruise altitude is defined based at least on a barometric pressure, in which cruise altitude is between approximately 4.85 psia and approximately 0.82 psia based on a sea level pressure of approximately 14.70 psia and sea level temperature at approximately 59 degrees Fahrenheit. In another embodiment, cruise altitude is between approximately 4.85 psia and approximately 2.14 psia. It should be appreciated that in certain embodiments, the ranges of cruise altitude defined by pressure may be adjusted based on a different reference sea level pressure and/or sea level temperature.

As such, it will be appreciated that an engine of such a configuration may be configured to generate at least 25,000 pounds and less than 80,000 of thrust during operation at a rated speed, such as between 25,000 and 50,000 pounds of thrust during operation at a rated speed, such as between 25,000 and 40,000 pounds of thrust during operation at a rated speed. Alternatively, in other exemplary aspects, an engine of the present disclosure may be configured to generate much less power, such as at least 2,000 pounds of thrust during operation at a rated speed.

In various exemplary embodiments, the fan (or rotor) may include twelve (12) fan blades. From a loading standpoint, such a blade count may allow a span of each blade to be reduced such that the overall diameter of the primary fan may also be reduced (e.g., to twelve feet in one exemplary embodiment). That said, in other embodiments, the fan may have any suitable blade count and any suitable diameter. In certain suitable embodiments, the fan includes at least eight (8) blades. In another suitable embodiment, the fan may have at least twelve (12) blades. In yet another suitable embodiment, the fan may have at least fifteen (15) blades. In yet another suitable embodiment, the fan may have at least eighteen (18) blades. In one or more of these embodiments, the fan includes twenty-six (26) or fewer blades, such as twenty (20) or fewer blades. Alternatively, in certain suitable embodiments, the fan may only include at least four (4) blades, such as with a fan of a turboprop engine.

Further, in certain exemplary embodiments, the rotor assembly may define a rotor diameter (or fan diameter) of at least 10 feet, such as at least 11 feet, such as at least 12 feet, such as at least 13 feet, such as at least 15 feet, such as at least 17 feet, such as up to 28 feet, such as up to 26 feet, such as up to 24 feet, such as up to 18 feet.

In various embodiments, it will be appreciated that the engine includes a ratio of a quantity of vanes to a quantity of blades that could be less than, equal to, or greater than 1:1. For example, in particular embodiments, the engine includes twelve (12) fan blades and ten (10) vanes. In other embodiments, the vane assembly includes a greater quantity of vanes to fan blades. For example, in particular embodiments, the engine includes ten (10) fan blades and twenty-three (23) vanes. For example, in certain embodiments, the engine may include a ratio of a quantity of vanes to a quantity of blades between 1:2 and 5:2. The ratio may be tuned based on a variety of factors including a size of the vanes to ensure a desired amount of swirl is removed for an airflow from the primary fan.

Additionally, in certain exemplary embodiments, where the engine includes the third stream and a mid-fan (a ducted fan aft of the primary, forward fan), a ratio R1/R2 may be between 1 and 10, or 2 and 7, or at least 3.3, at least 3.5, at least 4 and less than or equal to 7, where R1 is the radius of the primary fan and R2 is the radius of the mid-fan.

It should be appreciated that various embodiments of the engine, such as the single unducted rotor engine depicted and described herein, may allow for normal subsonic aircraft cruise altitude operation at or above Mach 0.5. In certain embodiments, the engine allows for normal aircraft operation between Mach 0.55 and Mach 0.85 at cruise altitude. In still particular embodiments, the engine allows for normal aircraft operation between Mach 0.75 and Mach 0.85. In certain embodiments, the engine allows for rotor blade tip speeds at or less than 750 feet per second (fps). In other embodiments, the rotor blade tip speed at a cruise flight condition can be 650 to 900 fps, or 700 to 800 fps. Alternatively, in certain suitable embodiments, the engine allows for normal aircraft operation of at least Mach 0.3, such as with turboprop engines.

A fan pressure ratio (FPR) for the primary fan of the fan assembly can be 1.04 to 2.20, or in some embodiments 1.05 to 1.2, or in some embodiments less than 1.08, as measured across the fan blades of the primary fan at a cruise flight condition.

In order for the gas turbine engine to operate with a fan having the above characteristics to define the above FPR, a gear assembly may be provided to reduce a rotational speed of the fan assembly relative to a driving shaft (such as a low pressure shaft coupled to a low pressure turbine). In some embodiments, a gear ratio of the input rotational speed to the output rotational speed is between 3.0 and 4.0, between 3.2 and 3.5, or between 3.5 and 4.5. In some embodiments, a gear ratio of the input rotational speed to the output rotational speed is greater than 4.1. For example, in particular embodiments, the gear ratio is within a range of 4.0 to 4.5, within a range of 4.1 to 14.0, within a range of 4.5 to 14.0, or within a range of 6.0 to 14.0. In certain embodiments, the gear ratio is within a range of 4.5 to 12 or within a range of 6.0 to 11.0.

With respect to a turbomachine of the gas turbine engine, the compressors and/or turbines can include various stage counts. As disclosed herein, the stage count includes the number of rotors or blade stages in a particular component (e.g., a compressor or turbine). For example, in some embodiments, a low pressure compressor may include 1 to 8 stages, a high-pressure compressor may include 4 to 15 stages, a high-pressure turbine may include 1 to 2 stages, and/or a low pressure turbine (LPT) may include 1 to 7 stages. In particular, the LPT may have 4 stages, or between 4 and 7 stages. For example, in certain embodiments, an engine may include a one stage low pressure compressor, an 11 stage high pressure compressor, a two stage high pressure turbine, and 4 stages, or between 4 and 7 stages for the LPT. As another example, an engine can include a three stage low-pressure compressor, a 10 stage high pressure compressor, a two stage high pressure turbine, and a 7 stage low pressure turbine.

The reduced installed drag may further provide for improved efficiency, such as improved specific fuel consumption. Additionally, or alternatively, the reduced installed drag may provide for cruise altitude engine and aircraft operation at the above described Mach numbers at cruise altitude. Still particular embodiments may provide such benefits with reduced interaction noise between the blade assembly and the vane assembly and/or decreased overall noise generated by the engine by virtue of structures located in an annular duct of the engine.

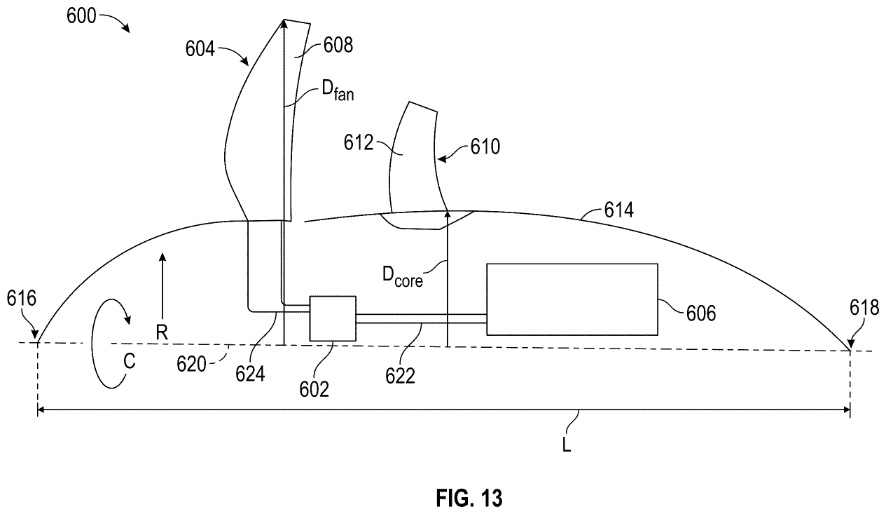

Referring now to FIG. 13, there is shown an exemplary embodiment of an engine 600 including a gear assembly 602 according to aspects of the present disclosure. The engine 600 includes a fan assembly 604 driven by a core engine 606. In various embodiments, the core engine 606 is a Brayton cycle system configured to drive the fan assembly 604. The core engine 606 is shrouded, at least in part, by an outer casing 614. The fan assembly 604 includes a plurality of fan blades 608. A vane assembly 610 extends from the outer casing 614 in a cantilevered manner. Thus, the vane assembly 610 can also be referred to as an unducted vane assembly. The vane assembly 610, including a plurality of vanes 612, is positioned in operable arrangement with the fan blades 608 to provide thrust, control thrust vector, abate or re-direct undesired acoustic noise, and/or otherwise desirably alter a flow of air relative to the fan blades 608.

In some embodiments, the fan assembly 604 includes eight (8) to twenty-six (26) fan blades 608. In particular embodiments, the fan assembly 604 includes ten (10) to twenty-two (22) fan blades 608. In certain embodiments, the fan assembly 604 includes twelve (12) to eighteen (18) fan blades 608. In some embodiments, the vane assembly 110 includes three (3) to thirty (30) vanes 612. In certain embodiments, the vane assembly 110 includes an equal or fewer quantity of vanes 612 to fan blades 608. For example, in particular embodiments, the engine 600 includes twelve (12) fan blades 608 and ten (10) vanes 612. In other embodiments, the vane assembly 610 includes a greater quantity of vanes 612 to fan blades 608. For example, in particular embodiments, the engine 600 includes ten (10) fan blades 608 and twenty-three (23) vanes 612. In another particular embodiment, the engine 600 includes fourteen (14) fan blades 608.

In certain embodiments, such as depicted in FIG. 13, the vane assembly 610 is positioned downstream or aft of the fan assembly 604. However, it should be appreciated that in some embodiments, the vane assembly 610 may be positioned upstream or forward of the fan assembly 604. In still various embodiments, the engine 600 may include a first vane assembly positioned forward of the fan assembly 604 and a second vane assembly positioned aft of the fan assembly 604. The fan assembly 604 may be configured to desirably adjust pitch at one or more fan blades 608, such as to control thrust vector, abate or re-direct noise, and/or alter thrust output. The vane assembly 610 may be configured to desirably adjust pitch at one or more vanes 612, such as to control thrust vector, abate or re-direct noise, and/or alter thrust output. Pitch control mechanisms at one or both of the fan assembly 604 or the vane assembly 610 may co-operate to produce one or more desired effects described above.

In certain embodiments, such as depicted in FIG. 13, the engine 600 is an un-ducted thrust producing system, such that the plurality of fan blades 608 is unshrouded by a nacelle or fan casing. As such, in various embodiments, the engine 600 may be configured as an unshrouded turbofan engine, an open rotor engine, or a propfan engine. In particular embodiments, the engine 600 is an unducted rotor engine with a single row of fan blades 608. The fan blades 608 can have a large diameter, such as may be suitable for high bypass ratios, high cruise speeds (e.g., comparable to aircraft with turbofan engines, or generally higher cruise speed than aircraft with turboprop engines), high cruise altitude (e.g., comparable to aircraft with turbofan engines, or generally higher cruise speed than aircraft with turboprop engines), and/or relatively low rotational speeds.

The fan blades 608 comprise a diameter (D_{fan}). It should be noted that for purposes of illustration only half of the D_{fan} is shown (i.e., the radius of the fan). In some embodiments, the D_{fan} is 72-216 inches. In particular embodiments the D_{fan} is 100-200 inches. In certain embodiments, the D_{fan} is 120-190 inches. In other embodiments, the D_{fan} is 72-120 inches. In other embodiments, the D_{fan} is 80-100 inches. In yet other embodiments, the D_{fan} is 50-80 inches.

In some embodiments, the fan blade tip speed at a cruise flight condition can be 650 to 900 fps, or 700 to 800 fps. A fan pressure ratio (FPR) for the fan assembly 104 can be 1.04 to 1.10, or in some embodiments 1.05 to 1.08, as measured across the fan blades at a cruise flight condition. In other examples, a fan pressure ratio for the fan assembly can be 1.05-1.5 (or 1.05-1.15 or 1.2-1.4) as measured at a static sea-level takeoff operating condition.

The core engine 606 is generally encased in outer casing 614 defining one half of a core diameter (D_{core}), which may be thought of as the maximum extent from the centerline axis (datum for R). In certain embodiments, the engine 600 includes a length (L) from a longitudinally (or axial) forward end 616 to a longitudinally aft end 618. In various embodiments, the engine 600 defines a ratio of L/D_{core} that provides for reduced installed drag. In one embodiment, L/D_{core} is at least 2. In another embodiment, L/D_{core} is at least 2.5. In some embodiments, the L/D_{core} is less than 5, less than 4, and less than 3. In various embodiments, it should be appreciated that the L/D_{core} is for a single unducted rotor engine.

The reduced installed drag may further provide for improved efficiency, such as improved specific fuel consumption. Additionally, or alternatively, the reduced drag may provide for cruise altitude engine and aircraft operation at or above Mach 0.5. In certain embodiments, the L/D_{core}, the fan assembly 604, and/or the vane assembly 110 separately or together configure, at least in part, the engine 600 to operate at a maximum cruise altitude operating speed between approximately Mach 0.55 and approximately Mach 0.85; or between approximately 0.72 to 0.85 or between approximately 0.75 to 0.85.

Referring still to FIG. 13, the core engine 606 extends in a radial direction (R) relative to an engine centerline axis 620. The gear assembly 602 receives power or torque from the core engine 606 through a power input source 622 and provides power or torque to drive the fan assembly 604, in a circumferential direction C about the engine centerline axis 620, through a power output source 624.

The gear assembly 602 of the engine 600 can include a plurality of gears, including an input and an output. The gear assembly 602 can also include one or more intermediate gears disposed between and/or interconnecting the input and the output. The input can be coupled to a turbine section of the core engine 606 and can comprise a first rotational speed. The output can be coupled to the fan assembly and can have a second rotational speed. In some embodiments, a gear ratio of the first rotational speed to the second rotational speed is greater than 4.1 (e.g., within a range of 4.1-14.0).

The gear assembly 602 (which can also be referred to as “a gearbox”) can comprise various types and/or configuration. For example, in some embodiments, the gearbox is an epicyclic gearbox configured in a star gear configuration. Star gear configurations comprise a sun gear, a plurality of star gears (which can also be referred to as “planet gears”), and a ring gear. The sun gear is the input and is coupled to the power turbine (e.g., the low-pressure turbine) such that the sun gear and the power turbine rotate at the same rotational speed. The star gears are disposed between and interconnect the sun gear and the ring gear. The star gears are rotatably coupled to a fixed carrier. As such, the star gears can rotate about their respective axes but cannot collectively orbit relative to the sun gear or the ring gear. As another example, the gearbox is an epicyclic gearbox configured in a planet gear configuration. Planet gear configurations comprise a sun gear, a plurality of planet gears, and a ring gear. The sun gear is the input and is coupled to the power turbine. The planet gears are disposed between and interconnect the sun gear and the ring gear. The planet gears are rotatably coupled to a rotatable carrier. As such, the planet gears can rotate about their respective axes and also collectively rotate together with the carrier relative to the sun gear and the ring gear. The carrier is the output and is coupled to the fan assembly. The ring gear is fixed from rotation.

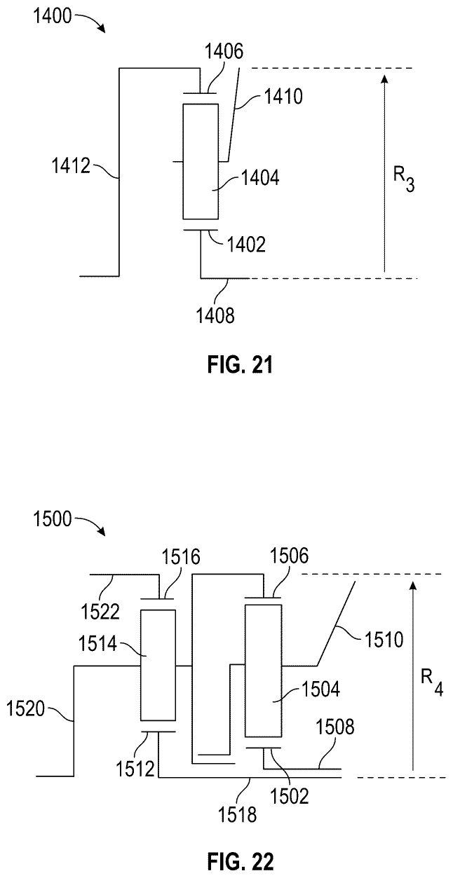

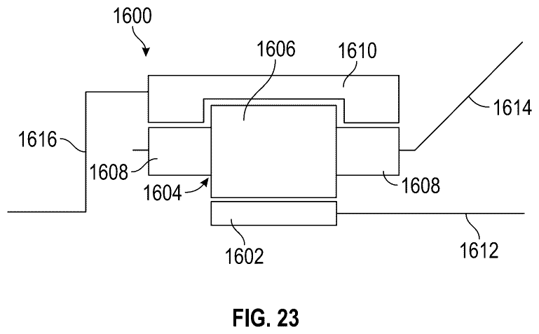

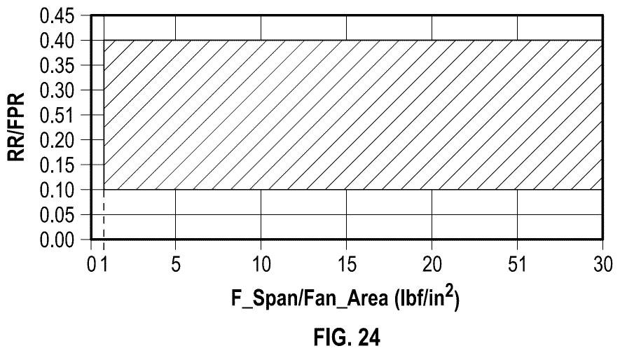

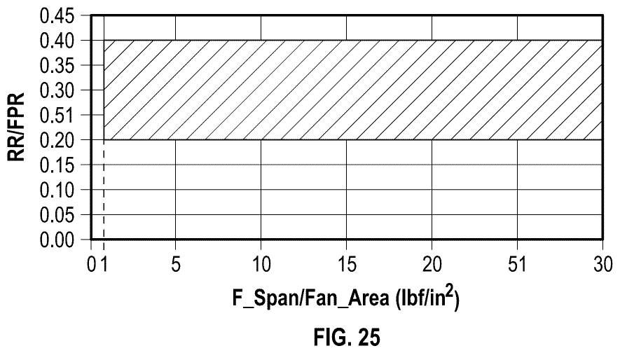

In some embodiments, the gearbox is a single-stage gearbox (e.g., FIGS. 22-23). In other embodiments, the gearbox is a multi-stage gearbox (e.g., FIGS. 21 and 24). In some embodiments, the gearbox is an epicyclic gearbox. In some embodiments, the gearbox is a non-epicyclic gearbox (e.g., a compound gearbox—FIG. 25).

As noted above, the gear assembly can be used to reduce the rotational speed of the output relative to the input. In some embodiments, a gear ratio of the input rotational speed to the output rotational speed is greater than 4.1. For example, in particular embodiments, the gear ratio is within a range of 4.1-14.0, within a range of 4.5-14.0, or within a range of 6.0-14.0. In certain embodiments, the gear ratio is within a range of 4.5-12 or within a range of 6.0-11.0. As such, in some embodiments, the fan assembly can be configured to rotate at a rotational speed of 700-1500 rpm at a cruise flight condition, while the power turbine (e.g., the low-pressure turbine) is configured to rotate at a rotational speed of 2,500-15,000 rpm at a cruise flight condition. In particular embodiments, the fan assembly can be configured to rotate at a rotational speed of 850-1350 rpm at a cruise flight condition, while the power turbine is configured to rotate at a rotational speed of 5,000-10,000 rpm at a cruise flight condition.

In some examples, a gear ratio of the input rotational speed to the output rotational speed is less than 6.0. Gear ratios less than six (e.g., 2.0-6.0) may be particularly suited for the ducted engines disclosed herein. For example, in particular embodiments, the gear ratio is within a range of 2.0-4.1, within a range of 2.5-3.75, or within a range of 3.2-4.1. In certain embodiments, the gear ratio is within a range of 3.0-3.5 or within a range of 3.25-3.55.

Various gear assembly configurations are depicted schematically in FIGS. 21-25. These gearboxes can be used any of the engines disclosed herein, including the engine 600. Additional details regarding the gearboxes are provided below.

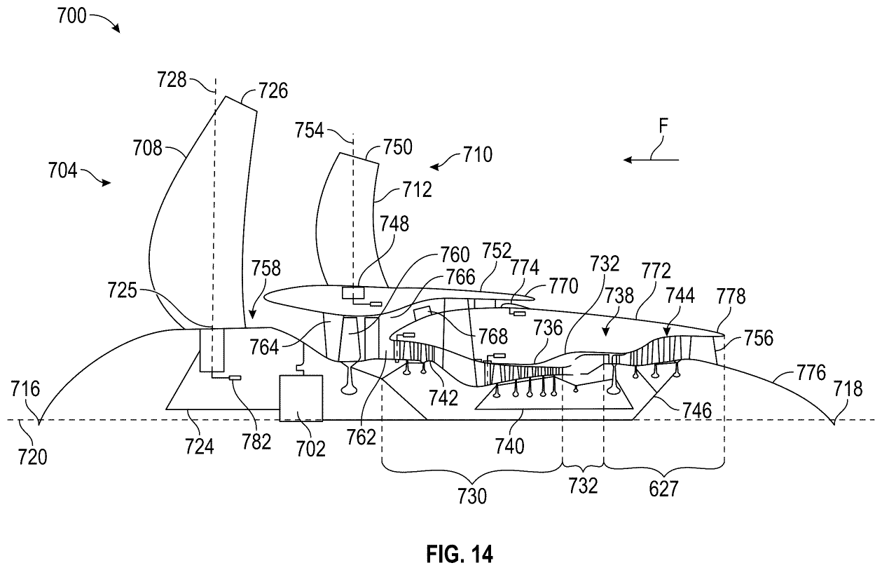

FIG. 14 shows a cross-sectional view of an engine 700, which is configured as an exemplary embodiment of an open rotor propulsion engine. The engine 7 is generally similar to the engine 600 and corresponding components have been numbered similarly. For example, the gear assembly of the engine 600 is numbered “602” and the gear assembly of the engine 700 is numbered “702,” and so forth. In addition to the gear assembly 702, the engine 700 comprises a fan assembly 704 that includes a plurality of fan blades 708 distributed around an engine centerline axis 720 extending from a forward end 716 to a longitudinally aft end 718. Fan blades 708 are circumferentially arranged in an equally spaced relation around the engine centerline axis 720, and each fan blade 708 has a root 725 and a tip 726, and an axial span defined therebetween, as well as a central blade axis 728.

The core engine 706 includes a compressor section 730, a combustion section 732, and a turbine section 734 (which may be referred to as “an expansion section”) together in a serial flow arrangement. The core engine 706 extends circumferentially relative to an engine centerline axis 720. The core engine 706 includes a high-pressure spool that includes a high-pressure compressor 736 and a high-pressure turbine 738 operably rotatably coupled together by a high-pressure shaft 740. The combustion section 732 is positioned between the high-pressure compressor 736 and the high-pressure turbine 738.

The combustion section 732 may be configured as a deflagrative combustion section, a rotating detonation combustion section, a pulse detonation combustion section, and/or other appropriate heat addition system. The combustion section 732 may be configured as one or more of a rich-burn system or a lean-burn system, or combinations thereof. In still various embodiments, the combustion section 732 includes an annular combustor, a can combustor, a cannular combustor, a trapped vortex combustor (TVC), or other appropriate combustion system, or combinations thereof.

The core engine 706 also includes a booster or low-pressure compressor positioned in flow relationship with the high-pressure compressor 736. The low-pressure compressor 742 is rotatably coupled with the low-pressure turbine 744 via a low-pressure shaft 746 to enable the low-pressure turbine 744 to drive the low-pressure compressor 742. The low-pressure shaft 746 is also operably connected to the gear assembly 702 to provide power to the fan assembly 704, such as described further herein.

It should be appreciated that the terms “low” and “high,” or their respective comparative degrees (e.g., “lower” and “higher,” where applicable), when used with compressor, turbine, shaft, or spool components, each refer to relative pressures and/or relative speeds within an engine unless otherwise specified. For example, a “low spool” or “low-speed shaft” defines a component configured to operate at a rotational speed, such as a maximum allowable rotational speed, lower than a “high spool” or “high-speed shaft” of the engine. Alternatively, unless otherwise specified, the aforementioned terms may be understood in their superlative degree. For example, a “low turbine” or “low-speed turbine” may refer to the lowest maximum rotational speed turbine within a turbine section, a “low compressor” or “low speed compressor” may refer to the lowest maximum rotational speed turbine within a compressor section, a “high turbine” or “high-speed turbine” may refer to the highest maximum rotational speed turbine within the turbine section, and a “high compressor” or “high-speed compressor” may refer to the highest maximum rotational speed compressor within the compressor section. Similarly, the low-speed spool refers to a lower maximum rotational speed than the high-speed spool. It should further be appreciated that the terms “low” or “high” in such aforementioned regards may additionally, or alternatively, be understood as relative to minimum allowable speeds, or minimum or maximum allowable speeds relative to normal, desired, steady state, etc. operation of the engine.

The compressors and/or turbines disclosed herein can include various stage counts. As disclosed herein the stage count includes the number of rotors or blade stages in a particular component (e.g., a compressor or turbine). For example, in some embodiments, a low-pressure compressor can comprise 1-8 stages or more narrowly 3 or 4 stages, a high-pressure compressor can comprise 8-15 stages or more narrowly 8-11 stages, or 8-10 stages, or 8 or 9 stages, a high-pressure turbine comprises 1-2 stages, and/or a low-pressure turbine comprises 3-7 stages, or more narrowly 3-5 stages. For example, in certain embodiments, an engine can comprise a one, two, or three stage low-pressure compressor, a 9 or 10 stage high-pressure compressor, a one or two stage high-pressure turbine, and a 4 stage low-pressure turbine. As another example, an engine can comprise a three or four stage low-pressure compressor, a 10 stage high-pressure compressor, a two stage high-pressure turbine, and a 4 stage low-pressure turbine.

In some embodiments, a low-pressure turbine is a counter-rotating low-pressure turbine comprising inner blade stages and outer blade stages. The inner blade stages extend radially outwardly from an inner shaft, and the outer blade stages extend radially inwardly from an outer drum. In particular embodiments, the counter-rotating low-pressure turbine comprises three inner blade stages and three outer blade stages, which can collectively be referred to as a six stage low-pressure turbine. In other embodiments, the counter-rotating low-pressure turbine comprises four inner blade stages and three outer blade stages, which can collectively be referred to as a seven stage low-pressure turbine.

As discussed in more detail below, the core engine 706 includes the gear assembly 702 that is configured to transfer power from the turbine section 734 and reduce an output rotational speed at the fan assembly 704 relative to the low-pressure turbine 744. Embodiments of the gear assembly 702 depicted and described herein can allow for gear ratios suitable for large-diameter unducted fans (e.g., gear ratios of 4.1-4.5, 4.1-14.0, 4.5-14.0, and/or 6.0-14.0). Additionally, embodiments of the gear assembly 702 provided herein may be suitable within the radial or diametrical constraints of the core engine 706 within the outer casing 714.

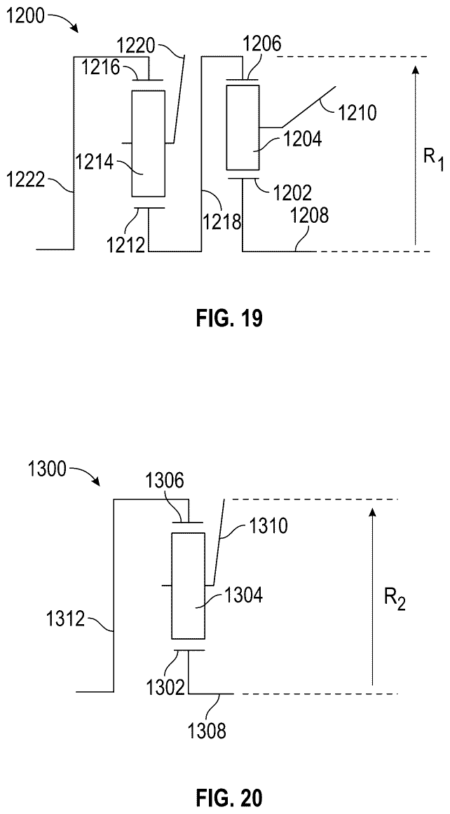

Various gearbox configurations are depicted schematically in FIGS. 19-23. These gearboxes can be used in any of the engines disclosed herein, including the engine 700. Additional details regarding the gearboxes are provided below.

Engine 700 also includes a vane assembly 710 comprising a plurality of vanes 712 disposed around engine centerline axis 720. Each vane 712 has a root 748 and a tip 750, and a span defined therebetween. Vanes 712 can be arranged in a variety of manners. In some embodiments, for example, they are not all equidistant from the rotating assembly.

In some embodiments, vanes 712 are mounted to a stationary frame and do not rotate relative to the engine centerline axis 720 but may include a mechanism for adjusting their orientation relative to their axis 754 and/or relative to the fan blades 708. For reference purposes, FIG. 14 depicts a forward direction denoted with arrow F, which in turn defines the forward and aft portions of the system.

As depicted in FIG. 14, the fan assembly 704 is located forward of the core engine 706 with the exhaust 756 located aft of core engine 706 in a “puller” configuration. Other configurations are possible and contemplated as within the scope of the present disclosure, such as what may be termed a “pusher” configuration embodiment where the engine core is located forward of the fan assembly. The selection of “puller” or “pusher” configurations may be made in concert with the selection of mounting orientations with respect to the airframe of the intended aircraft application, and some may be structurally or operationally advantageous depending upon whether the mounting location and orientation are wing-mounted, fuselage-mounted, or tail-mounted configurations.

Left- or right-handed engine configurations, useful for certain installations in reducing the impact of multi-engine torque upon an aircraft, can be achieved by mirroring the airfoils (e.g., 708, 712) such that the fan assembly 704 rotates clockwise for one propulsion system and counterclockwise for the other propulsion system. Alternatively, an optional reversing gearbox can be provided to permits a common gas turbine core and low-pressure turbine to be used to rotate the fan blades either clockwise or counterclockwise, i.e., to provide either left- or right-handed configurations, as desired, such as to provide a pair of oppositely-rotating engine assemblies can be provided for certain aircraft installations while eliminating the need to have internal engine parts designed for opposite rotation directions.

The engine 700 also includes the gear assembly 702 which includes a gear set for decreasing the rotational speed of the fan assembly 704 relative to the low-pressure turbine 744. In operation, the rotating fan blades 708 are driven by the low-pressure turbine 744 via gear assembly 702 such that the fan blades 708 rotate around the engine centerline axis 720 and generate thrust to propel the engine 700, and hence an aircraft on which it is mounted, in the forward direction F.

In some embodiments, a gear ratio of the input rotational speed to the output rotational speed is greater than 4.1, such as between 4.1 and 4.5 for a ducted turbofan with variable pitch and between 6.0 and 10.0 for an open rotor turbofan. For example, in particular embodiments, the gear ratio is within a range of 4.1-14.0, within a range of 4.5-14.0, or within a range of 6.0-14.0. In certain embodiments, the gear ratio is within a range of 4.5-12 or within a range of 6.0-11.0. As such, in some embodiments, the fan assembly can be configured to rotate at a rotational speed of 700-1500 rpm at a cruise flight condition, while the power turbine (e.g., the low-pressure turbine) is configured to rotate at a rotational speed of 5,000-10,000 rpm at a cruise flight condition. In particular embodiments, the fan assembly can be configured to rotate at a rotational speed of 850-1350 rpm at a cruise flight condition, while the power turbine is configured to rotate at a rotational speed of 5,500-9,500 rpm a cruise flight condition.

It may be desirable that either or both of the fan blades 708 or the vanes 712 to incorporate a pitch change mechanism such that the blades can be rotated with respect to an axis of pitch rotation (annotated as 728 and 754, respectively) either independently or in conjunction with one another. Such pitch change can be utilized to vary thrust and/or swirl effects under various operating conditions, including to provide a thrust reversing feature which may be useful in certain operating conditions such as upon landing an aircraft.

Vanes 712 can be sized, shaped, and configured to impart a counteracting swirl to the fluid so that in a downstream direction aft of both fan blades 708 and vanes 712 the fluid has a greatly reduced degree of swirl, which translates to an increased level of induced efficiency. Vanes 712 may have a shorter span than fan blades 708, as shown in FIG. 14. For example, vanes 712 may have a span that is at least 50% of a span of fan blades 708. In some embodiments, the span of the vanes can be the same or longer than the span as fan blades 708, if desired. Vanes 712 may be attached to an aircraft structure associated with the engine 700, as shown in FIG. 14, or another aircraft structure such as a wing, pylon, or fuselage. Vanes 712 may be fewer or greater in number than, or the same in number as, the number of fan blades 708. In some embodiments, the number of vanes 712 are greater than two, or greater than four, in number. Fan blades 708 may be sized, shaped, and contoured with the desired blade loading in mind.

In the embodiment shown in FIG. 14, an annular 360-degree inlet 758 is located between the fan assembly 704 and the vane assembly 710 and provides a path for incoming atmospheric air to enter the core engine 706 radially inwardly of at least a portion of the vane assembly 710. Such a location may be advantageous for a variety of reasons, including management of icing performance as well as protecting the inlet 758 from various objects and materials as may be encountered in operation.

In the exemplary embodiment of FIG. 14, in addition to the open rotor or unducted fan assembly 704 with its plurality of fan blades 708, an optional ducted fan assembly 760 is included behind fan assembly 704, such that the engine 700 includes both a ducted and an unducted fan which both serve to generate thrust through the movement of air at atmospheric temperature without passage through the core engine 706. The ducted fan assembly 760 is shown at about the same axial location as the vane 712, and radially inward of the root 748 of the vane 712. Alternatively, the ducted fan assembly 760 may be between the vane 712 and core duct 762 or be farther forward of the vane 712. The ducted fan assembly 760 may be driven by the low-pressure turbine 744, or by any other suitable source of rotation, and may serve as the first stage of the low-pressure compressor 742 or may be operated separately. Air entering the inlet 758 flows through an inlet duct 764 and then is divided such that a portion flows through a core duct 762 and a portion flows through a fan duct 766. Fan duct 766 may incorporate one or more heat exchangers 768 and exhausts to the atmosphere through an independent fixed or variable nozzle 770 aft of the vane assembly 710, at the aft end of the fan cowl 752 and outside of the engine core cowl 772. Air flowing through the fan duct 766 thus “bypasses” the core of the engine and does not pass through the core.

Thus, in the exemplary embodiment, engine 700 includes an unducted fan formed by the fan blades 708, followed by the ducted fan assembly 760, which directs airflow into two concentric or non-concentric ducts 762 and 766, thereby forming a three-stream engine architecture with three paths for air which passes through the fan assembly 704. The “first stream” of the engine 700 comprises airflow that passes through the vane assembly 710 and/or outside the fan cowl 752. As such, the first stream can be referred to as “the bypass stream” since the airflow of the first stream does not pass through the core duct 762. The first stream produces the majority of the thrust of the engine 700 and can thus also be referred to as “the primary propulsion stream.” The “second stream” of the engine 700 comprises the airflow that flows into the inlet 758, through the inlet duct 764, through the core duct 762, and exits the core nozzle 778. In this manner, the second stream can be referred to as “the core stream.” The “third stream” of the engine 700 comprises the airflow that flows into the inlet 758, through the inlet duct 764, through the fan duct 766, and exits the nozzle 770.

In various embodiments the fan duct 766, having the one or heat exchangers 768 located within the flowpath of the fan duct 766, may be referred to as the “third-stream” of the three-stream engine architecture.

The pressure ratio of the third stream is higher than that of the primary propulsion stream (i.e., the bypass stream). This thrust is produced through a dedicated nozzle or through mixing of the secondary stream with a fan stream or a core stream (e.g., into a common nozzle). In certain exemplary embodiments the operating temperature of an airflow through the third stream is less than a maximum compressor discharge temperature for the engine, and more specifically may be less than 350 degrees Fahrenheit (such as less than 300 degrees Fahrenheit, such as less than 250 degrees Fahrenheit, such as less than 200 degrees Fahrenheit, and at least as great as an ambient temperature). In certain exemplary embodiments these operating temperatures facilitate the heat transfer to or from the fluid in the third stream and a secondary fluid stream. Further, in certain exemplary embodiments, the airflow through the third stream may contribute less than 50% of the total engine thrust (and at least, e.g., 2% of the total engine thrust), and at a takeoff condition, or more particularly while operating at a rated takeoff power at sea level, static flight speed, 86 degrees Fahrenheit ambient temperature operating conditions. Furthermore, in certain exemplary embodiments the airstream, mixing, or exhaust properties (and thereby the aforementioned exemplary percent contribution to total thrust) of the third stream may passively adjust during engine operation or be modified purposefully through use of engine control features (such as fuel flow, electric machine power, variable stators, variable inlet guide vanes, valves, variable exhaust geometry, or fluidic features) to adjust or optimize overall system performance across a broad range of potential operating conditions.

In the exemplary embodiment shown in FIG. 14, a slidable, moveable, and/or translatable plug nozzle 774 with an actuator may be included in order to vary the exit area of the nozzle 770. A plug nozzle is typically an annular, symmetrical device which regulates the open area of an exit such as a fan stream or core stream by axial movement of the nozzle such that the gap between the nozzle surface and a stationary structure, such as adjacent walls of a duct, varies in a scheduled fashion thereby reducing or increasing a space for airflow through the duct. Other suitable nozzle designs may be employed as well, including those incorporating thrust reversing functionality. Such an adjustable, moveable nozzle may be designed to operate in concert with other systems such as variable bleed valves (VBV's), variable stator vanes (VSV's), or blade pitch mechanisms and may be designed with failure modes such as fully-open, fully-closed, or intermediate positions, so that the nozzle 770 has a consistent “home” position to which it returns in the event of any system failure, which may prevent commands from reaching the nozzle 770 and/or its actuator. In other embodiments a static nozzle may be utilized.

In some embodiments, a mixing device 776 can be included in a region aft of a core nozzle 778 to aid in mixing the fan stream and the core stream to improve acoustic performance by directing core stream outward and fan stream inward.

Since the engine 700 shown in FIG. 14 includes both an open rotor fan assembly 704, a ducted fan assembly 760 and the third stream, the engine's thrust output and work split can be tailored to achieve specific thrust, fuel burn, thermal management, and/or acoustic signature objectives which may be superior to those of a typical ducted or unducted fan gas turbine propulsion assembly of comparable thrust class. Operationally, the engine 700 may include a control system that manages the loading of the respective open and ducted fans, as well as potentially the exit area of the variable fan nozzle, to provide different thrust, noise, cooling capacity and other performance characteristics for various portions of the flight envelope and various operational conditions associated with aircraft operation. For example, in climb mode the ducted fan may operate at maximum pressure ratio there-by maximizing the thrust capability of stream, while in cruise mode, the ducted fan may operate a lower pressure ratio, raising overall efficiency through reliance on thrust from the unducted fan. Nozzle actuation modulates the ducted fan operating line and overall engine fan pressure ratio independent of total engine airflow. In other embodiments, loading may be managed using a static nozzle.

As noted above, the third stream (e.g., the fan duct 766) may include one or more heat exchangers 768 for removing heat from various fluids used in engine operation (such as an air-cooled oil cooler (ACOC), cooled cooling air (CCA), etc.). Heat exchangers 768 located in the third stream take advantage of the integration into the fan duct 766 with reduced performance penalties (such as fuel efficiency and thrust) compared with traditional ducted fan architectures, due to not impacting the primary source of thrust which is, in this case, the unducted fan stream. Heat exchangers may cool fluids such as gearbox oil, engine sump oil, thermal transport fluids such as supercritical fluids or commercially available single-phase or two-phase fluids (supercritical CO₂, EGV, Slither 800, liquid metals, etc.), engine bleed air, etc. Heat exchangers may also be made up of different segments or passages that cool different working fluids, such as an ACOC paired with a fuel cooler. Heat exchangers 768 may be incorporated into a thermal management system which provides for thermal transport via a heat exchange fluid flowing through a network to remove heat from a source and transport it to a heat exchanger.

The third stream can provide advantages in terms of reduced nacelle drag, enabling a more aggressive nacelle close-out, improved core stream particle separation, and inclement weather operation. By exhausting the fan duct flow over the core cowl, this aids in energizing the boundary layer and enabling the option of a steeper nacelle close out angle between the maximum dimension of the engine core cowl 772 and the exhaust 756. The close-out angle is normally limited by air flow separation, but boundary layer energization by air from the fan duct 766 exhausting over the core cowl reduces air flow separation. This yields a shorter, lighter structure with less frictional surface drag.

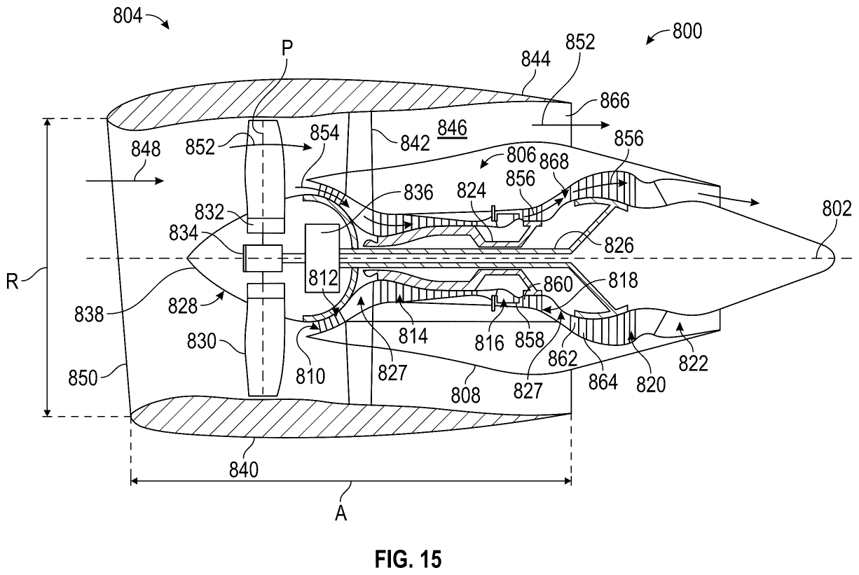

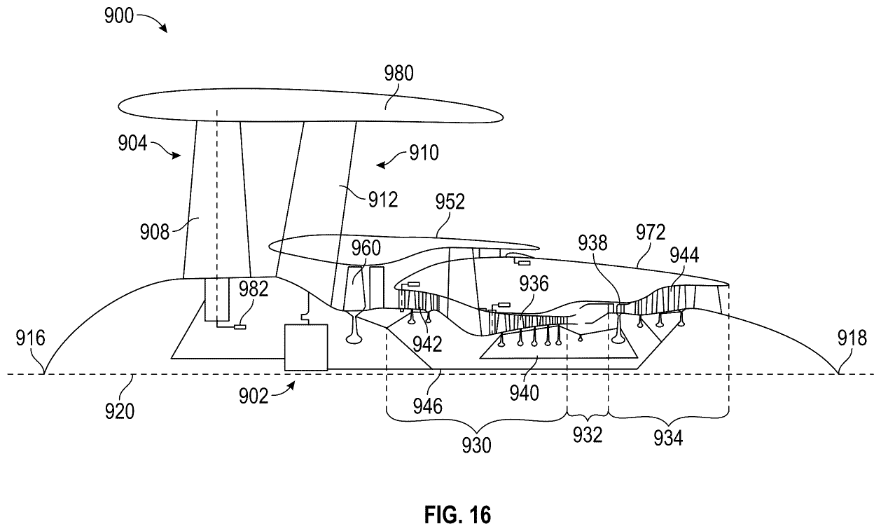

The fan assembly and/or vane assembly can be shrouded or unshrouded (as shown in FIGS. 13 and 14). Although not shown, an optional annular shroud or duct can be coupled to the vane assembly 710 and located distally from the engine centerline axis 720 relative to the vanes 712. In addition to the noise reduction benefit, the duct may provide improved vibratory response and structural integrity of the vanes 712 by coupling them into an assembly forming an annular ring or one or more circumferential sectors, i.e., segments forming portions of an annular ring linking two or more of the vanes 712. The duct may also allow the pitch of the vanes to be varied more easily. For example, FIGS. 15-16, discussed in more detail below, disclose embodiments in which both the fan assembly and vane assembly are shrouded.

Although depicted above as an unshrouded or open rotor engine in the embodiments depicted above, it should be appreciated that aspects of the disclosure provided herein may be applied to shrouded or ducted engines, partially ducted engines, aft-fan engines, or other turbomachinery configurations, including those for marine, industrial, or aero-propulsion systems. Certain aspects of the disclosure may be applicable to turbofan, turboprop, or turboshaft engines. However, it should be appreciated that certain aspects of the disclosure may address issues that may be particular to unshrouded or open rotor engines, such as, but not limited to, issues related to gear ratios, fan diameter, fan speed, length (L) of the engine, maximum diameter of the core engine (D_{core}) of the engine, L/D_{core} of the engine, desired cruise altitude, and/or desired operating cruise speed, or combinations thereof.

The unducted engines 600, 700 can comprise pitch change mechanisms configured for adjusting the pitch for fan. In this manner the fans of the engines 600, 700 are VPFs. For example, the engine 700 comprises a pitch change mechanism 782 coupled to the fan assembly 704 and configured to vary the pitch of the fan blades 708. In certain embodiments, the pitch change mechanism 782 can be a linear actuated pitch change mechanism.

In some examples, the unducted engines 600, 700 can be designed such that any one of the engines 600, 700 can be characterized by a thrust to power airflow ratio between 3.5 and 100, such as between 14 and 75, between 30 and 60, and/or between 35 and 50. In some examples, any one of the engines 600, 700 can be characterized by a core bypass ratio between 0.1 and 10, such as between 0.3 and 5 or between 0.5 and 3. In this way, the engines 600, 700 can exhibit a desirable balance between improved propulsive efficiency and acceptable size, weight, and/or thermal management capabilities.

FIG. 15 is a schematic cross-sectional view of a gas turbine engine in accordance with an exemplary embodiment of the present disclosure. More particularly, for the embodiment of FIG. 15, the gas turbine engine is a high-bypass turbofan jet engine 800, referred to herein as “turbofan engine 800.” As shown in FIG. 15, the turbofan engine 800 defines an axial direction A (extending parallel to a longitudinal centerline 802 provided for reference) and a radial direction R (extending perpendicular to the axial direction A). In general, the engine 800 includes a fan section 804 and a core engine 806 disposed downstream from the fan section 804. The engine 800 also includes a gear assembly or power gear box 836 having a plurality of gears for coupling a gas turbine shaft to a fan shaft. The position of the power gear box 836 is not limited to that as shown in the exemplary embodiment of the engine 800. For example, the position of the power gear box 836 may vary along the axial direction A.

The exemplary core engine 806 depicted generally includes a substantially tubular outer casing 808 that defines an annular inlet 810. The outer casing 808 encases, in serial flow relationship, a compressor section including a booster or low-pressure (LP) compressor 812 and a high-pressure (HP) compressor 814; a combustion section 816; a turbine section including a high-pressure (HP) turbine 818 and a low-pressure (LP) turbine 820; and a jet exhaust nozzle section 822. A high-pressure (HP) shaft or spool 824 drivingly connects the HP turbine 318 to the HP compressor 314. A low-pressure (LP) shaft or spool 826 drivingly connects the LP turbine 820 to the LP compressor 812. Additionally, the compressor section, combustion section 816, and turbine section together define at least in part a core air flowpath 827 extending therethrough.

A gear assembly of the present disclosure is compatible with standard fans, variable pitch fans, or other configurations. For the embodiment depicted, the fan section 804 includes a variable pitch fan 828 having a plurality of fan blades 830 coupled to a disk 832 in a spaced apart manner. As depicted, the fan blades 830 extend outwardly from disk 832 generally along the radial direction R. Each fan blade 830 is rotatable relative to the disk 832 about a pitch axis P by virtue of the fan blades 830 being operatively coupled to a suitable actuation member 834 configured to collectively vary the pitch of the fan blades 830. The fan blades 830, disk 832, and actuation member 834 are together rotatable about the longitudinal axis 3802 by LP shaft 826 across a gear assembly or power gear box 836. A gear assembly 836 may enable a speed change between a first shaft, e.g., LP shaft 826, and a second shaft, e.g., LP compressor shaft and/or fan shaft. For example, in one embodiment, the gear assembly 836 may be disposed in an arrangement between a first shaft and a second shaft such as to reduce an output speed from one shaft to another shaft.

More generally, the gear assembly 836 can be placed anywhere along the axial direction A to decouple the speed of two shafts, whenever it is convenient to do so from a component efficiency point of view, e.g., faster LP turbine and slower fan and LP compressor or faster LP turbine and LP compressor and slower fan.

Referring still to the exemplary embodiment of FIG. 15, the disk 832 is covered by rotatable front nacelle 838 aerodynamically contoured to promote an airflow through the plurality of fan blades 830. Additionally, the exemplary fan section 804 includes an annular fan casing or outer nacelle 840 that circumferentially surrounds the fan 828 and/or at least a portion of the core engine 806. The nacelle 840 is, for the embodiment depicted, supported relative to the core engine 806 by a plurality of circumferentially-spaced outlet guide vanes 842. Additionally, a downstream section 844 of the nacelle 840 extends over an outer portion of the core engine 806 so as to define a bypass airflow passage 846 therebetween.

During operation of the turbofan engine 800, a volume of air 848 enters the engine 800 through an associated inlet 850 of the nacelle 840 and/or fan section 804. As the volume of air 848 passes across the fan blades 830, a first portion of the air 848 as indicated by arrows 852 is directed or routed into the bypass airflow passage 846 and a second portion of the air 848 as indicated by arrow 854 is directed or routed into the LP compressor 812. The ratio between the first portion of air 852 and the second portion of air 854 is commonly known as a bypass ratio. The pressure of the second portion of air 854 is then increased as it is routed through the high-pressure (HP) compressor 814 and into the combustion section 816, where it is mixed with fuel and burned to provide combustion gases 856.

The combustion gases 856 are routed through the HP turbine 818 where a portion of thermal and/or kinetic energy from the combustion gases 856 is extracted via sequential stages of HP turbine stator vanes 858 that are coupled to the outer casing 808 and HP turbine rotor blades 860 that are coupled to the HP shaft or spool 824, thus causing the HP shaft or spool 824 to rotate, thereby supporting operation of the HP compressor 814. The combustion gases 856 are then routed through the LP turbine 820 where a second portion of thermal and kinetic energy is extracted from the combustion gases 856 via sequential stages of LP turbine stator vanes 862 that are coupled to the outer casing 808 and LP turbine rotor blades 864 that are coupled to the LP shaft or spool 826, thus causing the LP shaft or spool 826 to rotate, thereby supporting operation of the LP compressor 812 and/or rotation of the fan 828.

The combustion gases 856 are subsequently routed through the jet exhaust nozzle section 822 of the core engine 806 to provide propulsive thrust. Simultaneously, the pressure of the first portion of air 852 is substantially increased as the first portion of air 852 is routed through the bypass airflow passage 846 before it is exhausted from a fan nozzle exhaust section 866 of the engine 800, also providing propulsive thrust. The HP turbine 818, the LP turbine 820, and the jet exhaust nozzle section 822 at least partially define a hot gas path 868 for routing the combustion gases 856 through the core engine 806.

For example, FIG. 16 is a cross-sectional schematic illustration of an exemplary embodiment of an engine 900 that includes a gear assembly 902 in combination with a ducted fan assembly 904 and a core engine 906. The engine 900 extends in the direction of an engine centerline axis 920 extending from a forward end 916 to a longitudinally aft end 918. However, unlike the open rotor configuration of the engine 700, the fan assembly 904 and its fan blades 908 are contained within an annular fan case 980 (which can also be referred to as “a nacelle”) and the vane assembly 910 and the vanes 912 extend radially between the fan cowl 952 (and/or the engine core cowl 972) and the inner surface of the fan case 980, thereby defining the bypass stream. As discussed above, the gear assemblies disclosed herein can provide for increased gear ratios for a fixed gear envelope (e.g., with the same size ring gear), or alternatively, a smaller diameter ring gear may be used to achieve the same gear ratios.

The core engine 906 comprises a compressor section 930, a combustor section 932, and a turbine section 934. The compressor section 930 can include a high-pressure compressor 936 and a booster or a low-pressure compressor 942. The turbine section 934 can include a high-pressure turbine 938 and a low-pressure turbine 944. The low-pressure compressor 942 is positioned forward of and in flow relationship with the high-pressure compressor 936. The low-pressure compressor 942 is rotatably coupled with the low-pressure turbine 944 via a low-pressure shaft 946 to enable the low-pressure turbine 944 to drive the low-pressure compressor 942 (and a ducted fan 960). The low-pressure shaft 946 is also operably connected to the gear assembly 902 to provide power to the fan assembly 904. The high-pressure compressor 936 is rotatably coupled with the high-pressure turbine 938 via a high-pressure shaft 940 to enable the high-pressure turbine 938 to drive the high-pressure compressor 936.

One portion of the airflow from the ducted fan 960 can be directed into the core engine 906 (i.e., a second stream). Another portion of the airflow from the ducted fan 960 can be directed into a third stream 907 defined by the inner surface of the fan cowl 952 and the outer surface of the engine core cowl 972. In some examples, the third stream can comprise one or more heat exchangers.

The engine 900 (and/or the engine 800) comprises a pitch change mechanism 982 coupled to the fan assembly 904 and configured to vary the pitch of the fan blades 908. In certain embodiments, the pitch change mechanism 982 can be a linear actuated pitch change mechanism.

In some embodiments, the engine 900 can comprise a variable fan nozzle. Operationally, the engine 900 may include a control system that manages the loading of the fan, as well as potentially the exit area of the variable fan nozzle, to provide different thrust, noise, cooling capacity and other performance characteristics for various portions of the flight envelope and various operational conditions associated with aircraft operation. For example, nozzle actuation modulates the fan operating line and overall engine fan pressure ratio independent of total engine airflow. In other examples, the engine can comprise a static nozzle.

In some examples, the ducted engines 800, 900 can be designed such that any one of the engines 800, 900 can be characterized by a thrust to power airflow ratio between 3.5 and 100, such as between 3.5 and 40, between 8 and 40, between 14 and 75, between 15 and 40, and/or between 20 and 35. In some examples, any one of the engines 600, 700 can be characterized by a core bypass ratio between 0.1 and 10, such as between 0.2 and 5, between 0.3 and 5, and/or between 0.5 and 3. In this way, the engines 800, 900 can exhibit a desirable balance between improved propulsive efficiency and acceptable size, weight, and/or thermal management capabilities.

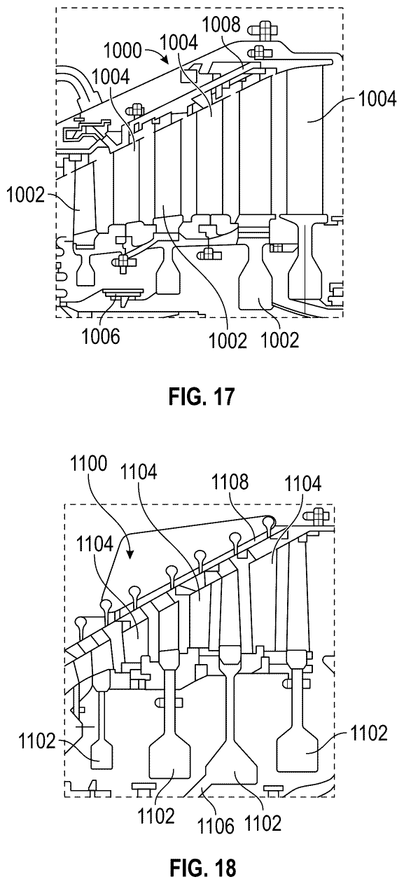

In some embodiments, an engine (e.g., the engine 600, the engine 700, and/or the engine 900) can comprise a counter-rotating low-pressure turbine. For example, FIGS. 17-18 depict schematic cross-sectional illustrations of counter-rotating low-pressure turbines. In particular, FIG. 17 depicts a counter-rotating turbine 1000, and FIG. 18 depicts a counter-rotating turbine 1100. The counter-rotating turbines comprise inner blade stages and outer blade stages arranged in an alternating inner-outer configuration. In other words, the counter-rotating turbines do not comprise stator vanes disposed between the blade stages.

Referring to FIG. 17, the counter-rotating turbine 1000 comprises a plurality of inner blade stages 1002 and a plurality of outer blade stages 1004. More specifically, the counter-rotating turbine 1000 includes three inner blades stages 1002 that are coupled to and extend radially outwardly from an inner shaft 1006 (which can also be referred to as “a rotor”) and three outer blade stages 1004 that are coupled to extend radially inwardly from an outer shaft 1008 (which can also be referred to as “a drum”). In this manner, the counter-rotating turbine 1000 can be considered a six stage turbine.

Referring to FIG. 18, the counter-rotating turbine 1100 comprises a plurality of inner blade stages 1102 and a plurality of outer blade stages 1104. More specifically, the counter-rotating turbine 1100 includes four inner blades stages 1102 that are coupled to and extend radially outwardly from an inner shaft 1106 and three outer blade stages 1104 that are coupled to extend radially inwardly from an outer shaft 1108. In this manner, the counter-rotating turbine 1100 can be considered a seven stage turbine.

According to some embodiments there is a turbomachinery characterized by a high gear ratio. A high gear ratio gearbox means a gearbox with a gear ratio of above about 4:1 to about 14:1 (or about 4.5:1 to about 12:1 in particular embodiments). For example, the engines disclosed herein can include a gearbox configured such the output speed (i.e., the speed of the propulsor) is about 400-1200 rpm at a cruise flight condition, or more particularly 450-1000 rpm at a cruise flight condition.

Various exemplary gear assemblies are shown and described herein. In particular, FIGS. 19-23 schematically depict several exemplary gear assemblies that can be used with the engines 600, 700, 800, 900 and/or the engines 100, 526, 538, 550. The disclosed gear assemblies may be utilized with any of the exemplary engines and/or any other suitable engine for which such gear assemblies may be desirable. In such a manner, it will be appreciated that the gear assemblies disclosed herein may generally be operable with an engine having a rotating element with a plurality of rotor blades and a turbomachinery having a turbine and a shaft rotatable with the turbine. With such an engine, the rotating element (e.g., fan assembly 604) may be driven by the shaft (e.g., low-pressure shaft) of the turbomachinery through the gear assembly.

Although the exemplary gear assemblies shown are mounted at a forward location (e.g., forward from the combustor and/or the low-pressure compressor), in other embodiments, the gear assemblies described herein can be mounted at an aft location (e.g., aft of the combustor and/or the low-pressure turbine).

Various embodiments of the gear assembly provided herein may allow for gear ratios of up to 14:1 (e.g., 2:1 to 14:1). Still various embodiments of the gear assemblies provided herein may allow for gear ratios of at least 4.1:1 or 4.5:1. Still yet various embodiments of the gear assemblies provided herein allow for gear ratios of 6:1 to 12:1.

FIG. 7 schematically depicts a gearbox 1200 that can be used, for example, with engines 600, 700, 800, 900 and/or the engines 100, 526, 538, 550. The gearbox 1200 comprises a two-stage star configuration.

The first stage of the gearbox 1200 includes a first-stage sun gear 1202, a first-stage carrier 1204 housing a plurality of first-stage star gears, and a first-stage ring gear 1206. The first-stage sun gear 1202 can be coupled to a low-pressure shaft 1208, which in turn is coupled to the low-pressure turbine of the engine. The first-stage sun gear 1202 can mesh with the first-stage star gears, which mesh with the first-stage ring gear. The first-stage carrier 1204 can be fixed from rotation by a support member 1210.

The second stage of the gearbox 1200 includes a second-stage sun gear 1212, a second-stage carrier 1214 housing a plurality of second-stage star gears, and a second-stage ring gear 1216. The second-stage sun gear 1212 can be coupled to a shaft 1218 which in turn is coupled to the first-stage ring gear 1206. The second-stage carrier 1214 can be fixed from rotation by a support member 1220. The second-stage ring gear 1216 can be coupled to a fan shaft 1222.

In some embodiments, each stage of the gearbox 1200 can comprise five star gears. In other embodiments, the gearbox 1200 can comprise fewer or more than five star gears in each stage. In some embodiments, the first-stage carrier can comprise a different number of star gears than the second-stage carrier. For example, the first-stage carrier can comprise five star gears, and the second-stage carrier can comprise three star gears, or vice versa.

In some embodiments, the radius R1 of the gearbox 1200 can be about 16-19 inches. In other embodiments, the radius R1 of the gearbox 1200 can be about 22-24 inches. In other embodiments, the radius R1 of the gearbox 1200 can be smaller than 16 inches or larger than 24 inches.

FIG. 8 schematically depicts a gearbox 1300 that can be used, for example, with engines 600, 700, 600, 700. The gearbox 1300 comprises a single-stage star configuration. The gearbox 1300 includes a sun gear 1302, a carrier 1304 housing a plurality of star gears (e.g., 3-5 star gears), and a ring gear 1306. The sun gear 1302 can mesh with the star gears, and the star gears can mesh with the ring gear 1306. The sun gear 1302 can be coupled to a low-pressure shaft 1308, which in turn is coupled to the low-pressure turbine of the engine. The carrier 1304 can be fixed from rotation by a support member 1310. The ring gear 1306 can be coupled to a fan shaft 1312.

In some embodiments, the radius R2 of the gearbox 1300 can be about 18-23 inches. In other embodiments, the radius R2 of the gearbox 1300 can be smaller than 18 inches or larger than 23 inches.

FIG. 9 schematically depicts a gearbox 1400 that can be used, for example, with engines 600, 700, 800, 900 and/or the engines 100, 526, 538, 550. The gearbox 1400 comprises a single-stage star configuration. The gearbox 1400 includes a sun gear 1402, a carrier 1404 housing a plurality of star gears (e.g., 3-5 star gears), and a ring gear 1406. The sun gear 1402 can mesh with the star gears, and the star gears can mesh with the ring gear 1406. The sun gear 1402 can be coupled to a low-pressure shaft 1408, which in turn is coupled to the low-pressure turbine of the engine. The carrier 1404 can be fixed from rotation by a support member 1410. The ring gear 1406 can be coupled to a fan shaft 1412.

In some embodiments, the radius R3 of the gearbox 1400 can be about 10-13 inches. In other embodiments, the radius R3 of the gearbox 1400 can be smaller than 10 inches or larger than 13 inches.

FIG. 22 schematically depicts a gearbox 1500 that can be used, for example, with engines 600, 700, 800, 900 and/or the engines 100, 526, 538, 550. The gearbox 1500 comprises a two-stage configuration in which the first stage is a star configuration and the second stage is a planet configuration.

The first stage of the gearbox 500 includes a first-stage sun gear 1502, a first-stage star carrier 1504 comprising a plurality of first-stage star gears (e.g., 3-5 star gears), and a first-stage ring gear 1506. The first-stage sun gear 1502 can mesh with the first-stage star gears, and the first-stage star gears can mesh with the first-stage ring gear 1506. The first-stage sun gear 1502 can be coupled to a higher-speed shaft 1508 of the low spool, which in turn is coupled to the inner blades of the low-pressure turbine of the engine. The first-stage star carrier 1504 can be fixed from rotation by a support member 1510.

The second stage of the gearbox 1500 includes a second-stage sun gear 1512, a second-stage planet carrier 1514 comprising a plurality of second-stage planet gears (e.g., 3-5 planet gears), and a second-stage ring gear 1516. The second-stage sun gear 1512 can mesh with the second-stage planet gears. The second-stage planet carrier 1514 can be coupled to the first-stage ring gear 1506. The second-stage sun gear 1512 can be coupled to a lower-speed shaft 1518 of the low spool, which in turn is coupled to the outer blades of the low-pressure turbine. The second-stage planet carrier 1514 can be coupled to the first-stage ring gear 1506. The second-stage planet carrier 1514 can also be coupled to a fan shaft 1520. The second-stage ring gear 1516 can be fixed from rotation by a support member 1522.

In some embodiments, each stage of the gearbox 1500 can comprise three star/planet gears. In other embodiments, the gearbox 1500 can comprise fewer or more than three star/planet gears in each stage. In some embodiments, the first-stage carrier can comprise a different number of star gears than the second-stage carrier has planet gears. For example, the first-stage carrier can comprise five star gears, and the second-stage carrier can comprise three planet gears, or vice versa.

Since the first stage of the gearbox 1500 is coupled to the higher-speed shaft 1508 of the low spool and the second stage of the gearbox 1500 is coupled to the lower-speed shaft 1518 of the low spool, the gear ratio of the first stage of the gearbox 1500 can be greater than the gear ratio of the second stage of the gearbox. For example, in certain embodiments, the first stage of the gearbox can comprise a gear ratio of 4.1-14, and the second stage of the gearbox can comprise a gear ratio that is less than the gear ratio of the first stage of the gearbox. In particular embodiments, the first stage of the gearbox can comprise a gear ratio of 7, and the second stage of the gearbox can comprise a gear ratio of 6.

In some embodiments, an engine comprising the gearbox 1500 can be configured such that the higher-speed shaft 1508 provides about 50% of the power to the gearbox 1500 and the lower-speed shaft 1518 provides about 50% of the power to the gearbox 1500. In other embodiments, an engine comprising the gearbox 1500 can be configured such that the higher-speed shaft 1508 provides about 60% of the power to the gearbox 1500 and the lower-speed shaft 1518 provides about 40% of the power to the gearbox 1500.

In some embodiments, the radius R4 of the gearbox 1500 can be about 18-22 inches. In other embodiments, the radius R4 of the gearbox 1500 can be smaller than 18 inches or larger than 22 inches.

FIG. 23 depicts a gearbox 1600 that can be used, for example, with the engines disclosed herein (e.g., the engines 600, 700, 800, 900, engines 100, 526, 538, 550). The gearbox 1600 is configured as a compound star gearbox. The gearbox 1600 comprises a sun gear 1602 and a star carrier 1604, which includes a plurality of compound star gears having one or more first portions 1606 and one or more second portions 1608. The gearbox 1600 further comprises a ring gear 1610. The sun gear 1602 can also mesh with the first portions 1606 of the star gears. The star carrier can be fixed from rotation via a support member 1614. The second portions 1608 of the star gears can mesh with the ring gear 1610. The sun gear 1602 can be coupled to a low-pressure turbine via the turbine shaft 1612. The ring gear 1610 can be coupled to a fan shaft 1616.

The gear assemblies shown and described herein can be used with any suitable engine. For example, although FIG. 16 shows an optional ducted fan and optional fan duct (similar to that shown in FIG. 14), it should be understood that such gear assemblies can be used with other ducted turbofan engines (e.g., the engine 800) and/or other open rotor engines that do not have one or more of such structures.

The engines depicted in FIGS. 13-16 are configured such that the fan assembly and the core engine are concentric (i.e., the rotate about a common axis, which may also be referred to as “coaxial”). In other embodiments, an engine can be configured such that the fan assembly rotates about a first axis and the core engine rotates about a second axis that are non-concentric (also referred to as “eccentric”).

Each embodiment of a turbomachinery disclosed herein comprises a variable pitch fan (“VPF”) and actuation member (e.g., the actuation member 834), which may also be referred to as a pitch change mechanism. The disclosed engines can also comprise a gearbox. Adoption of a variable pitch fan provides one or more advantages (e.g., increased propulsive efficiency) and also presents significant challenges. For example, incorporating variable pitch fan blades creates challenges with the mechanical packaging and mechanical integration including the packaging and integration of the actuation member and coupling between the blades and actuation member. Turbomachinery that instead have a fixed pitch for fan blades are comparatively simpler to implement. For example, when a fixed pitch turbomachinery is adopted, it is much easier to achieve a reduction in fan radius ratio (as defined below) because less space is needed for packaging and integration of a fan blade below the blade root, e.g., less space is needed because attachment of a blade is made directly to the fan disk as opposed to through a bearing assembly. The desire to achieve an acceptable fan radius ratio while providing a variable pitch capability for a fan blade, and arriving at a turbomachinery design incorporating such a capability while satisfying other necessary requirements, such as acceptable reliability for its intended use, mission requirements, etc., safety margin in the event of, e.g., debris impacting and damaging a fan blade, and accessibility for servicing of a variable pitch fan, blade replacement, etc. presents formidable challenges to overcome.

Starting from this basis, the inventors set out to define the various demands on a variable pitch fan and then constructed a variety of embodiments to meet those varying demands. During the process of developing the aforementioned embodiments of turbomachinery engines comprising variable pitch fans, the inventors discovered, unexpectedly, that a few particular fan parameters arranged in a unique combination provided a good approximation for an overall variable pitch fan design. More specifically, the inventors discovered that certain ranges of values defining embodiments of a variable pitch fan including, but not limited to bearing size, shape, orientation, material, etc., can inform the skilled artisan of the positive and negative attributes of choosing one embodiment over another, and as a function of the performance requirements of the turbomachinery. Thus, the inventors realized they had discovered values defining not only benefits but also penalties associated with choosing one design over another depending on the requirements of the engine (e.g., blade size, tip speed of fan, packaging, integration, etc.). The embodiments defined by these VPF parameters, as they are called, therefore provide a significant benefit because they define a design space down to a reduced number of practical embodiments based on the underlying structural requirements needed to meet the demand. Those structural requirements implicated are with respect to demands such as achieving a particular weight, size, drag, and/other factors relevant to the mechanical packaging of the VPF. For example, the VPF parameter ranges disclosed herein account for limitations (e.g., bearing stress) and thus allow for adequate mechanical integration. One particularly advantageous aspect of the inventor's discovery is that the VPF parameters can be utilized with either unducted or ducted fan designs.

There are two VPF parameters that the inventors discovered to be of particular significance. The first VPF parameter is defined as the hub-to-tip radius ratio of the fan (“RR”) divided by the fan pressure ratio (“FPR”) measured at a static sea-level takeoff operating condition. The second VPF parameter is defined as the bearing spanwise force of the fan (“F_span”) at a redline operating condition measured in pounds force divided by the fan area (“F_area”) measured in square inches.

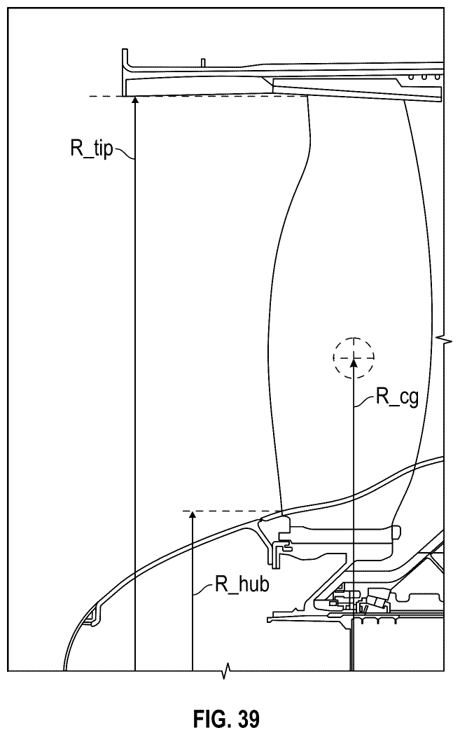

As used herein, fan radius ratio is defined as the fan hub radius (R_hub) divided by the fan tip radius (R_tip), both measured at the leading edge of the fan blades from the fan rotation axis. An exemplary fan comprising the various dimensions is depicted in FIG. 39. In some examples, the fan radius ratio is within a range of 0.125-0.55. In other examples, the fan radius ratio is within a range of 0.2-0.5. In particular examples, the fan radius ratio is within a range of 0.25-0.35.

Fan pressure ratio is defined as the ratio of total pressures across the fan (exit/inlet) during a static sea-level takeoff (SLTO) operating condition. In some examples, the fan pressure ratio at a static sea-level takeoff operating condition is within a range of 1.05-1.5. In other examples, the fan pressure ratio at a static sea-level takeoff operating condition is within a range of 1.05-1.15, which (in certain instances) can correspond to an unducted fan. In particular examples, the fan pressure ratio at a static sea-level takeoff operating condition is within a range of 1.2-1.4, which (in certain instances) can correspond to a ducted fan.

Bearing spanwise force (F_span) of a fan blade is defined as (mass of the fan blade/386.4)*R_cg*ω², where R_cg is the radius of the center of gravity of the fan blade measured from the fan rotation axis (inches), and ω is a redline speed of the fan measured in radians/second. The center of gravity and thus the R_cg can be calculated or approximated in various ways. As one example, R_cg can be approximated by the following equation: R_hub+⅓*(R_tip−R_hub). F_span is measured in pounds force (lbf). In some examples, F_span is within a range of 20,000-200,000 lbf at a redline operating condition. In other examples, F_span is within a range of 50,000-100,000 lbf at a redline operating condition.

The fan blade area (F_area) equals 7π*(R_tip²−R_hub²), which results in an area in square inches. In some examples, F_area is within a range of 3,000-25,000 in². In other examples, F_area is within a range of 5,000-15,000 in². In particular examples, F_area is within a range of 4,000-8,000 in².

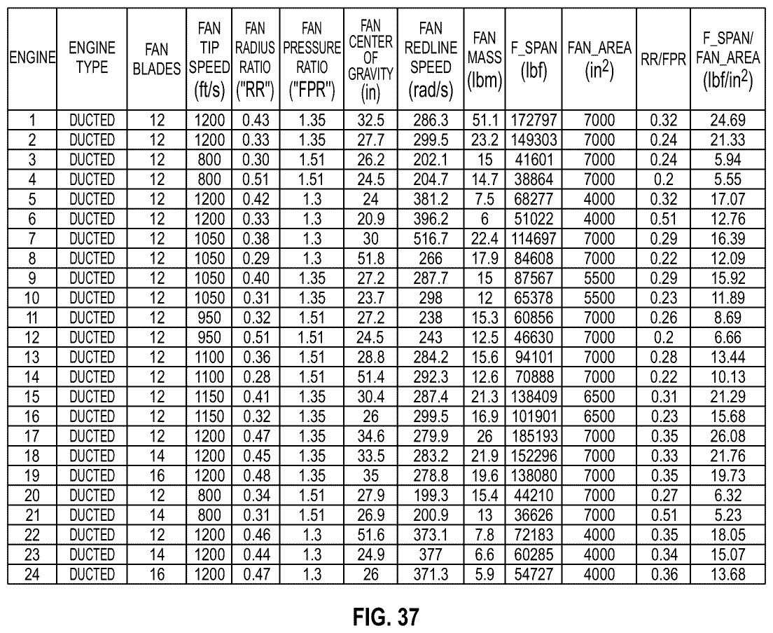

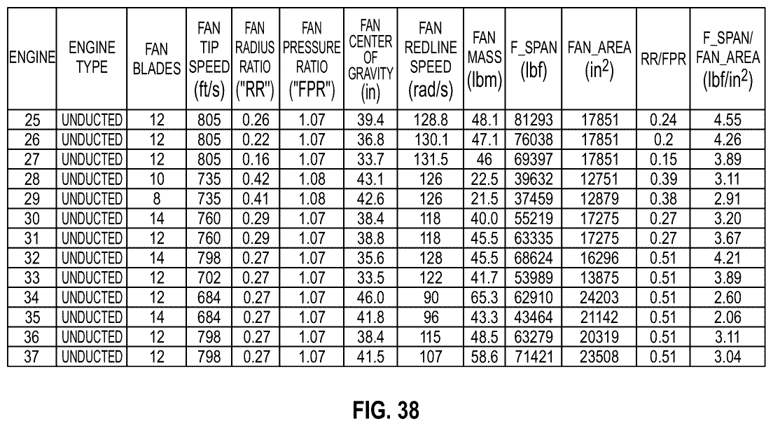

It should be noted that the terms of “Fan Center of Gravity,” “Fan Mass,” “F_Span,” and “Fan_Area” are for any one fan blade of an engine. Therefore, it should be noted that the values of “Fan Center of Gravity,” “Fan Mass,” “F_Span,” and “Fan_Area” listed herein (e.g., in the table of FIGS. 37-38, other examples, and the claims) apply to any one fan blade of the engine.

As depicted in FIG. 24, in some examples, a VPF can be configured such that the first VPF parameter (i.e., RR/FPR) is or is about 0.10-0.40 and the second VPF parameter (i.e., F_span/Fan_area) is or is about 1-30 lbf/in². These ranges apply to both ducted and unducted engines.

As depicted in FIG. 25, in some examples, a VPF can be configured such that the first VPF parameter is or is about 0.20-0.40 and the second VPF parameter is or is about 1-30 lbf/in².

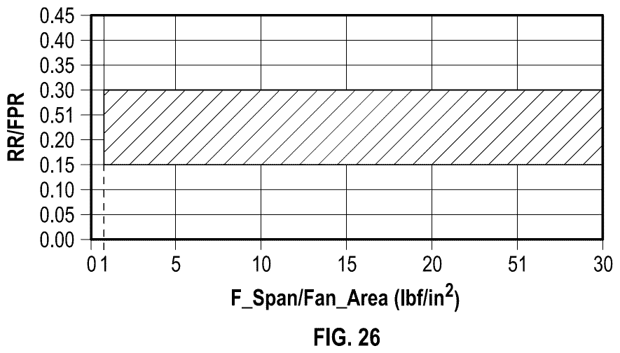

As depicted in FIG. 26, in some examples, a VPF can be configured such that the first VPF parameter is or is about 0.15-0.30 and the second VPF parameter is or is about 1-30 lbf/in².

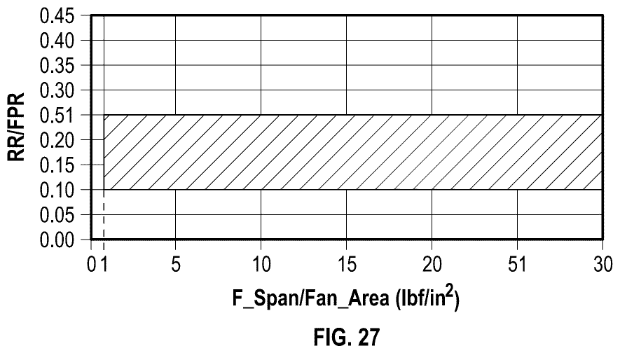

As depicted in FIG. 27, in some embodiments, a VPF can be configured such that the first VPF parameter is or is about 0.10-0.25 and the second VPF parameter is or is about 1-30 lbf/in².

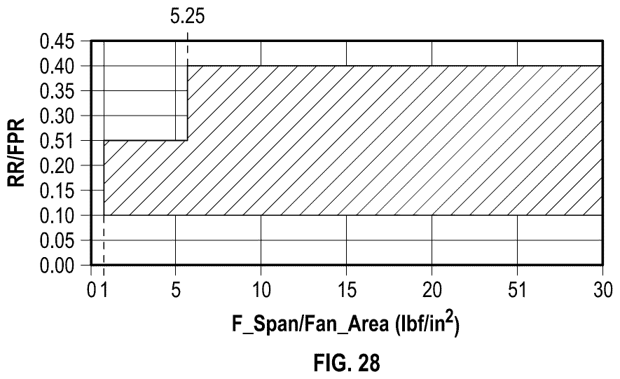

Referring now to FIG. 28, in some examples, a VPF can be configured such that the first VPF parameter is or is about 0.1-0.25 and the second VPF parameter is or is about 1-30 lbf/in² or such that the first VPF parameter is or is about 0.1-0.4 and a second VPF factor is or is about 5.25-30 lbf/in².

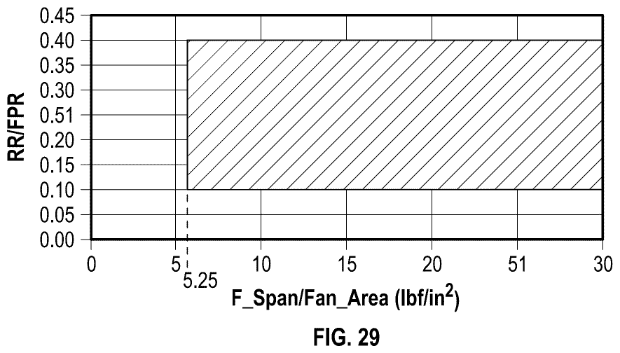

With reference to FIG. 29, in some examples, a VPF can be configured such that the first VPF parameter is or is about 0.1-0.4 and the second VPF parameter is or is about 5.25-30 lbf/in². This range of VPF parameters can, for example, be particularly advantageous for ducted fans.

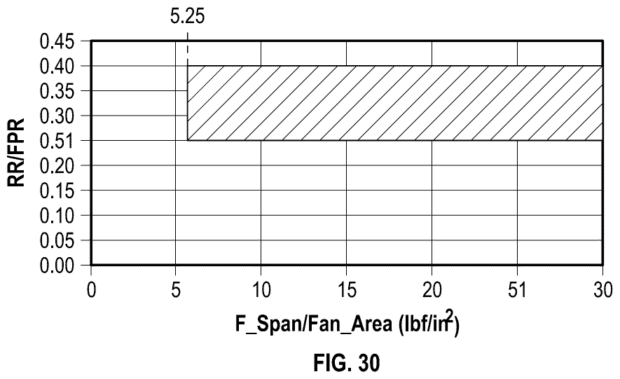

With reference to FIG. 30, in some examples, a VPF can be configured such that the first VPF parameter is or is about 0.25-0.4 and the second VPF parameter is or is about 5.25-30 lbf/in².

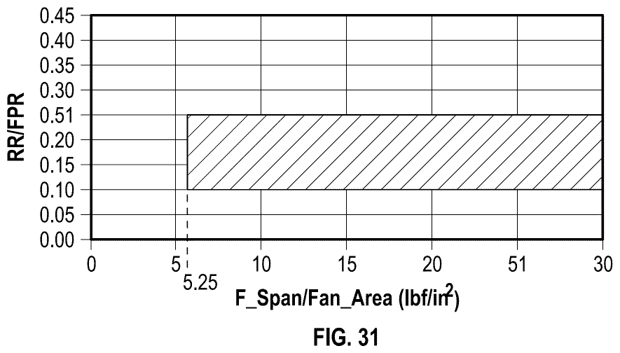

As shown in FIG. 31, in some examples, a VPF can be configured such that the first VPF parameter is or is about 0.1-0.25 and the second VPF parameter is or is about 5.25-30 lbf/in².

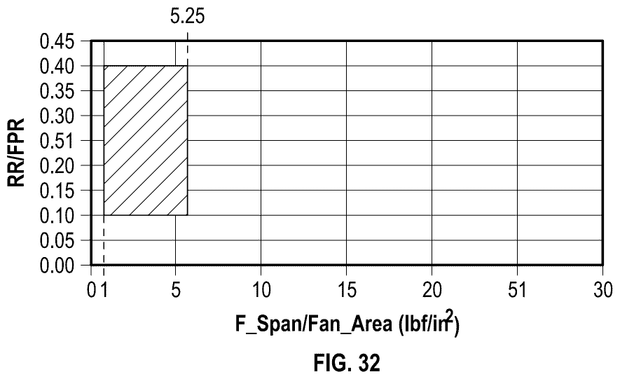

As depicted in FIG. 32, in some examples, a VPF can be configured such that the first VPF parameter is or is about 0.10-0.40 and the second VPF parameter is or is about 1-5.25 lbf/in². This range of VPF parameters can, for example, be particularly advantageous for unducted fans.

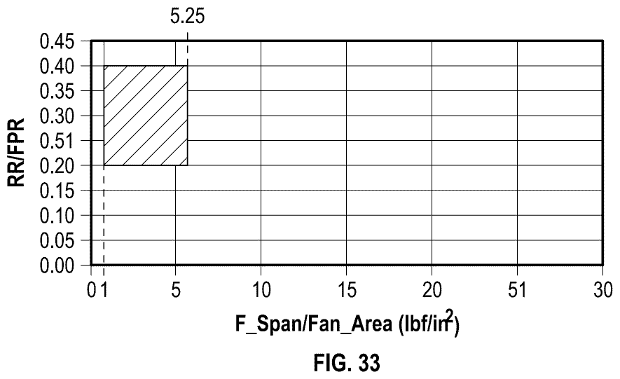

As depicted in FIG. 33, in some examples, a VPF can be configured such that the first VPF parameter is or is about 0.20-0.40 and the second VPF parameter is or is about 1-5.25 lbf/in². This range can, for example, include fans with relatively high radius ratio. In some instances, these may be unducted fans. Configuring a fan such that it is within the range depicted in FIG. 33 can, for example, enable increased pitch change mechanism design space to help improve durability pitch change mechanism and/or improve compatibility with the gearbox.

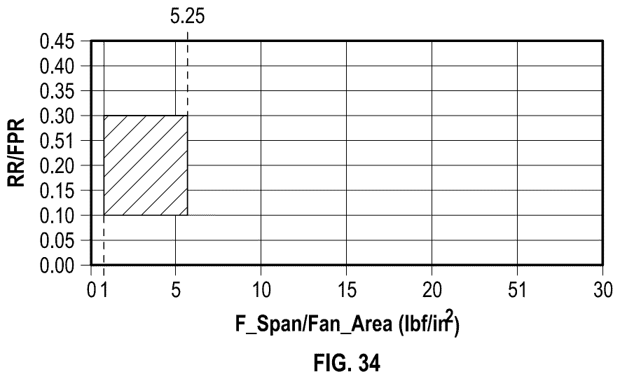

As depicted in FIG. 34, in some examples, a VPF can be configured such that the first VPF parameter is or is about 0.10-0.30 and the second VPF parameter is or is about 1-5.25 lbf/in².

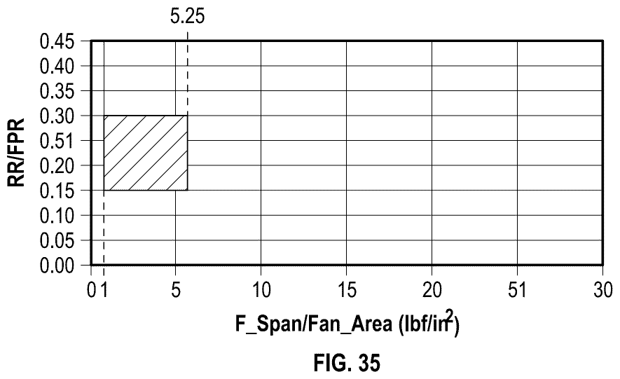

As depicted in FIG. 35, in some examples, a VPF can be configured such that the first VPF parameter is or is about 0.15-0.30 and the second VPF parameter is or is about 1-5.25 lbf/in².

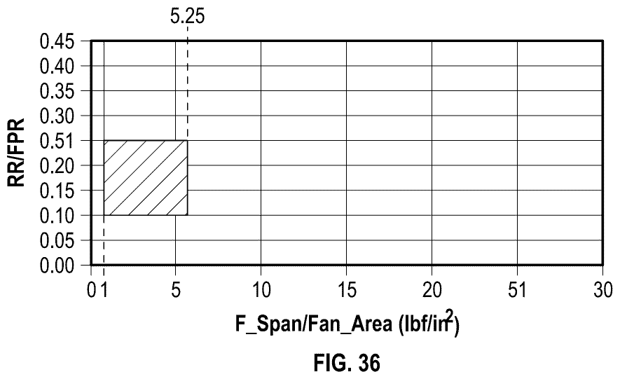

Referring to FIG. 36, in some examples, a VPF can be configured such that the first VPF parameter is or is about 0.1-0.25 and the second VPF parameter is or is about 1-5.25 lbf/in².

FIG. 37 comprises a table listing a plurality of exemplary ducted engines with a variable pitch fan, and FIG. 38 comprises a table listing a plurality of exemplary unducted engines with a variable pitch fan. The example engines of FIGS. 37-38 comprise first VPF parameters (i.e., RR/FPR) and second VPF parameters (i.e., F_span/Fan_area) that fall within one or more of the disclosed ranges of first and second VPF parameters depicted in FIGS. 24-36. FIGS. 37-38 also depicts various other parameters of the VPFs. It should be noted that in FIGS. 37-38 the fan tip speeds, fan redline speed (ω), and bearing spanwise force of the fan (F_span) are listed at a redline operating condition, and the fan pressure ratio (FPR) is listed at a static sea-level takeoff operating condition.

Thus, the exemplary engines listed in FIGS. 37-38 each define a variable pitch fan compatible with achieving, for example, a particular weight, size, and/or drag requirement, and/other factors relevant to the mechanical packaging of the engine. As discussed earlier, the disclosed engines and their VPFs account for other limitations (e.g., bearing stress), thereby allowing for adequate mechanical integration. As indicated in FIGS. 37-38, the disclosed VPF parameters are applicable to both unducted and ducted VPF designs. As explained earlier and demonstrated further in FIGS. 37-38, the relationship of the VPF parameters to turbomachinery embodiments discovered by the inventors provides a relatively quick and straightforward way of determining the feasibility of a particular VPF design. Accordingly, the inventor's disclosed methods and VPF parameters can improve the design of ducted and unducted turbomachinery engines.

The fan blades disclosed herein (e.g., the fan blades 608, 708, 830, 908, and the fan blades listed in FIGS. 37-38) can comprise various materials. For example, in some instances, a fan can comprise a metal alloy. In some instances, the metal alloy can comprise aluminum, lithium, titanium, and/or other suitable metals for fan blades. In some instances, a fan can comprise composite material. In some examples, a fan can comprise a metal alloy core and a composite cover.

Various pitch change mechanisms can be adopted for varying fan blade pitch for the examples disclosed herein (e.g., those in FIGS. 37-38). These pitch change mechanisms can comprise various components including actuators, kinematic mechanisms, counterweights, pitch-locking mechanisms, and blade bearings.

In some examples, an actuator can comprise one or more of rotary motion and linear motion. In some instances, an actuator can be driven hydraulically and/or electrically. In some examples, an actuator can reside on an engine centerline axis. In some examples, an actuator can reside offset from an engine centerline axis.

Various kinematic mechanisms can be used. For example, adjustable linkages with a unison ring to a blade crank can be used. In some examples, an actuator yoke to a blade crank can be used. In some examples, a quill shaft driven via gears to blade root, in unison or individually, can be used.

Various types of counterweights can be used. For example, in some instances, counterweights directly mounted to the blade root can be used. In some examples, counterweights in a remote position, driven by gears can be used. In some examples, counterweights with a remote position, driven by levers and linkages can be used.

Various pitch-locking mechanisms can be used. In some examples, a pitch-locking mechanism comprises a ball-screw mechanism. In some examples, pitch-locking is accomplished via hydraulic chamber manipulation. In some examples, a pitch-locking mechanism includes locking via a clutch plate.

Various types of blade bearing can be used in a pitch change mechanism. For example, a duplex combination of tapered roller, spherical roller, and/or ball bearings can be used. In some instances, a preloading device above, below, or between the bearing pair can be used. The bearings can comprise various materials including metal (e.g., steel) and/or ceramic.

A variable pitch fan can comprise a plurality of fan blades. Each of the fan blades can be rotatably attached to a disk about respective pitch axes, and the disk may be rotatable about a central axis by the one or more shafts of the core. For example, each fan blade can be attached to a trunnion mechanism which extends through an individual disk segment of the disk. The trunnion mechanism can, in turn, be retained within a respective disk segment by a keyed connection. For example, the trunnion mechanism may define a key slot and the disk segment may include a support surface. A key positioned in the key slot interacts with the key slot and the support surface to retain the trunnion mechanism within the respective disk segments.

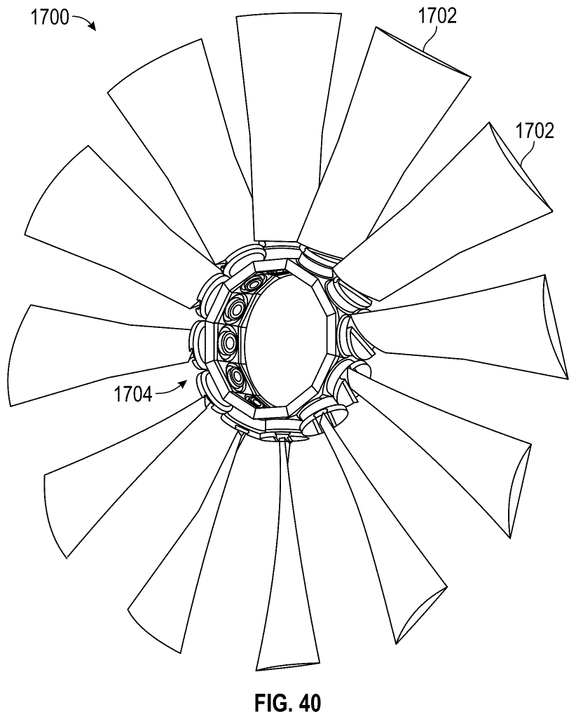

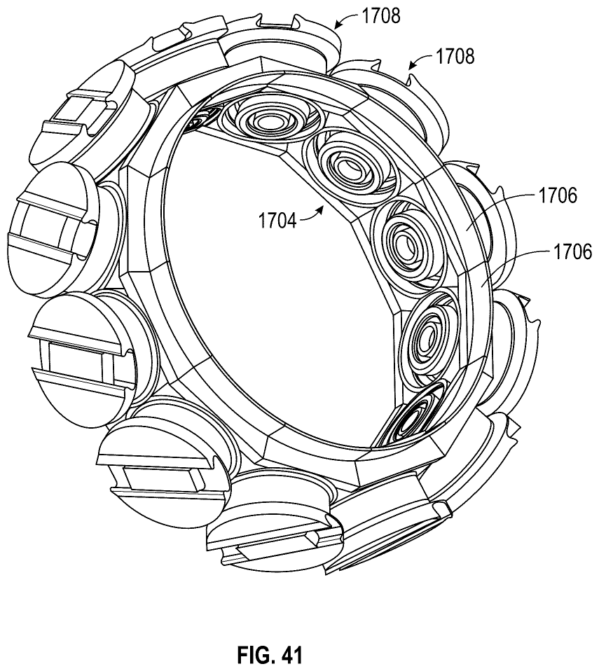

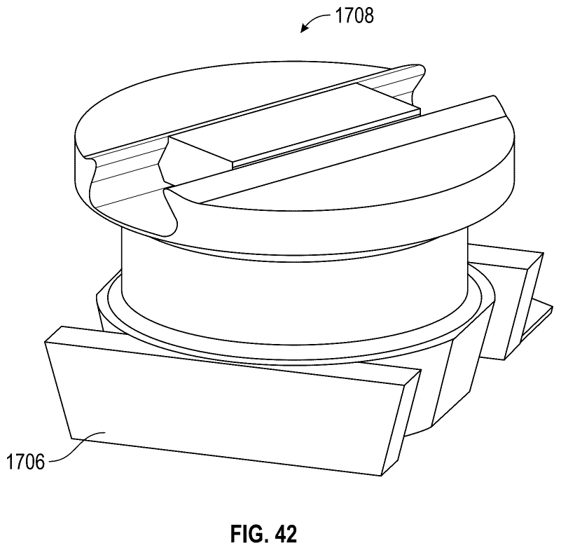

Referring now to FIGS. 40-41, a variable pitch fan assembly 1700 will be described in greater detail. The variable pitch fan assembly 1700 can be used with any of the engines disclosed herein. The variable pitch fan assembly 1700 (also referred to herein as “the fan 1700”) comprises a plurality of fan blades 1702 and a disk 1704. FIG. 40 provides a perspective view of the fan 1700. FIG. 31 provides a perspective view of the disk 1704.

In the depicted example, the fan 1700 includes twelve (12) fan blades 1702. Various other fan blade counts can be used. In some examples, the fan 1700 can be configured as an open rotor and comprise 8-16 fan blades. In some examples, the fan 1700 can be configured as a ducted rotor and comprise 16-22 fan blades.

The fan 1700 can have a diameter of 72-216 inches. In some examples, the fan 1700 can have a diameter of 100-200 inches. In some examples, the fan 1700 can have a diameter of 120-190 inches. In some examples, the fan 1700 can have a diameter of 72-120 inches. In some examples, the fan 1700 can have a diameter of 80-100 inches. In some examples, the fan 1700 can have a diameter of 50-80 inches.

The fan 1700 may have any suitable blade count and any suitable diameter, including those explicitly disclosed herein.

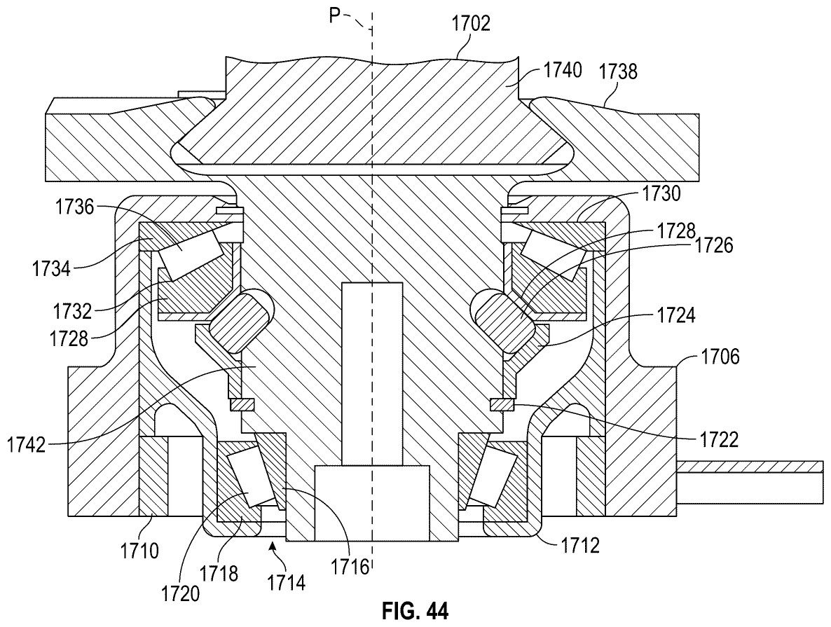

Referring to FIG. 41, the disk 1704 includes a plurality of disk segments 1706 that are rigidly coupled together or integrally molded together in a generally annular shape (e.g., a polygonal shape). Each fan blade 1702 is coupled to a respective disk segment 1706 at a trunnion mechanism 1708 that facilitates retaining the fan blade 1702 on the disk 1704 during rotation of disk 1704 (i.e., the trunnion mechanism 1708 facilitates providing a load path to disk 1704 for the centrifugal load generated by the fan blades 1702 during rotation about an engine centerline axis), while still rendering its associated fan blade 1702 rotatable relative to disk 1704 about pitch axis P (FIG. 44).

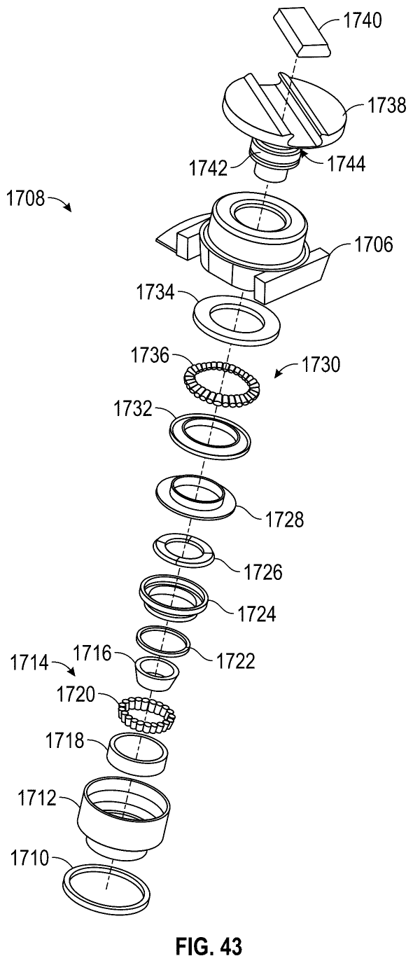

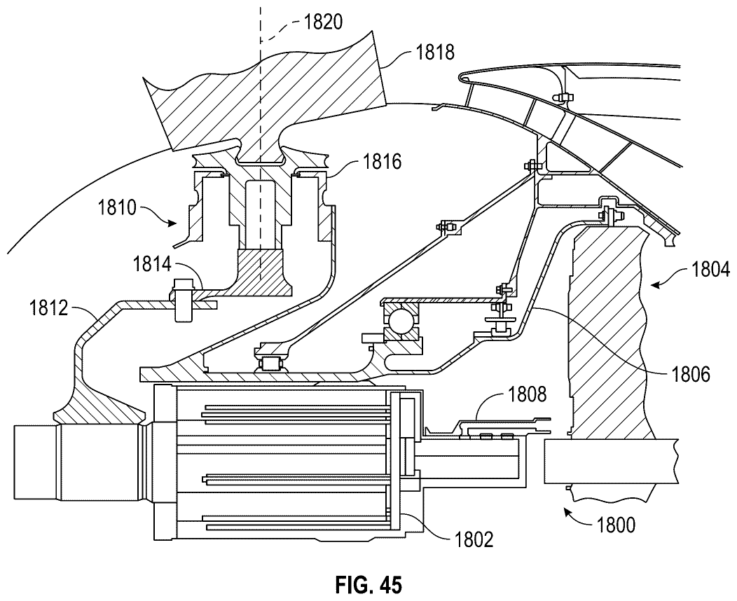

Referring now to FIGS. 42-45, an individual disk segment 1706 and trunnion mechanism 1708 in accordance with an example is depicted. More specifically, FIG. 52 provides an assembled perspective view of the exemplary disk segment 1706 and trunnion mechanism 1708. FIG. 43 provides an exploded, perspective view of the exemplary disk segment 1706 and trunnion mechanism 1708. FIG. 44 provides a side, cross-sectional view of the exemplary disk segment 1706 and trunnion mechanism 1708. FIG. 45 provides a close up, cross-sectional view of the exemplary disk segment 1706 and trunnion mechanism 1708.

In the exemplary embodiment depicted, each trunnion mechanism 1708 extends through its associated disk segment 1706 and includes: a coupling nut 1710; a lower bearing support 1712; a first line contact bearing 1714 (having, for example, an inner race 1716, an outer race 1718, and a plurality of rollers 1720); a snap ring 1722; a key hoop retainer 1724; a key 1726; a bearing support 1728; a second line contact bearing 1730 (having, for example, an inner race 1732, an outer race 1734, and a plurality of rollers 1736); and a trunnion 1738 which receives a dovetail 1740 of a fan blade 1702. In alternative embodiments, however, the trunnion 1738 may be integrated into a hub of the fan blade 1702 as a spar attachment or an additional key may be inserted into overlapping openings of the hub of the fan blade 1702 and trunnion 1738 to form a pinned root. For use as bearings 1714, 1730, at least the following types of line contacting type rolling element bearings are contemplated: cylindrical roller bearings; cylindrical roller thrust bearings; tapered roller bearings; spherical roller bearings; spherical roller thrust bearings; needle roller bearings; and tapered roller needle bearings. Additionally, the bearings may be formed of any suitable material, such as a suitable stainless steel or other metal material, or alternatively of any suitable nonferrous material.

Referring particularly to FIG. 44, in the exemplary embodiment depicted, the first line contact bearing 1714 is oriented at a different angle than the second line contact bearing 1730. More specifically, line contact bearings 1714, 1730 are preloaded against one another in a face-to-face (or duplex) arrangement, wherein centerline axes of the bearings 1714, 1730 are oriented substantially perpendicular to one another.

It should be appreciated, however, that in other exemplary embodiments, the line contact bearings 1714, 1730 may instead be arranged in tandem so as to be oriented substantially parallel to one another. It should also be appreciated that in other exemplary embodiments, the trunnion mechanism 1708 may additionally or alternatively include any other suitable type of bearing, formed of any suitable material. For example, in other exemplary embodiments, the trunnion mechanism 1708 may include roller ball bearings or any other suitable bearing.

When assembled, the coupling nut 1710 is threadably engaged with disk segment 1706 so as to sandwich the remaining components of trunnion mechanism 1708 between coupling nut 1710 and disk segment 1706, thereby retaining trunnion mechanism 1708 attached to disk segment 1706. Moreover, as is depicted, the individual disk segment 1706 and trunnion mechanism 1708 depicted includes a keyed configuration for carrying a centrifugal load of the fan blade 1702 during operation. The centrifugal load, which may generally be a function of a mass of the fan blade 1702 and a rotational speed of the fan blade 1702, can be relatively high during operation of the fan 1700 of the engine.

Additional details of the variable pitch fan 1700 and its pitch change mechanism can be found in U.S. Pat. No. 10,100,653, which is incorporated by reference.

FIG. 45 is a side elevation view of a variable pitch fan assembly 1800 including an integrated pitch change mechanism (PCM) actuator assembly 1802. The variable pitch fan assembly 1800 (which can also be referred to as “the fan 1800”) can be used with any of the engines disclosed herein. The PCM actuator assembly 1802 comprises a hydraulic actuation mechanism. The fan 1800 includes the integrated PCM actuator assembly 1802, an epicyclic gearbox 1804, a power engine rotor 1806, a stationary hydraulic fluid transfer sleeve 1808, and a hub assembly 1810. Hub assembly 1810 includes a unison ring 1812, a plurality of fan blade trunnion yokes 1814, a plurality of trunnion assemblies 1816, and a plurality of fan blades 1818. In some embodiments, a low-pressure shaft is fixedly coupled to epicyclic gearbox 1804 which is rotationally coupled to power engine rotor 1806. Power engine rotor 1806 is rotationally coupled to hub assembly 1810 and integrated PCM actuator assembly 1802 which is rotationally coupled to unison ring 1812 through integrated PCM actuator assembly 1802. Hub assembly 1810 is rotationally coupled to fan blades 1818. Unison rings 1812 are rotationally coupled to fan blade trunnion yokes 1814 which are rotationally coupled to trunnion assemblies 1816. Trunnion assemblies 1816 are rotationally coupled to fan blades 1818. Stationary hydraulic fluid transfer sleeve 1808 is coupled to supports within epicyclic gearbox 1804 and circumscribes integrated PCM actuator assembly 1802. Stationary hydraulic fluid transfer sleeve 1808 is coupled in flow communication with integrated PCM actuator assembly 1802.

In operation, the low-pressure shaft is configured to rotate a plurality of gears within epicyclic gearbox 1804 which are configured to rotate power engine rotor 1806. Power engine rotor 1806 is configured to rotate integrated PCM actuator assembly 1802 which is configured to rotate unison rings 1812. Unison ring 1812 is configured to rotate fan blade trunnion yokes 1814 which are configured to rotate trunnion assemblies 1816. Trunnion assemblies 1816 are configured to rotate fan blades 1818 about their respective axis. Stationary hydraulic fluid transfer sleeve 1808 is configured to remain stationary while integrated PCM actuator assembly 1802 is configured to rotate along with the fan module.

Stationary hydraulic fluid transfer sleeve 1808 is coupled in flow communication with integrated PCM actuator assembly 1802. Hydraulic fluid pressure from stationary hydraulic fluid transfer sleeve 1808 actuates integrated PCM actuator assembly 1802 which rotates unison ring 1812 about a radially extending pitch axis of rotation 1820. Unison ring 1812 translates fan blade trunnion yokes 1814 along an arcuate path, which rotate respective trunnion assemblies 1816 about radially extending pitch axis of rotation 1820. Trunnion assemblies 1816 are configured to rotate fan blades 1818 about radially extending pitch axis of rotation 1820.

Stationary hydraulic fluid transfer sleeve 1808 is coupled in flow communication with integrated PCM actuator assembly 1802. Hydraulic fluid pressure from stationary hydraulic fluid transfer sleeve 1808 actuates integrated PCM actuator assembly 1802 which rotates unison ring 1812 about a radially extending pitch axis of rotation 1820. Unison ring 1812 translates fan blade trunnion yokes 1814 along an arcuate path, which rotate respective trunnion assemblies 1816 about radially extending pitch axis of rotation 1820. Trunnion assemblies 1816 are configured to rotate fan blades 1818 about radially extending pitch axis of rotation 1820.

Additional details regarding the fan 1800 and the hydraulic PCM 1802 can be found in U.S. Pat. No. 10,393,137, which is incorporated by reference herein.

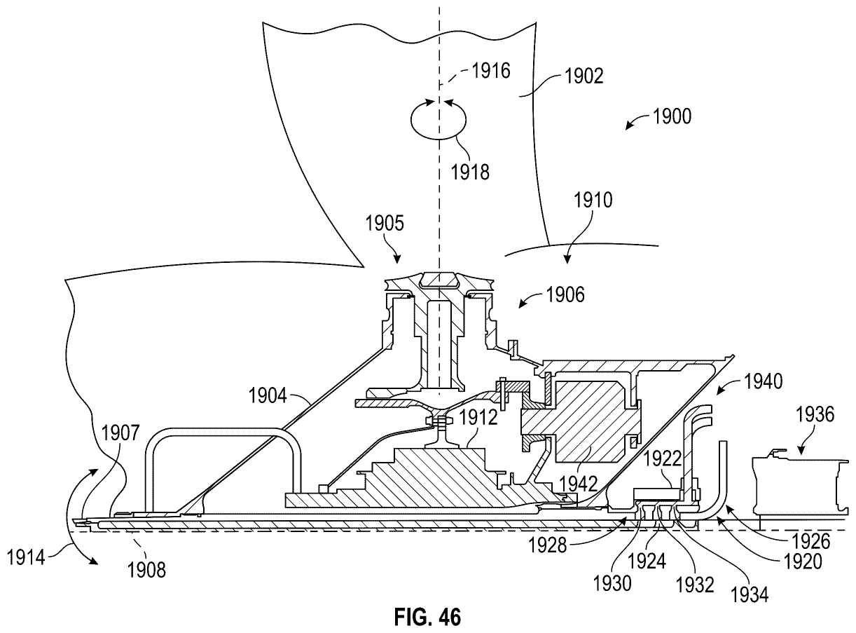

FIG. 46 is a cross-sectional view of a portion of a variable pitch fan assembly 1900, which can be used with any one of the engines disclosed herein. Fan assembly 1900 includes a plurality of blades 1902 (though only one blade is 1902 is shown in FIG. 46) mounted on a rotatable frame 1904. More specifically, blades 1902 are retained within blade retention mechanisms 1905 of an annular fan hub 1906. Moreover, blades 1902 are disposed symmetrically about a shaft 1907 (e.g., a low-pressure shaft). Shaft 1907 defines a shaft axis 1908, which is co-axial with an engine centerline. Accordingly, shaft axis 1908 may be referred to herein as “engine centerline axis 1908.” Fan assembly 1900 further includes a pitch control mechanism (PCM) 1910 for controlling a pitch of blades 1902. PCM 1910 includes a single master hydraulic actuator 1912 positioned axisymmetric with respect to centerline 1908 and fan assembly 1900. In the illustrated embodiment, hydraulic actuator 1912 is a rotary actuator configured to rotate about an axis defined by engine centerline 1908, as indicated by arrow 1914. In one embodiment, hydraulic actuator 1912 circumscribes shaft 1907.

Hydraulic actuator 1912 is configured to angularly displace blades 1902 of fan assembly 1900 between a first position and a second position. More specifically, hydraulic actuator 1912 drives rotation of blades 1902 about respective pitch axes 1916. In the illustrated embodiment, hydraulic actuator 1912 is configured to angularly displace blades 1902 upon rotation of hydraulic actuator 1912. The angular displacement of blades 1902 around pitch axes 1916 is indicated generally by arrow 1918.

PCM 1910 also includes a hydraulic fluid transfer system, including a power gearbox 1936 configured to drive hydraulic fluid (e.g., hydraulic oil) through shaft 1907 to hydraulic actuator 1912. Gearbox 1936 may be a star gearbox, such that hydraulic fluid is channeled therethrough, a planetary gearbox, in which the hydraulic is transferred therearound, or another suitable gearbox configuration (including those disclosed herein). Hydraulic fluid transfer system also includes a hydraulic fluid transfer sleeve 1920, such as, for example, a hydraulic oil transfer “slip ring,” in fluid communication with gearbox 1936. Hydraulic transfer sleeve 1920 includes a stationary member 1922, fixed relative to fan assembly 1900, and a rotatable member 1924, which rotates with hydraulic actuator 1912. Hydraulic fluid transfer sleeve 1920 is configured to transfer a flow of pressurized hydraulic fluid, for example, hydraulic oil, across a gap 1926 between stationary member 1922 and rotatable member 1924. In the example embodiment, PCM 1910 further includes a plurality of hydraulic fluid supply lines 1928 coupled in flow communication between hydraulic actuator 1912 and hydraulic fluid transfer sleeve 1920. The plurality of fluid supply lines 1928 includes a first supply line 1930, configured to channel pressurized fluid to hydraulic actuator 1912 to increase pitch of blades 1902, a second supply line 1932, configured to channel pressurized fluid to hydraulic actuator 1912 to decrease pitch of blades 1902, and a third supply line 1934 configured to facilitate draining at least a portion of hydraulic actuator 1912.

PCM 1910 includes a remote counterweight system 1940. Remote counterweight system 1940 includes a plurality of counterweights 1942 configured to affect a position of blades 1902, for example, when fluid pressure in PCM 1910 is outside a predetermined range. Remote counterweight system 1940 is remote from blade retention mechanisms 1905.

Additional details regarding the fan 1900 and its PCM 1910 can be found in U.S. Pat. No. 10,533,436, which is incorporated by reference.

It should be understood that any one of the above-described gas turbine engines can be evaluated based various combinations of the above-described ratios and/or parameters, such as combinations of one or more of the thrust to power airflow ratio, the core bypass ratio, the first VPF parameter, and the second VPF parameter. For example, any one of the gas turbine engines described herein can be designed, evaluated based on one or more of these ratios and/or parameters (for example, the thrust to power airflow ratio, the core bypass ratio, the first VPF parameter, and the second VPF parameter), and redesigned to improve the evaluated ratios and/or parameters. The evaluation of a gas turbine engine design based on the thrust to power airflow ratio, the core bypass ratio, the first VPF parameter, and the second VPF parameter can better determine the feasibility of the design of the gas turbine engine's third stream and the design of the gas turbine engine's variable pitch fan, thereby resulting in a better, more complete analysis of the gas turbine engine design. Such evaluations can be especially helpful when designing unducted, three-stream gas turbine engines including variable pitch fans with pluralities of fan blades.

Additionally, it should be appreciated that ranges of power loading and/or rotor blade tip speed may correspond to certain structures, core sizes, thrust outputs, etc., or other structures of the core engine. However, as previously stated, to the extent one or more structures provided herein may be known in the art, it should be appreciated that the present disclosure may include combinations of structures not previously known to combine, at least for reasons based in part on conflicting benefits versus losses, desired modes of operation, or other forms of teaching away in the art.

Although depicted above as an unshrouded or open rotor engine in the embodiments depicted above, it should be appreciated that aspects of the disclosure provided herein may be applied to shrouded or ducted engines, partially ducted engines, aft-fan engines, or other gas turbine engine configurations, including those for marine, industrial, or aero-propulsion systems. Certain aspects of the disclosure may be applicable to turbofan, turboprop, or turboshaft engines. However, it should be appreciated that certain aspects of the disclosure may address issues that may be particular to unshrouded or open rotor engines, such as, but not limited to, issues related to gear ratios, fan diameter, fan speed, length (L) of the engine, maximum diameter of the core engine (D_{core}) of the engine, L/D_{core} of the engine, desired cruise altitude, and/or desired operating cruise speed, or combinations thereof.

This written description uses examples to disclose the present disclosure, including the best mode, and also to enable any person skilled in the art to practice the disclosure, including making and using any devices or systems and performing any incorporated methods. The patentable scope of the disclosure is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

Further aspects are provided by the subject matter of the following clauses:

Example 1. A gas turbine engine comprising: a turbomachine comprising a compressor section, a combustion section, and a turbine section arranged in serial flow order, the turbomachine defining an engine inlet to an inlet duct, a fan duct inlet to a fan duct, and a core inlet to a core duct; a primary fan driven by the turbomachine; and a secondary fan located downstream of the primary fan within the inlet duct, the gas turbine engine defining a thrust to power airflow ratio between 3.5 and 100 and a core bypass ratio between 0.1 and 10, wherein the thrust to power airflow ratio is a ratio of an airflow through a bypass passage over the turbomachine plus an airflow through the fan duct to an airflow through the core duct, and wherein the core bypass ratio is a ratio of the airflow through the fan duct to the airflow through the core duct.

Example 2. The gas turbine engine of any clause herein, wherein the thrust to power airflow ratio and the core bypass ratio are defined when the gas turbine engine is operated at a rated speed during standard day operating conditions.

Example 3. The gas turbine engine of any clause herein, wherein the thrust to power airflow ratio between 4 and 75.

Example 4. The gas turbine engine of any clause herein, wherein the primary fan is an unducted primary fan, and wherein the thrust to power airflow ratio between 30 and 60.

Example 5. The gas turbine engine of any clause herein, wherein the thrust to power airflow ratio between 35 and 50.

Example 6. The gas turbine engine of any clause herein, wherein the core bypass ratio between 0.3 and 5.

Example 7. The gas turbine engine of any clause herein, wherein the gas turbine engine is a turboprop engine, and wherein the thrust to power airflow ratio between 40 and 100.

Example 8. The gas turbine engine of any clause herein, wherein the primary fan is a ducted primary fan, and wherein the thrust to power airflow ratio is between 3.5 and 40.

Example 9. The gas turbine engine of any clause herein, wherein the gas turbine engine is a direct drive gas turbine engine, and wherein the thrust to power airflow ratio is between 3.5 and 20.

Example 10. The gas turbine engine of any clause herein, wherein the gas turbine engine is a geared gas turbine engine, and wherein the thrust to power airflow ratio is between 8 and 40.

Example 11. The gas turbine engine of any clause herein, wherein the secondary fan is a single stage secondary fan.

Example 12. The gas turbine engine of any clause herein, wherein the secondary fan is a multi-stage secondary fan.

Example 13. The gas turbine engine of any clause herein, wherein the multi-stage secondary fan is a two stage secondary fan.

Example 14. The gas turbine engine of any clause herein, wherein the primary fan is a ducted primary fan comprising an outer nacelle surrounding the primary fan and defining the bypass passage downstream of the primary fan and over the turbomachine, wherein the gas turbine engine further defines a bypass passage outlet at a downstream end of the outer nacelle, wherein the fan duct defines a fan duct outlet, and wherein the fan duct outlet is downstream of the bypass passage outlet.

Example 15. The gas turbine engine of any clause herein, wherein the primary fan is a ducted primary fan comprising an outer nacelle surrounding the primary fan and defining the bypass passage downstream of the primary fan and over the turbomachine, wherein the gas turbine engine further defines a bypass passage outlet at a downstream end of the outer nacelle, wherein the fan duct defines a fan duct outlet, and wherein the fan duct outlet is upstream of the bypass passage outlet.

Example 16. The gas turbine engine of any clause herein, wherein the primary fan, the secondary fan, the compressor section, the combustion section, and the turbine section are arranged in serial flow order.

Example 17. A method of operating a gas turbine engine, comprising: operating the gas turbine engine at a rated speed, wherein operating the gas turbine engine at the rated speed comprises operating the gas turbine engine to define a thrust to power airflow ratio between 3.5 and 100 and a core bypass ratio between 0.1 and 5, wherein the thrust to power airflow ratio is a ratio of an airflow through a bypass passage over a turbomachine of the gas turbine engine plus an airflow through a fan duct to an airflow through a core duct, and wherein the core bypass ratio is a ratio of the airflow through the fan duct to the airflow through the core duct.

Example 18. The method of any clause herein, wherein the gas turbine engine of claim 1, wherein the thrust to power airflow ratio between 4 and 75.

Example 19. The method of any clause herein, wherein the primary fan is an unducted primary fan, and wherein the thrust to power airflow ratio between 30 and 60.

Example 20. The method of any clause herein, wherein the thrust to power airflow ratio between 35 and 50.

Example 21. The method of any clause herein, wherein the core bypass ratio between 0.3 and 5.

Example 22. A turbomachinery engine comprising a fan assembly, a pitch change mechanism, a vane assembly, a core engine, and a gearbox. The fan assembly includes a plurality of fan blades, a first VPF parameter, and a second VPF parameter. The first VPF parameter is defined by a fan blade radius ratio (RR) divided by a fan pressure ratio (FPR) at a static sea-level takeoff operating condition. The second VPF parameter is defined by a bearing spanwise force (F_Span) at a redline operating condition measured in pounds force divided by a fan area (F_Area) measured in square inches. The first VPF parameter is within a range of 0.1 to 0.25 and the second VPF parameter is within a range of 2-30 lbf/in², or the first VPF parameter is within a range of 0.1 to 0.4 and the second VPF parameter is within a range of 5.25-30 lbf/in². The pitch change mechanism is coupled to the plurality of fan blades and configured for adjusting a pitch of the plurality of fan blades. The vane assembly includes a plurality of vanes disposed aft of the fan blades. The core engine includes one or more compressor sections and one or more turbine sections. The gearbox includes an input and an output. The input is coupled to the one or more turbine sections of the core engine and comprises a first rotational speed, and the output is coupled to the fan assembly and has a second rotational speed which is less than the first rotational speed.

Example 23. The turbomachinery engine of any clause herein, wherein the plurality of fan blades is 8-20 fan blades.

Example 24. The turbomachinery engine of any clause herein, wherein the plurality of fan blades is 12-16 fan blades.

Example 25. The turbomachinery engine of any clause herein, wherein the plurality of fan blades is exactly 12-14 fan blades.

Example 26. The turbomachinery engine of any clause herein, wherein the RR is within a range of 0.125-0.55.

Example 27. The turbomachinery engine of any clause herein, wherein the RR is within a range of 0.2-0.5.

Example 28. The turbomachinery engine of any clause herein, wherein the RR is within a range of 0.25-0.35.

Example 29. The turbomachinery engine of any clause herein, wherein the RR is within a range of 0.25-0.3.

Example 30. The turbomachinery engine of any clause herein, wherein the FPR at the static sea-level takeoff operating condition is within a range of 1.05-1.5.

Example 31. The turbomachinery engine of any clause herein, wherein the FPR at the static sea-level takeoff operating condition is within a range of 1.05-1.15.

Example 32. The turbomachinery engine of any clause herein, wherein the FPR at the static sea-level takeoff operating condition is within a range of 1.2-1.4.

Example 33. The turbomachinery engine of any clause herein, wherein the F_Span at the redline operating condition is within a range of 20,000-200,000 lbf.

Example 34. The turbomachinery engine of any clause herein, wherein the F_Span at the redline operating condition is within a range of 100,000-175,000 lbf.

Example 35. The turbomachinery engine of any clause herein, wherein the F_Span at the redline operating condition is within a range of 50,000-100,000 lbf.

Example 36. The turbomachinery engine of any clause herein, wherein the F_Span at the redline operating condition is within a range of 65,000-85,000 lbf.

Example 37. The turbomachinery engine of any clause herein, wherein the F_Area is within a range of 3,000-25,000 in².

Example 38. The turbomachinery engine of any clause herein, wherein the F_Area is within a range of 15,000-20,000 in².

Example 39. The turbomachinery engine of any clause herein, wherein the F_Area is within a range of 17,000-18,000 in².

Example 40. The turbomachinery engine of any clause herein, wherein the F_Area is within a range of 3,000-10,000 in².

Example 41. The turbomachinery engine of any clause herein, wherein the F_Area is within a range of 4,000-7,000 in².

Example 42. The turbomachinery engine of any clause herein, wherein a fan blade tip speed of the fan assembly at a redline operating condition is within a range of 700-1,400 ft/s.

Example 43. The turbomachinery engine of any clause herein, wherein the fan blade tip speed of the fan assembly at a redline operating condition is within a range of 800-950 ft/s.

Example 44. The turbomachinery engine of any clause herein, wherein the fan blade tip speed of the fan assembly at a redline operating condition is within a range of 1,000-1,200 ft/s.

Example 45. The turbomachinery engine of any clause herein, wherein the gearbox comprises a gear ratio of 4.1-14, and wherein the gear ratio is defined by the first rotational speed divided by the second rotational speed.

Example 46. A turbomachinery engine comprises a fan assembly, a core engine, and a gearbox. The fan assembly includes a plurality of variable pitch fan blades, a first VPF parameter, and a second VPF parameter. The first VPF parameter is defined by a fan blade radius ratio (RR) divided by a fan pressure ratio (FPR) at a static sea-level takeoff operating condition. The second VPF parameter is defined by a bearing spanwise force (F_Span) at a redline operating condition measured in pounds force divided by a fan area (F_Area) measured in square inches. The first VPF parameter is within a range of 0.1 to 0.25, and the second VPF parameter is within a range of 2-30 lbf/in². The core engine includes one or more compressor sections and one or more turbine sections. The gearbox includes an input and an output. The input is coupled to the one or more turbine sections of the core engine and comprises a first rotational speed, and the output is coupled to the fan assembly and has a second rotational speed, which is less than the first rotational speed.

Example 47. The turbomachinery engine of any clause herein, further comprising a pitch change mechanism coupled to the plurality of variable pitch fan blades and configured for adjusting a pitch of the plurality of variable pitch fan blades.

Example 48. The turbomachinery engine of any clause herein, wherein the pitch change mechanism is a linear actuated pitch change mechanism.

Example 49. The turbomachinery engine of any clause herein, wherein the plurality of fan blades is 10-18 fan blades.

Example 50. The turbomachinery engine of any clause herein, wherein the plurality of fan blades is 12-14 fan blades.

Example 51. The turbomachinery engine of any clause herein, wherein the plurality of fan blades is exactly 14 fan blades.

Example 52. The turbomachinery engine of any clause herein, wherein the RR is within a range of 0.125-0.55.

Example 53. The turbomachinery engine of any clause herein, wherein the RR is within a range of 0.2-0.5.

Example 54. The turbomachinery engine of any clause herein, wherein the RR is within a range of 0.25-0.35.

Example 55. The turbomachinery engine of any clause herein, wherein the FPR at the static sea-level takeoff operating condition is within a range of 1.05-1.5.

Example 56. The turbomachinery engine of any clause herein, wherein the FPR at the static sea-level takeoff operating condition is 1.05-1.15.

Example 57. The turbomachinery engine of any clause herein, wherein the FPR at the static sea-level takeoff operating condition is within a range of 1.20-1.40.

Example 58. The turbomachinery engine of any clause herein, wherein the F_Span at the redline operating condition is within a range of 20,000-200,000 lbf.

Example 59. The turbomachinery engine of any clause herein, wherein the F_Span at the redline operating condition is within a range of 60,000-90,000 lbf.

Example 60. The turbomachinery engine of any clause herein, wherein the F_Span at the redline operating condition is within a range of 100,000-150,000 lbf.

Example 61. The turbomachinery engine of any clause herein, wherein the F_Area is within a range of 3,000-25,000 in².

Example 62. The turbomachinery engine of any clause herein, wherein the F_Area is within a range of 16,000-18,000 in².

Example 63. The turbomachinery engine of any clause herein, wherein the F_Area is within a range of 5,500-6,500 in².

Example 64. The turbomachinery engine of any clause herein, wherein a fan blade tip speed of the fan assembly at a redline operating condition is within a range of 800-1,200 ft/s.

Example 65. The turbomachinery engine of any clause herein, wherein the gearbox comprises a gear ratio of 6:1 to 11:1, and wherein the gear ratio is defined by the first rotational speed divided by the second rotational speed.

Example 66. The turbomachinery engine of any clause herein, wherein the second VPF parameter is within a range of 2.0-5.25 lbf/in².

Example 67. The turbomachinery engine of any clause herein, wherein the second VPF parameter is within a range of 5.25-30 lbf/in².

Example 68. A turbomachinery engine comprises a fan assembly, a core engine, and a gearbox. The fan assembly includes a plurality of variable pitch fan blades, a first VPF parameter, and a second VPF parameter. The first VPF parameter is defined by a fan blade radius ratio (RR) divided by a fan pressure ratio (FPR) at a static sea-level takeoff operating condition. The second VPF parameter is defined by a bearing spanwise force (F_Span) at a redline operating condition measured in pounds force divided by a fan area (F_Area) measured in square inches. The first VPF parameter is within a range of 0.10 to 0.40, and the second VPF parameter is within a range of 5.25-30 lbf/in². The core engine includes one or more compressor sections and one or more turbine sections. The gearbox includes an input and an output. The input is coupled to the one or more turbine sections of the core engine and comprises a first rotational speed, and the output is coupled to the fan assembly and has a second rotational speed, which is less than the first rotational speed.

Example 69. The turbomachinery engine of any clause herein, further comprising a linear actuated pitch change mechanism coupled to the fan assembly and configured for adjusting a pitch of the plurality of variable pitch fan blades.

Example 70. The turbomachinery engine of any clause herein, wherein the plurality of fan blades is 12-16 fan blades.

Example 71. The turbomachinery engine of any clause herein, wherein the plurality of fan blades is 12-14 fan blades.

Example 72. The turbomachinery engine of any clause herein, wherein the RR is within a range of 0.125-0.55.

Example 73. The turbomachinery engine of any clause herein, wherein the RR is within a range of 0.2-0.5.

Example 74. The turbomachinery engine of any clause herein, wherein the RR is within a range of 0.25-0.35.

Example 75. The turbomachinery engine of any clause herein, wherein the FPR at the static sea-level takeoff operating condition is within a range of 1.05-1.5.

Example 76. The turbomachinery engine of any clause herein, wherein the FPR at the static sea-level takeoff operating condition is within a range of 1.05-1.15.

Example 77. The turbomachinery engine of any clause herein, wherein the FPR at the static sea-level takeoff operating condition is within a range of 1.2-1.4.

Example 78. The turbomachinery engine of any clause herein, wherein the F_Span at the redline operating condition is within a range of 20,000-200,000 lbf.

Example 79. The turbomachinery engine of any clause herein, wherein the F_Span at the redline operating condition is within a range of 140,000-183,000 lbf.

Example 80. The turbomachinery engine of any clause herein, wherein the F_Span at the redline operating condition is within a range of 50,000-75,000 lbf.

Example 81. The turbomachinery engine of any clause herein, wherein the F_Area is within a range of 3,500-18,000 in².

Example 82. The turbomachinery engine of any clause herein, wherein the F_Area is within a range of 15,000-18,000 in².

Example 83. The turbomachinery engine of any clause herein, wherein the F_Area is within a range of 4,000-5,500 in².

Example 84. The turbomachinery engine of any clause herein, wherein a fan blade tip speed of the fan assembly at a redline operating condition is within a range of 800-950 ft/s.

Example 85. The turbomachinery engine of any clause herein, wherein the gearbox comprises a gear ratio of 4.5:1 to 12:1.

Example 86. The turbomachinery engine of any clause herein, wherein the first VPF parameter is within a range of 0.10 to 0.25.

Example 87. The turbomachinery engine of any clause herein, wherein the first VPF parameter is within a range of 0.25 to 0.40.

Example 88. The turbomachinery engine of any clause herein, further comprising a third stream.

Example 89. A variable pitch fan assembly for a turbomachinery engine can be provided. The variable pitch fan assembly includes a plurality of variable pitch fan blades, a fan blade radius ratio (RR), a fan pressure ratio (FPR) at a static sea-level takeoff operating condition, a bearing spanwise force (F_Span) at a redline operating condition measured in pounds force, and a fan area (F_Area) measured in square inches. The variable pitch fan assembly is configured such that the RR divided by the FPR is within a range of 0.10-0.25 and the F_Span divided by the F_Area is within a range of 2.0-30.0 lbf/in².

Example 90. The variable pitch fan assembly of any clause herein, wherein the F_Span divided by the F_Area is within a range of 2-5.25 lbf/in².

Example 91. The variable pitch fan assembly of any clause herein, wherein the F_Span divided by the F_Area is within a range of 5.25-30 lbf/in².

Example 92. A variable pitch fan assembly for a turbomachinery engine can be provided. The variable pitch fan assembly includes a plurality of variable pitch fan blades, a fan blade radius ratio (RR), a fan pressure ratio (FPR) at a static sea-level takeoff operating condition, a bearing spanwise force (F_Span) at a redline operating condition measured in pounds force, and a fan area (F_Area) measured in square inches. The variable pitch fan assembly is configured such that the RR divided by the FPR is within a range of 0.10-0.40 and the F_Span divided by the F_Area is within a range of 5.25-30.0 lbf/in².

Example 93. The variable pitch fan assembly of any clause herein, wherein the RR divided by the FPR is within a range of 0.1-0.25.

Example 94. The variable pitch fan assembly of any clause herein, wherein the RR divided by the FPR is within a range of 0.25-0.40.

Example 95. The variable pitch fan assembly of any clause herein, wherein the fan blades are configured to be used with an unducted engine.

Example 96. The variable pitch fan assembly of any clause herein, wherein the fan blades are configured to be used with a ducted engine.

Example 97. The variable pitch fan assembly of any clause herein, wherein the fan blades are configured to be used with an engine comprising a third stream.

Example 98. A turbomachinery engine comprising a fan assembly, a vane assembly, a core engine, and a gearbox. The fan assembly includes a plurality of variable pitch fan blades, a first VPF parameter, and a second VPF parameter. The first VPF parameter is within a range of 0.10-0.40 and is defined by a fan blade radius ratio (RR) divided by a fan pressure ratio (FPR) at a static sea-level takeoff operating condition. The second VPF parameter 1-30 lbf/in2 and is defined by a bearing spanwise force (F_Span) at a redline operating condition measured in pounds force divided by a fan area (F_Area) measured in square inches. The vane assembly includes a plurality of vanes disposed aft of the plurality of variable pitch fan blades. The core engine includes one or more compressor sections and one or more turbine sections. The gearbox includes an input and an output. The input is coupled to the one or more turbine sections of the core engine and comprises a first rotational speed, and the output is coupled to the fan assembly and has a second rotational speed which is less than the first rotational speed.

Example 99. The turbomachinery engine of any clause herein, wherein the first VPF parameter is within a range of 0.20 to 0.40.

Example 100. The turbomachinery engine of any clause herein, wherein the first VPF parameter is within a range of 0.15 to 0.30.

Example 101. The turbomachinery engine of any clause herein, wherein the second VPF parameter is within a range of 2-30 lbf/in².

Example 102. The turbomachinery engine of any clause herein, wherein the second VPF parameter is within a range of 1-5.25 lbf/in².

Example 103. The turbomachinery engine of any clause herein, wherein the second VPF parameter is within a range of 2-5.25 lbf/in².

Example 104. The turbomachinery engine of any clause herein, further comprising a pitch change mechanism coupled to the plurality of variable pitch fan blades and configured for adjusting a pitch of the plurality of variable pitch fan blades.

Example 105. A turbomachinery engine comprising a fan assembly, a core engine, and a gearbox. The fan assembly includes a plurality of variable pitch fan blades, a first VPF parameter, and a second VPF parameter. The first VPF parameter is within a range of 0.10-0.40 and is defined by a fan blade radius ratio (RR) divided by a fan pressure ratio (FPR) at a static sea-level takeoff operating condition. The second VPF parameter is within a range of 1.0-5.25 lbf/in² and is defined by a bearing spanwise force (F_Span) at a redline operating condition measured in pounds force divided by a fan area (F_Area) measured in square inches. The core engine includes one or more compressor sections and one or more turbine sections. The gearbox includes an input and an output. The input is coupled to the one or more turbine sections of the core engine and comprises a first rotational speed. The output is coupled to the fan assembly and has a second rotational speed which is less than the first rotational speed.

Example 106. The turbomachinery engine of any clause herein, further comprising a pitch change mechanism coupled to the plurality of variable pitch fan blades and configured for adjusting a pitch of the plurality of variable pitch fan blades.

Example 107. The turbomachinery engine of any clause herein, wherein the pitch change mechanism comprises at least one of a linear motion pitch change mechanism, a rotatory motion pitch change mechanism, a hydraulically driven pitch change mechanism, or an electrically driven pitch change mechanism.

Example 108. The turbomachinery engine of any clause herein, wherein the pitch change mechanism is disposed on an engine centerline axis.

Example 109. The turbomachinery engine of any clause herein, wherein the pitch change mechanism is offset from an engine centerline axis.

Example 110. The turbomachinery engine of any clause herein, wherein the first VPF parameter is within a range of 0.20 to 0.40.

Example 111. The turbomachinery engine of any clause herein, wherein the first VPF parameter is within a range of 0.10 to 0.30.

Example 112. The turbomachinery engine of any clause herein, wherein the first VPF parameter is within a range of 0.15 to 0.30.

Example 113. The turbomachinery engine of any clause herein, wherein the first VPF parameter is within a range of 0.10 to 0.25.

Example 114. A turbomachinery engine comprising a fan assembly, a core engine, and a gearbox. The fan assembly includes a plurality of variable pitch fan blades, a first VPF parameter, and a second VPF parameter. The first VPF parameter is within a range of 0.15-0.39 and is defined by a fan blade radius ratio (RR) divided by a fan pressure ratio (FPR) at a static sea-level takeoff operating condition. The second VPF parameter is within a range of 2-27 lbf/in² and is defined by a bearing spanwise force (F_Span) at a redline operating condition measured in pounds force divided by a fan area (F_Area) measured in square inches. The core engine includes one or more compressor sections and one or more turbine sections. The gearbox includes an input and an output. The input is coupled to the one or more turbine sections of the core engine and comprises a first rotational speed. The output is coupled to the fan assembly and has a second rotational speed which is less than the first rotational speed.

Example 115. The turbomachinery engine of any clause herein, wherein the fan assembly is disposed within a fan case, wherein the first VPF parameter is within a range of 0.2-0.36, and wherein the second VPF parameter is within a range of 5-27 lbf/in².

Example 116. The turbomachinery engine of any clause herein, wherein the fan assembly is an unducted fan assembly, and wherein the second VPF parameter is within a range of 2-4.6 lbf/in².

Example 117. The turbomachinery engine of any clause herein, further comprising a pitch change mechanism coupled to the plurality of variable pitch fan blades and configured for adjusting a pitch of the plurality of variable pitch fan blades, and wherein the pitch change mechanism comprises at least one of a linear motion pitch change mechanism, a rotatory motion pitch change mechanism, a hydraulically driven pitch change mechanism, or an electrically driven pitch change mechanism.

Example 118. The turbomachinery engine of any clause herein, wherein the plurality of variable pitch fan blades is 8-26 fan blades.

Example 119. The turbomachinery engine of any clause herein, wherein the plurality of variable pitch fan blades is 12-20 fan blades.

Example 120. The turbomachinery engine of any clause herein, wherein the plurality of variable pitch fan blades is exactly 12 fan blades.

Example 121. The turbomachinery engine of any clause herein, wherein the plurality of variable pitch fan blades is exactly 14 fan blades.

Example 122. The turbomachinery engine of any clause herein, wherein the plurality of variable pitch fan blades is exactly 16 fan blades.

Example 123. The turbomachinery engine of any clause herein, wherein the plurality of variable pitch fan blades is exactly 18 fan blades.

Example 124. The turbomachinery engine of any clause herein, wherein the plurality of variable pitch fan blades is exactly 20 fan blades.

Example 125. The turbomachinery engine of any clause herein, wherein the plurality of variable pitch fan blades is exactly 22 fan blades.

Example 126. The turbomachinery engine of any clause herein, wherein the plurality of variable pitch fan blades is exactly 24 fan blades.

Example 127. The turbomachinery engine of any clause herein, wherein the one or more compressor sections of the core engine comprises a low-pressure compressor having 1-8 stages and a high-pressure compressor comprising 7-11 stages, and wherein the one or more turbine sections of the core engine comprises a high-pressure turbine comprising 1-2 stages and a low-pressure turbine comprising 3-6 stages.

Example 128. The turbomachinery engine of any clause herein, wherein the one or more compressor sections of the core engine comprises a low-pressure compressor having 3-5 stages and a high-pressure compressor comprising 9-10 stages, and wherein the one or more turbine sections of the core engine comprises a high-pressure turbine comprising 2 stages and a low-pressure turbine comprising 3-4 stages.

Example 129. The turbomachinery engine of any clause herein, wherein the one or more turbine sections of the core engine comprises a high-pressure turbine comprising exactly 2 stages and a low-pressure turbine comprising exactly 3 stages.

Example 130. The turbomachinery engine of any clause herein, wherein the one or more turbine sections of the core engine comprises a high-pressure turbine comprising exactly 2 stages and a low-pressure turbine comprising exactly 4 stages.

Example 131. The turbomachinery engine of any clause herein, wherein the one or more compressor sections of the core engine comprises a high-pressure compressor comprising exactly 8 stages.

Example 132. The turbomachinery engine of any clause herein, wherein the one or more compressor sections of the core engine comprises a high-pressure compressor comprising exactly 9 stages.

Example 133. The turbomachinery engine of any clause herein, wherein the one or more compressor sections of the core engine comprises a high-pressure compressor comprising exactly 10 stages.

Example 134. The turbomachinery engine of any clause herein, wherein the one or more compressor sections of the core engine comprises a high-pressure compressor comprising exactly 11 stages.

Example 135. The turbomachinery engine of any clause herein, wherein the RR is within a range of 0.16-0.48.

Example 136. The turbomachinery engine of any clause herein, wherein the RR is within a range of 0.16-0.30.

Example 137. The turbomachinery engine of any clause herein, wherein the RR is within a range of 0.25-0.48.

Example 138. The turbomachinery engine of any clause herein, wherein the FPR is within a range of 1.25-1.35.

Example 139. The turbomachinery engine of any clause herein, wherein the FPR is within a range of 1.07-1.08.

Example 140. The turbomachinery engine of any preceding clause, wherein the FPR is within a range of 1.07-1.35.

Example 141. The turbomachinery engine of any clause herein, wherein the F_Span is within a range of 37,459-81,293 lbf.

Example 142. The turbomachinery engine of any clause herein, wherein the F_Span is within a range of 36,626-182,593 lbf.

Example 143. The turbomachinery engine of any clause herein, wherein the F_Area is within a range of 4,000-7,000 in².

Example 144. The turbomachinery engine of any clause herein, wherein the F_Area is within a range of 12,000-25,000 in².

Example 145. The turbomachinery engine of any clause herein, wherein the F_Area is within a range of 4,000-25,000 in².

Example 146. A gas turbine engine includes a turbomachine with a core engine including at least one compressor section, a combustion section, and at least one turbine section arranged in serial flow order. The turbomachine defines an engine inlet to an inlet duct, a fan duct inlet to a fan duct, and a core inlet to a core duct, a primary fan including a plurality of variable pitch fan blades and driven by the turbomachine, and a secondary fan located downstream of the primary fan within the inlet duct. The gas turbine engine defines a thrust to power airflow ratio between 3.5 and 100 and a core bypass ratio between 0.1 and 10. The thrust to power airflow ratio is a ratio of an airflow through a bypass passage over the turbomachine plus an airflow through the fan duct to an airflow through the core duct. The core bypass ratio is a ratio of the airflow through the fan duct to the airflow through the core duct. The primary fan includes a first VPF parameter and a second VPF parameter. The first VPF parameter is within a range of 0.10-0.40 and is defined by a fan blade radius ratio (RR) divided by a fan pressure ratio (FPR) at a static sea-level takeoff operating condition. The second VPF parameter is within a range of 1-30 lbf/in² and is defined by a bearing spanwise force (F_Span) at a redline operating condition measured in pounds force divided by a fan area (F_Area) measured in square inches.

Example 147. The gas turbine engine of any clause herein, wherein the thrust to power airflow ratio and the core bypass ratio are defined when the gas turbine engine is operated at a rated speed during standard day operating conditions.

Example 148. The gas turbine engine of any clause herein, wherein the primary fan is an unducted primary fan.

Example 149. The gas turbine engine of any clause herein, further comprising a gearbox including an input and an output, wherein the input is coupled to the at least one turbine section of the core engine and comprises a first rotational speed, and wherein the output is coupled to the primary fan and has a second rotational speed which is less than the first rotational speed.

Example 150. The gas turbine engine of any clause herein, further comprising a pitch change mechanism coupled to the plurality of variable pitch fan blades and configured to adjust a pitch of the plurality of variable pitch fan blades.

Example 151. The gas turbine engine of any clause herein, wherein the thrust to power airflow ratio is between 4 and 75.

Example 152. The gas turbine engine of any clause herein, wherein the thrust to power airflow ratio is between 30 and 60.

Example 153. The gas turbine engine of any clause herein, wherein the thrust to power airflow ratio is between 35 and 50.

Example 154. The gas turbine engine of any clause herein, wherein the core bypass ratio is between 0.3 and 5.

Example 155. The gas turbine engine of any clause herein, wherein the core bypass ratio is between 0.5 and 3.

Example 156. The gas turbine engine of any clause herein, wherein the first VPF parameter is between 0.20 to 0.40.

Example 157. The gas turbine engine of any clause herein, wherein the second VPF parameter is between 1-5.25 lbf/in².

Example 158. A method of operating a gas turbine engine includes operating the gas turbine engine at a rated speed, wherein operating the gas turbine engine at the rated speed comprises operating the gas turbine engine to define a thrust to power airflow ratio between 3.5 and 100, a core bypass ratio between 0.1 and 5, a first VPF parameter between 0.10-0.40, and a second VPF parameter between of 1-30 lbf/in². The thrust to power airflow ratio is a ratio of an airflow through a bypass passage over a turbomachine of the gas turbine engine plus an airflow through a fan duct to an airflow through a core duct, the core bypass ratio is a ratio of the airflow through the fan duct to the airflow through the core duct, the first VPF parameter a ratio of a fan blade radius ratio (RR) to a fan pressure ratio (FPR) at a static sea-level takeoff operating condition, and the second VPF parameter is a ratio of a bearing spanwise force (F_Span) at a redline operating condition measured in pounds force to a fan area (F_Area) measured in square inches.

Example 159. The method of any clause herein, wherein the gas turbine engine includes an unducted fan assembly.

Example 160. The method of any clause herein, wherein the unducted fan assembly is a variable pitch fan assembly having a plurality of variable pitch fan blades, and wherein the gas turbine engine further comprises a pitch change mechanism coupled to the plurality of variable pitch fan blades and configured to adjust a pitch of the plurality of variable pitch fan blades.

Example 161. The method of any clause herein, wherein the gas turbine engine includes at least one turbine section and gearbox including an input and an output, wherein the input is coupled to the at least one turbine section of the gas turbine engine and has a first rotational speed, and wherein the output is coupled to a fan assembly and has a second rotational speed which is less than the first rotational speed.

Example 162. The method of any clause herein, wherein the thrust to power airflow ratio is between 4 and 75.

Example 163. The method of any clause herein, wherein the core bypass ratio is between 0.5 and 3.

Example 164. The method of any clause herein, wherein the first VPF parameter is between 0.20 to 0.40.

Example 165. The method of any clause herein, wherein the second VPF parameter is between 1-5.25 lbf/in².

We claim:

1. A gas turbine engine comprising:
a turbomachine comprising a core engine including at least one compressor section, a combustion section, and at least one turbine section arranged in serial flow order, the turbomachine defining an engine inlet to an inlet duct, a fan duct inlet to a fan duct, and a core inlet to a core duct;
a primary fan including a plurality of variable pitch fan blades and driven by the turbomachine; and
a secondary fan located downstream of the primary fan within the inlet duct,
the gas turbine engine defining a thrust to power airflow ratio between 3.5 and 100 and a core bypass ratio between 0.1 and 10,
wherein the thrust to power airflow ratio is a ratio of an airflow through a bypass passage over the turbomachine plus an airflow through the fan duct to an airflow through the core duct,
wherein the core bypass ratio is a ratio of the airflow through the fan duct to the airflow through the core duct,
wherein the primary fan includes a first VPF parameter and a second VPF parameter,
wherein the first VPF parameter is within a range of 0.10-0.40 and is defined by a fan blade radius ratio (RR) divided by a fan pressure ratio (FPR) at a static sea-level takeoff operating condition; and
wherein the second VPF parameter is within a range of 1-30 lbf/in² and is defined by a bearing spanwise force (F_Span) at a redline operating condition measured in pounds force divided by a fan area (F_Area) measured in square inches.

2. The gas turbine engine of claim 1, wherein the thrust to power airflow ratio and the core bypass ratio are defined when the gas turbine engine is operated at a rated speed during standard day operating conditions.

3. The gas turbine engine of claim 1, wherein the primary fan is an unducted primary fan.

4. The gas turbine engine of claim 1, further comprising a gearbox including an input and an output, wherein the input is coupled to the at least one turbine section of the core engine and comprises a first rotational speed, and wherein the output is coupled to the primary fan and has a second rotational speed which is less than the first rotational speed.

5. The gas turbine engine of claim 1, further comprising a pitch change mechanism coupled to the plurality of variable pitch fan blades and configured to adjust a pitch of the plurality of variable pitch fan blades.

6. The gas turbine engine of claim 1, wherein the thrust to power airflow ratio is between 4 and 75.

7. The gas turbine engine of claim 1, wherein the thrust to power airflow ratio is between 30 and 60.

8. The gas turbine engine of claim 1, wherein the thrust to power airflow ratio is between 35 and 50.

9. The gas turbine engine of claim 1, wherein the core bypass ratio is between 0.3 and 5.

10. The gas turbine engine of claim 1, wherein the core bypass ratio is between 0.5 and 3.

11. The gas turbine engine of claim 1, wherein the first VPF parameter is between 0.20 to 0.40.

12. The gas turbine engine of claim 1, wherein the second VPF parameter is between 1-5.25 lbf/in².

13. A method of operating a gas turbine engine, comprising:
operating the gas turbine engine at a rated speed, wherein operating the gas turbine engine at the rated speed comprises operating the gas turbine engine to define a thrust to power airflow ratio between 3.5 and 100, a core bypass ratio between 0.1 and 5, a first VPF parameter between 0.10-0.40, and a second VPF parameter between of 1-30 lbf/in²,
wherein the thrust to power airflow ratio is a ratio of an airflow through a bypass passage over a turbomachine of the gas turbine engine plus an airflow through a fan duct to an airflow through a core duct,
wherein the core bypass ratio is a ratio of the airflow through the fan duct to the airflow through the core duct,
wherein the first VPF parameter a ratio of a fan blade radius ratio (RR) to a fan pressure ratio (FPR) at a static sea-level takeoff operating condition, and
wherein the second VPF parameter is a ratio of a bearing spanwise force (F_Span) at a redline operating condition measured in pounds force to a fan area (F_Area) measured in square inches.

14. The method of claim 13, wherein the gas turbine engine includes an unducted fan assembly.

15. The method of claim 14, wherein the unducted fan assembly is a variable pitch fan assembly having a plurality of variable pitch fan blades, and wherein the gas turbine engine further comprises a pitch change mechanism coupled to the plurality of variable pitch fan blades and configured to adjust a pitch of the plurality of variable pitch fan blades.

16. The method of claim 13, wherein the gas turbine engine comprises at least one turbine section and gearbox including an input and an output,
wherein the input is coupled to the at least one turbine section of the gas turbine engine and has a first rotational speed, and
wherein the output is coupled to a fan assembly and has a second rotational speed which is less than the first rotational speed.

17. The method of claim 13, wherein the thrust to power airflow ratio is between 4 and 75.

18. The method of claim 13, wherein the core bypass ratio is between 0.5 and 3.

19. The method of claim 13, wherein the first VPF parameter is between 0.20 to 0.40.

20. The method of claim 13, wherein the second VPF parameter is between 1-5.25 lbf/in².
